(19) United States
(12) Patent Application Publication
(10) Pub. No.: US 2024/0402667 A1
(43) Pub. Date: Dec. 5, 2024

(54) Method for calculating Control Attainable Set of redundant drive system under linear constraint

(71) Applicant: SHANDONG JIAOTONG UNIVERSITY, Jinan (CN)

(72) Inventors: Yuhong Xing, Jinan (CN); Jiuhong Ruan, Jinan (CN)

(21) Appl. No.: 18/640,040

(22) Filed: Apr. 19, 2024

(30) Foreign Application Priority Data
Apr. 21, 2023 (CN) 202310433407.2

(51) Int. Cl. G05B 19/02

(52) U.S. Cl. CPC G05B 19/02; G05B 2219/39061

(57) ABSTRACT

Provided is a method for calculating a control attainable set of a redundant drive system under a linear constraint, which relates to the technical field of dynamics control allocation of the redundant drive system. The method first constructs a control attainable set problem for a redundant drive system under each pair of linear constraint control components, and then classifies boundary surfaces corresponding to a control set into three types of rectangular boundary surfaces and one type of triangular boundary surface. By grouping the boundary surfaces, the method determines a key boundary surface for each group to form a boundary surface set. After removing duplicate boundary surfaces from the boundary surface set, the method calculates a boundary surface of a control attainable set, and finally obtains the control attainable set.

### CROSS REFERENCE TO RELATED APPLICATION

This patent application claims the benefit and priority of Chinese Patent Application No. 202310433407.2, filed with the China National Intellectual Property Administration on Apr. 21, 2023, the disclosure of which is incorporated by reference herein in its entirety as part of the present application.

### TECHNICAL FIELD

The present disclosure relates to the technical field of dynamics control allocation of a redundant drive system, and in particular, to a method for calculating a control attainable set of a redundant drive system under a linear constraint.

### BACKGROUND

A control attainable set of a redundant drive system can quantitatively characterize a control capability of the system, and calculation of the control attainable set is an inverse problem of control allocation. The control allocation is responsible for allocating an expected system control vector to each redundant actuator for execution. The calculation of the control attainable set is to determine, in the case of a known variation range of each actuator, a boundary of a system control attainable vector that can be achieved by all actuators acting simultaneously, to obtain the control capability of the redundant drive system, especially a control capability of the system after some actuators fail. A control allocation method based on the control attainable set has become a hot research topic in the field of control allocation.

A control attainable set of a parallel configuration redundant drive system can be mathematically expressed as follows:

$$Φ = \{ v \vert v = B \cdot u , u ∈ Ω \} \qquad ( 1 - 1 )$$

In the above expression, u represents a control vector, and u=(u₁, . . . , uₘ)^{T}, which represents a control input of the redundant drive system, where T represents a matrix transpose symbol, and an i^{th} control component is a control action of a corresponding i^{th} actuator, where 1≤i≤m, m represents a quantity of actuators, uᵢₘᵢₙ≤uᵢ≤uᵢₘₐₓ≤uᵢₘᵢₙ represents a minimum constraint value of the control action of the i^{th} actuator, and uᵢₘₐₓ represents a maximum constraint value of the control action of the i^{th} actuator; there is often a linear or nonlinear constraint between each uᵢ; Ω represents a control set, and Ω={u}; v represents a control attainable vector of the redundant drive system, and v=(v₁, L, vₙ)^{T}, which represents a control output of the redundant drive system, where vⱼ represents a j^{th} control attainable component, 1≤j≤n, n represents a dimension of the control attainable vector, and n<m; Φ represents the control attainable set; and B represents an n-row and m-column control efficiency matrix.

The above expression (1-1) is physically used to describe how to determine, based on the control efficiency matrix B, the control attainable vector set Φ composed of n control outputs of the redundant drive system, provided that the control vector set Ω composed of m control inputs of the redundant drive system is known. For example, a physical meaning of a control attainable set of a four-wheel independently driven and independently steered vehicle is as follows:
1) Four longitudinal forces of four wheels are F_{L1}, F_{L2}, F_{L3}, and F_{L4} respectively, and four lateral forces of the four wheels are, F_{T1}, F_{T2}, F_{T3} and F_{T4} respectively.
2) A control vector uᵥ=(F_{L1}, F_{T1}, F_{L2}, F_{T2}, F_{L3}, F_{T3}, F_{L4}, F_{T4})^{T} containing eight control components is set for the four-wheel independently driven and independently steered vehicle, where F_{Limin}≤F_{Li}≤F_{Li max}, F_{Timin}≤F_{Ti}≤F_{Ti max}, (i−1, . . . , 4), F_{Limin} and F_{Timin} respectively represent a minimum longitudinal force and a minimum lateral force of each wheel, and F_{Li max} and F_{Ti max} respectively represent a maximum longitudinal force and a maximum lateral force of each wheel. There is often a nonlinear or linear constraint relationship between the components in the uᵥ.
3) All values of the uᵥ constitute a control set Ωᵥ={uᵥ} of the four-wheel independently driven and independently steered vehicle.
4) A specific group of data uᵥₛ ∈Ω_{V} in the Ω_{V} is processed by a wheel force control efficiency matrix B_{V} to generate a specific overall longitudinal force F_{LS} of the vehicle, a a specific overall lateral force F_{TS} of the vehicle. and a specific overall yawing moment M_{S} of specific overall lateral force the vehicle, which is denoted as V_{VS}=(F_{LS}, F_{TS}, M_{S})^{T}. Therefore, v_{VS}=B_{V}·u_{VS}.
5) All values of the v_{VS} constitute a control attainable set Φ_{V} of the four-wheel independently driven and independently steered vehicle, namely,

$${Φ}_{V} = \{ {v}_{VS} \vert {v}_{VS} = {B}_{V} \cdot {u}_{VS} , {u}_{VS} ∈ {Ω}_{V} \} .$$

The literature “Attainable Moments for the Constrained Control Allocation Problem” and the patent “Control Allocation Method for Overdrive System Based on Geometrically and Intuitively Constructed Attainable Set” (Patent Application No.: ZL201810131251.1) disclose a problem of determining a control attainable set when control actions of various actuators are independent of each other, in other words, when there is no constraint relationship between uᵢ and uⱼ(1≤i≤m, and 1≤j≤m, i≠j). The control attainable set is mathematically represented as follows:

$$Φ = \{ v \vert v = B \cdot u , u = {( {u}_{1} , … , {u}_{m} )}^{T} , u ∈ Ω \} \\ s . t . \\ {u}_{imin} \leq {u}_{i} \leq {u}_{imax} , i = 1 , L , m \qquad ( 1 - 2 )$$

The patent “Method for Determining Control Attainable Set of Overdrive System under One Pair of Linear Constraint Control Components” (Patent Application No.: ZL201911405624.0) solves a problem of determining a control attainable set of a redundant drive system with a linear constraint relationship between only one pair of actuators, but is not applicable to determining a control attainable set of a redundant drive system with a linear constraint relationship between a plurality of pairs of actuators. The patent “Method for Determining Control Attainable Set of Overdrive System under Each Pair of Linear Constraint Control Components” (Patent Application No.: ZL201911411744.1) and the patent “Method for Determining Control Attainable Set of Overdrive System under a Plurality of Pairs of Linear Constraint Control Components (Patent Application No.: ZL201911405939.5) solve a problem of determining a control attainable set when there is a constraint relationship between each actuator pair and when there is a constraint relationship among a plurality of pairs of actuators. However, the two patents require determining a quasi-key boundary surface first. For each quasi-key boundary surface, a vertex mapped onto a control attainable set is first calculated to obtain a plane equation, and then a vertex of a boundary surface that has been determined as a key boundary surface is mapped to obtain a vertex of the control attainable set, and the vertex of the control attainable set is substituted into the plane equation. Finally, whether the quasi-key boundary surface is the key boundary surface is determined based on a characteristic that the control attainable set is a convex set. Calculation steps are complex and error-prone, and as a result, a good application result cannot be achieved.

### SUMMARY

An objective of the present disclosure is to provide a method for calculating a control attainable set of a redundant drive system under a linear constraint to overcome the shortcomings in the existing technologies. The present disclosure solves a problem of determining a control attainable set of a parallel configuration redundant drive system in which the control attainable set is three-dimensional (3D) space, any three columns of a control efficiency matrix are linearly independent, and each pair of control components are linear constraint control components. The method can be used for evaluating a control capability of a parallel hybrid system with a redundant driving characteristic and each pair of control components being linear constraint control components in an advanced satellite, aircraft, ship, automobile, parallel robot, and the like. The present disclosure can provide a basis for control allocation of the system and be used for fault-tolerant control of the system after some actuators fail.

The present disclosure proposes a method for calculating a control attainable set of a redundant drive system under a linear constraint, including the following steps.
1) establishing an expression of a control attainable set of a redundant drive system under each pair of linear constraint control components as follows:

$$Φ = \{ v \vert v = B \cdot u , u = {( {u}_{1} , … , {u}_{m} )}^{T} , u ∈ Ω \} \\ s . t . \\ {u}_{imin} \leq {u}_{i} \leq {u}_{imax} , i = 1 , L , m \\ ( {u}_{kmax} - {u}_{kmin} ) {u}_{k + 1} + ( {u}_{k + 1 max} - {u}_{k + 1 min} ) {u}_{k} \leq {u}_{k + 1 max} {u}_{k max} - {u}_{k + 1 min} {u}_{k min} , \\ k = 1 , 3 , … , 2 [ \frac{m}{2} ] - 1 \qquad ( 1 )$$

where [m/2] represents an integer part obtained by dividing m by 2, u represents a control vector, the u is denoted as u_{ELR}, u_{ELR}=(u₁, . . . , uₘ)^{T}, uᵢₘᵢₙ≤uᵢ≤u_{i max}, i=1,L,m (u_{k max}−u_{k min}))uₖ₊₁+(uₖ₊₁ₘₐₓ−uₖ₊₁ₘᵢₙ)uₖ≤uₖ₊₁ₘₐₓu_{k max}−uₖ₊₁ₘᵢₙu_{k min}, and k=1, 3, . . . 2[m/2]−1;

where i^{th} control component uᵢ is a control action of a corresponding i^{th} actuator, where 1≤i≤m, and m represents a quantity of actuators; uᵢₘᵢₙ represents a minimum constraint value of the control action of the i^{th} actuator, and uᵢₘₐₓ represents a maximum constraint value of the control action of the i^{th} actuator; Ω represents a control set, and Ω={u}; v represents a control attainable vector of the redundant drive system, and v=(v₁, v₂, v₃)^{T}, which represents a control output of the redundant drive system; Φ represents the control attainable set; and B represents a 3-row and m-column control efficiency matrix; and
the expression (1) is rewritten to a following expression (2):

$${Φ}_{ELR} = \{ v \vert v = B \cdot {u}_{ELR} , {u}_{ELR} = {( {u}_{1} , … , {u}_{m} )}^{T} , {u}_{ELR} ∈ {Ω}_{ELR} \} \\ s . t . \\ {u}_{imin} \leq {u}_{i} \leq {u}_{imax} , i = 1 , L , m ; \\ ( {u}_{kmax} - {u}_{kmin} ) {u}_{k + 1} + ( {u}_{k + 1 max} - {u}_{k + 1 min} ) {u}_{k} \leq {u}_{k + 1 max} {u}_{kmax} - {u}_{k + 1 min} {u}_{kmin} , \\ k = 1 , 3 , … , 2 [ \frac{m}{2} ] - 1 \qquad ( 2 )$$

where uₖ and uₖ₊₁ represent a pair of control components with a linear constraint, Φ_{ELR} represents a control attainable set of a redundant drive system with each pair of control components being linear constraint control components, Ω_{ELR} represents a control set, u_{ELR} represents a control vector, and Ω_{ELR}={u_{ELR}};
2) classifying all boundary surfaces of the control set Ω_{ELR} obtained in the step 1) into four types, which includes:
using, as a vertex of the control set Ω_{ELR} a point obtained by taking a corresponding maximum or minimum constraint value of each component uᵢ of the control vector u_{ELR}=(u₁, . . . , uₘ)^{T}, where the m-dimensional control set Ω_{ELR} represented in the expression (2) has

$${3}^{[ \frac{m}{2} ]} \cdot {2}^{( \frac{m}{2} )}$$

vertices, and [m/2] represents a remainder of dividing m by 2; and
setting ∂(Ω_{ELR}) to represent a boundary of the Ω_{ELR}, and classifying boundary surfaces of the ∂(Ω_{ELR}) into a type-rectangular boundary surface, a type-rectangular boundary surface, a type-=2 \*ROMAN I rectangular boundary surface, and a triangular boundary surface based on a value of each component of each vertex, which specifically includes:
assuming that four vertices of the rectangular boundary surface are denoted as A, B, D, and C in clockwise order, and three vertices of the triangular boundary surface are denoted as A, C, and B in clockwise order,
if any rectangular boundary surface satisfies following conditions: for the vertices A and B, one component has a different value, and other components have a same value; for the vertices A and C, one component of another pair of components has a different value, and other components have a same value; and for the vertices A and D, the above two components have different values, and other components have a same value, determining that the rectangular boundary surface is the type-rectangular boundary surface;
if any rectangular boundary surface satisfies following conditions: for the vertex A and the vertex B, one pair of linear constraint components have different values, and other components have a same value; for the vertex C and the vertex D, the one pair of linear constraint components have different values, and other components have a same value; and for the vertex A and the vertex C, the one pair of linear constraint components have a same value, and other components have a same value except that one of the other components has a different value, determining that the rectangular boundary surface is the type-rectangular boundary surface;
if any rectangular boundary surface satisfies following conditions: for the vertex A and the vertex B, one pair of linear constraint components have different values, and other components have a same value; for the vertex A and the vertex C, another pair of linear constraint components have different values, and other components have a same value; and for the vertex D and the vertex A, each of the above two pairs of linear constraint components has a different value, and other components have a same value, determining that the rectangular boundary surface is the type-=2 \*ROMAN I rectangular boundary surface; and
if any right angle satisfies following conditions: for the vertex A and the vertex B, one pair of linear constraint components have different values, and other components have a same value;
for the vertex A and the vertex C, one component of the one pair of linear constraint components has a different value, and other components have a same value; and for the vertex B and the vertex C, the other component of the one pair of linear constraint components has a different value, and other components have a same value, determining that the right angle is the triangular boundary surface;
3) dividing all the boundary surfaces of the control set into groups, where
if values of two components in the u_{ELR} are between the corresponding minimum and maximum values, and values of other m−2 components are the corresponding minimum or maximum value, the m components form 2^{m-2} boundary surfaces of the control set; and
if any two components in the u_{ELR} are denoted as a p^{th} component and a q^{th} component, values of the p^{th} component and the q^{th} component are between the corresponding minimum and maximum values, 1≤p≤m, 1≤q≤m, p<q values of other m−2 components are the corresponding minimum or maximum value, and a formed boundary surface is denoted as a P−q group, all the boundary surfaces of the control set are divided into the Cₘ² groups;
4) determining a key boundary surface for each of the Cₘ² groups in the step 3), where
a boundary surface of an image mapped onto the Φ_{ELR} in the Ω_{ELR} of a boundary ∂(Φ_{ELR}) is denoted as the key boundary surface, the Ω is denoted as a set of key boundary surfaces, the Ω is initialized as an empty set, and the step includes following substeps:
4-1) selecting any group for which no key boundary surface has been determined, denoting the group as a current p-q group, and performing a step 4-2);
4-2) determining whether the p^{th} control component and the q^{th} control component are a pair of linear constraint components; and
if they are a pair of linear constraint components, performing a step 4-3);
if they are not a pair of linear constraint components, and m is an even number, performing a step 4-4);
if they are not a pair of linear constraint components, m is an odd number, and the p^{th} and q^{th} control components each have a paired linear constraint component, performing a step 4-4); or
if they are not a pair of linear constraint components, m is an odd number, and the q^{th} control component has no paired linear constraint component, performing a step 4-5);
4-3) when the p^{th} control component and the q^{th} control component are a pair of linear constraint components, determining a key boundary surface of the p-q group according to a following specific method:
4-3-1) when the p^{th} control component and the q^{th} control component are a pair of linear constraint components, determining that all boundary surfaces of the group are triangular boundary surfaces, where a value of each component of each point on the boundary surface satisfies a following formula:

$$\{ \begin{matrix}{u}_{pmin} \leq {u}_{p} \leq {u}_{pmax} \\ {u}_{qmin} \leq {u}_{q} \leq \frac{{u}_{qmax} {u}_{pmax} - {u}_{qmin} {u}_{pmin} - ( {u}_{qmax} - {u}_{qmin} ) {u}_{p}}{( {u}_{pmax} - {u}_{pmin} )} \\ {u}_{i} ∈ \{ {u}_{imin} , {u}_{imax} \} , i ∈ {Z}^{+} , 1 \leq i \leq m , i \neq p , q\end{matrix} \qquad ( 3 )$$

where a vertex of each boundary surface in the group is represented by an m-row and 3-column matrix Δ, and 3 columns are vectors corresponding to 3 vertices; values of the p^{th} and q^{th} components of three vertices on each boundary surface are shown in p^{th} and q^{th} rows of the matrix Δ, while values of other components are all the uᵢₘₐₓ or the uᵢₘᵢₙ; one pair of linear constraint components in the other components do not simultaneously take a maximum constraint value corresponding to the one pair of linear constraint components; and the p^{th} row of the matrix Δ is (uₚₘₐₓ, uₚₘᵢₙ, uₚₘᵢₙ), and the q^{th} row is (u_{qmin}, u_{qmin}, u_{qmax});

$$Δ = [ \begin{matrix}… & … & … \\ {u}_{pmax} & {u}_{pmin} & {u}_{pmin} \\ {u}_{qmin} & {u}_{qmin} & {u}_{qmax} \\ … & … & …\end{matrix} ] ;$$

4-3-2) constructing a coordinate rotation transformation ¹T, such that a transformed coordinate axis v₁ is perpendicular to an image of the triangular boundary surface of the group, which specifically includes: setting

$${}^{1} T = [ \begin{matrix}{}^{1} {t}_{11} & {}^{1} {t}_{12} & {}^{1} {t}_{13} \\ {}^{1} {t}_{21} & {}^{1} {t}_{22} & {}^{1} {t}_{23} \\ {}^{1} {t}_{31} & {}^{1} {t}_{32} & {}^{1} {t}_{33}\end{matrix} ] , B = [ \begin{matrix}{b}_{11} … {b}_{1 p} … {b}_{1 q} … {b}_{1 m} \\ {b}_{21} … {b}_{2 p} … {b}_{2 q} … {b}_{2 m} \\ {b}_{31} … {b}_{3 p} … {b}_{3 q} … {b}_{3 m}\end{matrix} ] , and \\ {}^{1} C = [ \begin{matrix}{}^{1} {c}_{11} … {}^{1} {c}_{1 p} … {}^{1} {c}_{1 q} … {}^{1} {c}_{1 m} \\ {}^{1} {c}_{21} … {}^{1} {c}_{2 p} … {}^{1} {c}_{2 q} … {}^{1} {c}_{2 m} \\ {}^{1} {c}_{31} … {}^{1} {c}_{3 p} … {}^{1} {c}_{3 q} … {}^{1} {c}_{3 m}\end{matrix} ] ,$$

where ¹cᵢⱼ represents an element of an i^{th} row and a j^{th} column of the matrix ¹C, ¹tᵢⱼ represents an element of an i^{th} row and a j^{th} column of the matrix ¹T, and bᵢⱼ represents an element of an i^{th} row and a j^{th} column of the matrix B;
setting ¹C=¹T·B, such that ¹c₁ₚ=0 and ¹c_{1q}=0;
substituting the ¹T and the B into the ¹C=¹T·B to obtain a following equation set:

$$\{ \begin{matrix}{\sum }_{s = 1}^{3} {}^{1} {t}_{1 s} \cdot {b}_{sp} = 0 \\ {\sum }_{s = 1}^{3} {}^{1} {t}_{1 s} \cdot {b}_{sq} = 0\end{matrix} \qquad ( 4 )$$

solving the linear equation set (4) to obtain a first row (¹t₁₁, ¹t₁₂, ¹t₁₃) of the ¹T; and
calculating a first row (¹c₁₁, . . . , ¹c₁ₘ) of the matrix ¹C according to the ¹C=T·B;
4-3-3) processing other rows than the rows p, q of the matrix Δ according to a following rule, where a boundary surface represented by an obtained matrix is the key boundary surface and placed into the set Ω, and 1≤i≤m,i is an integer, i≠p, q; and
the rule is as follows:
when ¹c₁ᵢ·¹c₁ᵢ₊₁<0,
if ¹c₁ᵢ>0 and ¹c₁ᵢ₊₁<0, setting an i^{th} row of the matrix Δ to the uᵢₘₐₓ and an i+1^{th} row to u_{i+1 min}; or
if ¹c₁ᵢ<0 and ¹c₁ᵢ₊₁<0, setting an i^{th} row of the matrix Δ to the uᵢₘᵢₙ and an i+1^{th} row to uᵢ₊₁ₘₐₓ;
when ¹c₁ᵢ<0 and ¹c₁ᵢ₊₁<0,
setting an i^{th} row of the matrix Δ to the uᵢₘᵢₙ and an i+1^{th} row to uᵢ₊₁ₘᵢₙ; or
when ¹c₁ᵢ>0 and ¹c₁ᵢ₊₁<0,
calculating ¹z₀₁=¹c₁ᵢ·uᵢₘₐₓ+¹c₁ᵢ₊₁·uᵢ₊₁ₘᵢₙ and ¹z₀₂=¹c₁ᵢ·uᵢₘᵢₙ+¹c₁ᵢ₊₁·uᵢ₊₁ₘₐₓ, and then performing determining as follows:
if ¹z₀₁>¹z₀₂, setting an i^{th} row of the matrix Δ to the uᵢₘₐₓ and an i+1^{th} row to uᵢ₊₁ₘᵢₙ; if ¹z₀₁<¹z₀₂ setting an i^{th} row of the matrix Δ to the uᵢₘᵢₙ and an i+1^{th} row to uᵢ₊₁ₘₐₓ; or if ¹z₀₁=¹z₀₂, setting an i^{th} row and an i+1^{th} row of the matrix Δ as follows: setting the i^{th} row of the matrix Δ to the uᵢₘₐₓ and the i+1^{th} row to uᵢ₊₁ₘᵢₙ; or setting the i^{th} row of the matrix Δ to the uᵢₘᵢₙ and the i+1^{th} row to uᵢ₊₁ₘₐₓ;
4-3-4) processing other rows than the rows p, q of the matrix Δ according to a following rule, where a boundary surface represented by an obtained matrix is the key boundary surface and placed into the set Ω; and then performing a step 4-6), where 1≤i≤m,i is an integer, i≠p, q; and
the rule is as follows:
when ¹c₁ᵢ·¹c₁ᵢ₊₁<0,
if ¹c₁ᵢ>0 and ¹c₁ᵢ₊₁<0, setting the i^{th} row of the matrix Δ to the uᵢₘᵢₙ and the i+1^{th} row to the uᵢ₊₁ₘₐₓ; or
if ¹c₁ᵢ<0 and ¹c₁ᵢ₊₁>0, setting the i^{th} row of the matrix Δ to the uᵢₘₐₓ and the i+1^{th} row to u_{i+1 min};
when ¹c₁ᵢ>0 and ¹c₁ᵢ₊₁>0,
setting the i^{th} row of the matrix Δ to the uᵢₘᵢₙ and the i+1^{th} row to the uᵢ₊₁ₘᵢₙ; or
when ¹c₁ᵢ<0 and ¹c₁ᵢ₊₁<0,
calculating ²z₀₁=¹c₁ᵢ·uᵢₘₐₓ+¹c₁ᵢ₊₁·uᵢ₊₁ₘᵢₙ and ²z₀₂=¹c₁ᵢ·uᵢₘᵢₙ+¹c₁ᵢ₊₁·uᵢ₊₁ₘₐₓ and performing determining as follows: if ²z₀₁>²z₀₂, setting the i^{th} row of the matrix Δ to the uᵢₘᵢₙ and the i+1^{th} row to the uᵢₘₐₓ; if ²z₀₁<²z₀₂, setting the i^{th} row of the matrix Δ to the uᵢₘₐₓ and the i+1^{th} row to the uᵢ₊₁ₘᵢₙ; or if ¹z₀₁=¹z₀₂, setting the i^{th} row and the i+1^{th} row of the matrix Δ as follows: setting the i^{th} row of the matrix Δ to the uᵢₘₐₓ and the i+1^{th} row to the uᵢ₊₁ₘᵢₙ; or setting the i^{th} row of the matrix Δ to the uᵢₘᵢₙ and the i+1^{th} row to the uᵢ₊₁ₘₐₓ;
4-4) when the p^{th} control component and the q^{th} control component are not a pair of linear constraint components, and each have the paired linear constraint component, determining a key boundary surface of the p-q group according to a following specific method:
4-4-1) denoting the component paired with the p^{th} component as a p component, and the component paired with the q^{th} component as a q′^{th} component, where the p-q group has three types of rectangular boundary surfaces, and each component of each point on the boundary surfaces of the group has a value that satisfies a following formula:

$$\{ \begin{matrix}{u}_{p min} \leq {u}_{p} \leq {u}_{p max} \\ {u}_{q min} \leq {u}_{q} \leq {u}_{q max} \\ {u}_{{p}^{′}} ∈ \{ {u}_{{p}^{′} min} , \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} \} \\ {u}_{{q}^{′}} ∈ \{ {u}_{{q}^{′} min} , \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} \} \\ {u}_{i} ∈ \{ {u}_{i min} , {u}_{i max} \} , 1 \leq i \leq m , i \neq p , q , {p}^{′} , {q}^{′} \\ {u}_{k} + {u}_{k + 1} < {u}_{k max} + {u}_{k + 1 max} , k = 1 , 3 , … , 2 [ \frac{m}{2} ] - 1 , k \neq p , q , {p}^{′} , {q}^{′}\end{matrix} \qquad ( 5 )$$

when u_{p′}=u_{p′min} and u_{q′}=u_{q′min}, determining that a boundary surface formed by a point satisfying the formula (5) is the type-I rectangular boundary surface;
when u_{p′}=u_{p′min} and

$${u}_{{q}^{′}} = \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$

determining that a boundary surface formed by a point satisfying the formula (5) is the type-II rectangular boundary surface;
when

$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )}$$

and u_{q′}=u_{q′min}, determining that a boundary surface formed by a point satisfying the formula (5) also is the type-II rectangular boundary surface;
when

$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} and$$

$${u}_{{q}^{′}} = \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$

determining that a boundary surface formed by a point satisfying the formula (5) is the type-III rectangular boundary surface; and
representing a vertex of each rectangular boundary surface of the group by using an m-row and 4-column matrix, where 4 columns respectively represent vectors corresponding to 4 vertices; a matrix Λ represents a vertex of one type-I rectangular boundary surface, a matrix ¹Π or ²Π represents a vertex of one type-II rectangular boundary surface, and a matrix T represents a vertex of one type-III rectangular boundary surface; values of the p^{th}, p′^{th}, q^{th}, and q′^{th} components of four vertices of each boundary surface are shown in a p^{th} row, a p′^{th} row, a q^{th} row, and a q′^{th} row of the matrix, and other components are all the uᵢₘₐₓ or the uᵢₘᵢₙ; one pair of linear inequality constraint components do not simultaneously take a maximum constraint value corresponding to the one pair of linear inequality constraint components; for the Λ, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min});
for the ¹Λ, the p^{th} row is (uₚₘₐₓ, uₚₘᵢₙ, uₚₘᵢₙ, uₚₘₐₓ), the p′^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min});
for the ²Π, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}, the q^{th} row is (u_{qmin}, u_{qmin}, u_{qmax}, u_{qmax}), and the q′^{th} row is (u_{q′max}, u_{q′max}, u_{q′min}, u_{q′min});
for the T, the p^{th} row is (uₚₘₐₓ, uₚₘᵢₙ, uₚₘᵢₙ, uₚₘₐₓ), the p′^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′max}, u_{q′max}, u_{q′min}, u_{q′min});

$$Λ = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] , \qquad ( 6 )$$

$${}^{1} Π = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] ,$$

$${}^{2} Π = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ] ,$$

$$T = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ] ,$$

where if P is an odd number, the p^{th} row comes before the p′^{th} row; if p is an even number, the p^{th} row comes after the p′^{th} row; if q is an odd number, the q^{th} row comes before the q′^{th} row; and if q is an even number, the q^{th} row comes after the q′^{th} row;
4-4-2) constructing a coordinate rotation transformation G, such that a transformed coordinate axis v₁ is perpendicular to an image of the type-III rectangular boundary surface, and images of all points on the boundary surface have equal coordinate values on the v₁ axis, which specifically includes:
setting

$$G = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] ,$$

$$B = [ \begin{matrix}{b}_{11} & … & {b}_{1 p} & {b}_{1 {p}^{′}} & … & {b}_{1 q} & {b}_{1 {q}^{′}} & … & {b}_{1 m} \\ {b}_{21} & … & {b}_{2 p} & {b}_{2 {p}^{′}} & … & {b}_{2 q} & {b}_{2 {q}^{′}} & … & {b}_{2 m} \\ {b}_{31} & … & {b}_{3 p} & {b}_{3 {p}^{′}} & … & {b}_{3 q} & {b}_{3 {q}^{′}} & … & {b}_{3 m}\end{matrix} ] , and$$

$$E = [ \begin{matrix}{e}_{11} & … & {e}_{1 p} & {e}_{1 {p}^{′}} & … & {e}_{1 q} & {e}_{1 {q}^{′}} & … & {e}_{1 m} \\ {e}_{21} & … & {e}_{2 p} & {e}_{2 {p}^{′}} & … & {e}_{2 q} & {e}_{2 {q}^{′}} & … & {e}_{2 m} \\ {e}_{31} & … & {e}_{3 p} & {e}_{3 {p}^{′}} & … & {e}_{3 q} & {e}_{3 {q}^{′}} & … & {e}_{3 m}\end{matrix} ] ,$$

where gᵢⱼ represents an element of an i^{th} row and a j^{th} column of the matrix G, and eᵢⱼ represents an element of an i^{th} row and a j^{th} column of the matrix E;
setting E=G·B, such that

$${e}_{1 {p}^{′}} = \frac{{u}_{p max} - {u}_{p min}}{{u}_{{p}^{′} max} - {u}_{{p}^{′} min}} {e}_{1 p} , {e}_{1 {q}^{′}} = \frac{{u}_{q max} - {u}_{q min}}{{u}_{{q}^{′} max} - {u}_{{q}^{′} min}} {e}_{1 q} ;$$

and substituting the G and the B into the E=G·B to obtain a following equation set:

$$\{ \begin{matrix}{\sum }_{s = 1}^{3} {g}_{1 s} \cdot {b}_{sp} = {e}_{1 p} \\ {\sum }_{s = 1}^{3} {g}_{1 s} \cdot {b}_{{sp}^{′}} = \frac{{u}_{p max} - {u}_{p min}}{{u}_{{p}^{′} max} - {u}_{{p}^{′} min}} {e}_{1 p} \\ {\sum }_{s = 1}^{3} {g}_{1 s} \cdot {b}_{sq} = {e}_{1 q} \\ {\sum }_{s = 1}^{3} {g}_{1 s} \cdot {b}_{{sq}^{′}} = \frac{{u}_{q max} - {u}_{q min}}{{u}_{{q}^{′} max} - {u}_{{q}^{′} min}} {e}_{1 q}\end{matrix} \qquad ( 7 )$$

solving the linear equation set (7) to obtain a first row of the G, and calculating a first row (e₁₁, . . . , e₁ₘ) of the matrix E according to the E=G·B; and if e_{1p′}>0 and e_{1q′}>0, performing a step 4-4-3); if and e_{1p′}<0 and e_{1q′}<0, performing a step 4-4-4); or if e_{1p′}·e_{1q′}<0 performing a step 4-4-5);
4-4-3) processing other rows than the rows p, q, p′, q′ of the matrix T according to a following rule, where a boundary surface represented by an obtained matrix is the key boundary surface and placed into the set Ω; and then performing the step 4-4-5), where i=1, . . . , m, i≠p, p′, q, q′; and
the rule is as follows:
when e₁ᵢ·e₁ᵢ₊₁<0,
if e₁ᵢ>0 and e₁ᵢ₋₁<0, setting an i^{th} row of the matrix T to the uᵢₘₐₓ and an i+1^{th} row to uᵢ₊₁ₘᵢₙ; or
if e₁ᵢ<0 and e₁ᵢ₊₁>0, setting an i^{th} row of the matrix T to the uᵢₘᵢₙ and an i+1^{th} row to uᵢ₊₁ₘₐₓ;
when e₁ᵢ<0 and e₁ᵢ₊₁<0 ^{(i=1, . . . , m,i≠p, p′,q,q′)},
setting an i^{th} row of the matrix T to the uᵢₘᵢₙ and an i+1^{th} row to uᵢ₊₁ₘᵢₙ; or
when e₁ᵢ>0 and e₁ᵢ₊₁>0,
calculating ¹d₀₁=e₁ᵢ·uᵢₘₐₓ+e₁ᵢ₊₁ₘᵢₙ and ¹d₀₂=e₁ᵢ·uᵢₘᵢₙ+e₁ᵢ₊₁ₘₐₓ, and performing determining as follows: if ¹d₀₁>¹d₀₂, setting an i^{th} row of the matrix T to the uᵢₘₐₓ and an i+1^{th} row to uᵢ₊₁ₘᵢₙ; if ¹d₀₁<¹d₀₂, setting an i^{th} row of the matrix T to the uᵢₘᵢₙ and an i+1^{th} row to uᵢ₊₁ₘₐₓ; or if ¹d₀₁=¹d₀₂, setting an i^{th} row and an i+1^{th} row of the matrix T as follows: setting the i^{th} row of the matrix T to the uᵢₘₐₓ and the i+1^{th} row to the uᵢ₊₁ₘᵢₙ; or setting the i^{th} row of the matrix T to the uᵢₘᵢₙ and the i+1^{th} row to the uᵢ₊₁ₘₐₓ;
4-4-4) processing other rows than the rows p, q, p′, q′ of the matrix T according to a following rule, where a boundary surface represented by an obtained matrix is the key boundary surface and placed into the set Ω; and then performing the step 4-4-5), where i=1, . . . , m, i≠p, p′, q, q′; and
the rule is as follows:
when e₁ᵢ·e₁ᵢ₊₁<0,
if e₁ᵢ>0 and e₁ᵢ₊₁<0, setting an i^{th} row of the matrix T to the uᵢₘᵢₙ and an i+1^{th} row to uᵢ₊₁ₘₐₓ; or
if e₁ᵢ<0 and e₁ᵢ₊₁>0, setting an i^{th} row of the matrix T to the uᵢₘₐₓ and an i+1^{th} row to uᵢ₊₁ₘᵢₙ;
when e₁ᵢ<0 and e₁ᵢ₊₁<0,
calculating ²d₀₁=²h₁ᵢ·uᵢₘₐₓ+²h₁ᵢ₊₁·+uᵢ₊₁ₘᵢₙ and ²d₀₂=²h₁ᵢ·uᵢₘᵢₙ+²h₁ᵢ₊₁·uᵢ₊₁ₘₐₓ and if ²d₀₁>²d₀₂, setting an i^{th} row of the matrix T to the uᵢₘᵢₙ and an i+1^{th} row to uᵢ₊₁ₘₐₓ; if ²d₀₁<²d₀₂, setting an i^{th} row of the matrix T to the uᵢₘₐₓ and an i+1^{th} row to uᵢ₊₁ₘᵢₙ; or if ²d₀₁=²d₀₂, setting an i^{th} row and an i+1^{th} row of the matrix T as follows: setting the i^{th} row of the matrix T to the uᵢₘₐₓ and the i+1^{th} row to uᵢ₊₁ₘᵢₙ; or setting the i^{th} row of the matrix T to the uᵢₘᵢₙ and the i+1^{th} row to uᵢ₊₁ₘₐₓ; or
when e₁ᵢ>0 and e₁ᵢ₊₁>0,
setting an i^{th} row of the matrix T to the uᵢₘᵢₙ and an i+1^{th} row to uᵢ₊₁ₘᵢₙ;
4-4-5) constructing a coordinate rotation transformation ²T, such that a transformed coordinate axis v₁ is perpendicular to an image of the type-I rectangular boundary surface of the group, which specifically includes: setting

$${}^{2} T = [ \begin{matrix}{}_{}^{2} {t}_{11}^{} & {}_{}^{2} {t}_{12}^{} & {}_{}^{2} {t}_{13}^{} \\ {}_{}^{2} {t}_{21}^{} & {}_{}^{2} {t}_{22}^{} & {}_{}^{2} {t}_{23}^{} \\ {}_{}^{2} {t}_{31}^{} & {}_{}^{2} {t}_{32}^{} & {}_{}^{2} {t}_{33}^{}\end{matrix} ] , B = [ \begin{matrix}{b}_{11} … {b}_{1 p} … {b}_{1 q} … {b}_{1 m} \\ {b}_{21} … {b}_{2 p} … {b}_{2 q} … {b}_{2 m} \\ {b}_{31} … {b}_{3 p} … {b}_{3 q} … {b}_{3 m}\end{matrix} ] , and$$

$${}^{2} C = [ \begin{matrix}{}_{}^{2} {c}_{11}^{} … {}_{}^{2} {c}_{1 p}^{} … {}_{}^{2} {c}_{1 q}^{} … {}_{}^{2} {c}_{1 m}^{} \\ {}_{}^{2} {c}_{21}^{} … {}_{}^{2} {c}_{2 p}^{} … {}_{}^{2} {c}_{2 q}^{} … {}_{}^{2} {c}_{2 m}^{} \\ {}_{}^{2} {c}_{31}^{} … {}_{}^{2} {c}_{3 p}^{} … {}_{}^{2} {c}_{3 q}^{} … {}_{}^{2} {c}_{3 m}^{}\end{matrix} ] ,$$

where ²Cᵢⱼ represents an element of an i^{th} row and a j^{th} column of the matrix ²C, and ²tᵢⱼ represents an element of an i^{th} row and a j^{th} column of the matrix ²T;
setting ²C=²T·B, such that ²c₁ₚ=0 and ²C_{1q}=0; and substituting the ²T and the B into the ²C=²T·B to obtain a following equation set:

$$\{ \begin{matrix}{\sum }_{s = 1}^{3} {}_{}^{2} {t}_{1 s} \cdot {b}_{sp} = 0 \\ {\sum }_{s = 1}^{3} {}_{}^{2} {t}_{1 s} \cdot {b}_{sq} = 0\end{matrix} \qquad ( 8 )$$

solving the linear equation set (8) to obtain a first row (²t₁₁, ²t₁₂, ²t₁₃) of the ²T, and calculating a first row (²C₁₁, . . . , ²C₁ₘ) of the matrix ²C according to the ²C=²T·B; and
if ²c_{1p′}<0 and ²C_{1q′}<0 performing a step 4-4-6); if ²c_{1p′}>0 and ²C_{1q′}>0, performing a step 4-4-7); or if ²c_{1p′}·²C_{1q′}<0, performing a step 4-4-8);
4-4-6) processing other rows than the rows p, q, p′, q′ of the matrix Λ according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-8); where
the rule is as follows:
when ²c₁ᵢ·²c₁ᵢ₊₁<0,
if ²c₁ᵢ>0 and ²c₁ᵢ₊₁<0 setting an i^{th} row of the matrix Λ to the uᵢₘₐₓ and an i+1^{th} row to uᵢ₊₁ₘᵢₙ; or
if ²c₁ᵢ<0 and ²c₁ᵢ₊₁>0, setting an i^{th} row of the matrix Λ to the uᵢₘᵢₙ and an i+1^{th} row to uᵢ₊₁ₘₐₓ;
when ²c₁ᵢ<0 and ²c₁ᵢ₊₁<0,
setting an i^{th} row of the matrix Λ to the uᵢₘᵢₙ and an i+1^{th} row to uᵢ₊₁ₘᵢₙ; or
when ²c₁ᵢ>0 and ²c₁ᵢ₊₁>0,
calculating ³d₀₁=²c₁ᵢ·uᵢₘₐₓ+²c₁ᵢ₊₁·uᵢ₊₁ₘᵢₙ, and ³d₀₂=²c₁ᵢ·uᵢₘᵢₙ+²c₁ᵢ₊₁·uᵢ₊₁ₘₐₓ; and if ³d₀₁>³d₀₂, setting an i^{th} row of the matrix Λ to the uᵢₘₐₓ and an i+1^{th} row to uᵢ₊₁ₘᵢₙ; if ³d₀₁<³d₀₂, setting an i^{th} row of the matrix Λ to the uᵢₘᵢₙ and an i+1^{th} row to uᵢ₊₁ₘₐₓ; or if ³d₀₁=³d₀₂, setting an i^{th} row and an i+1^{th} row of the matrix Λ as follows: setting the i^{th} row of the matrix Λ to the uᵢₘₐₓ and the i+1^{th} row to uᵢ₊₁ₘᵢₙ; or setting the i^{th} row of the matrix Λ to the uᵢₘᵢₙ and the i+1^{th} row to uᵢ₊₁ₘₐₓ;
4-4-7) processing other rows than the rows p, q, p′, q′ of the matrix according Λ to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-8); where
the rule is as follows:
when ²c₁ᵢ·²c₁ᵢ₊₁<0,
if ²c₁ᵢ>0 and ²c₁ᵢ₊₁<0, setting an i^{th} row of the matrix Λ to the uᵢₘᵢₙ and an i+1^{th} row to uᵢ₊₁ₘₐₓ; or
if ²c₁ᵢ<0 and ²c₁ᵢ₊₁>0 setting an i^{th} row of the matrix Λ to the uᵢₘₐₓ and an i+1^{th} row to uᵢ₊₁ₘᵢₙ;
when ²c₁ᵢ<0 and ²c₁ᵢ₊₁<0,
calculating ⁴d₀₁=²c₁ᵢ·uᵢₘₐₓ+²c₁ᵢ₊₁·uᵢ₊₁ₘᵢₙ and ⁴d₀₂=²c₁ᵢ·uᵢₘᵢₙ+²c₁ᵢ₊₁·uᵢ₊₁ₘₐₓ; and if ⁴d₀₁>⁴d₀₂, setting an i^{th} row of the matrix Λ to the uᵢₘᵢₙ and an i+1^{th} row to uᵢ₊₁ₘₐₓ; if ⁴d₀₁<⁴d₀₂, setting an i^{th} row of the matrix Λ to the uᵢₘₐₓ and an i+1^{th} row to uᵢ₊₁ₘᵢₙ; or if ⁴d₀₁=⁴d₀₂, setting an i^{th} row and an i+1^{th} row of the matrix Λ as follows: setting the i^{th} row of the matrix Λ to the uᵢₘₐₓ and the i+1^{th} row to uᵢ₊₁ₘᵢₙ; or setting the i^{th} row of the matrix Λ to the uᵢₘᵢₙ and the i+1^{th} row to uᵢ₊₁ₘₐₓ; or
when ²c₁ᵢ>0 and ²c₁ᵢ₊₁>0,
setting an i^{th} row of the matrix Λ to the uᵢₘᵢₙ and an i+1^{th} row to u_{i+1 min};
4-4-8) constructing a coordinate rotation transformation ¹F, such that a transformed coordinate axis v₁ is Perpendicular to an Image of a Boundary Surface Whose Vertex Matrix is the ¹Π in the group, and images of all points on the boundary surface have equal coordinate values on the v₁ axis, which specifically includes: setting

$${}^{1} F = [ \begin{matrix}{}_{}^{1} {f}_{11}^{} & {}_{}^{1} {f}_{12}^{} & {}_{}^{1} {f}_{13}^{} \\ {}_{}^{1} {f}_{21}^{} & {}_{}^{1} {f}_{22}^{} & {}_{}^{1} {f}_{23}^{} \\ {}_{}^{1} {f}_{31}^{} & {}_{}^{1} {f}_{32}^{} & {}_{}^{1} {f}_{33}^{}\end{matrix} ] ,$$

$$B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] , and$$

$${}^{1} H = [ \begin{matrix}{}_{}^{1} {h}_{11}^{} & … & {}_{}^{1} {h}_{1 p}^{} & {}_{}^{1} {h}_{1 {p}^{′}}^{} & … & {}_{}^{1} {h}_{1 q}^{} & … & {}_{}^{1} {h}_{1 m}^{} \\ {}_{}^{1} {h}_{21}^{} & … & {}_{}^{1} {h}_{2 p}^{} & {}_{}^{1} {h}_{2 {p}^{′}}^{} & … & {}_{}^{1} {h}_{2 q}^{} & … & {}_{}^{1} {h}_{2 m}^{} \\ {}_{}^{1} {h}_{31}^{} & … & {}_{}^{1} {h}_{3 p}^{} & {}_{}^{1} {h}_{3 {p}^{′}}^{} & … & {}_{}^{1} {h}_{3 p}^{} & … & {}_{}^{1} {h}_{3 m}^{}\end{matrix} ] ,$$

where ¹fᵢⱼ represents an element of an i^{th} row and a j^{th} column of the matrix ¹F, and ¹hᵢⱼ represents an element of an i^{th} row and a j^{th} column of the matrix ¹H;
setting ¹H=¹F·B, such that

$${}_{}^{1} {h}_{1 {p}^{′}}^{} = \frac{{u}_{p max} - {u}_{p min}}{{u}_{{p}^{′} max} - {u}_{{p}^{′} min}} {}_{}^{1} {h}_{1 p}^{}$$

and ¹_{1q}=0; and substituting the ¹F and the B into the ¹H= ¹F·B to obtain a following equation set:

$$\{ \begin{matrix}{\sum }_{s = 1}^{3} {}_{}^{1} {f}_{1 s}^{} \cdot {b}_{sp} = {}_{}^{1} {h}_{1 p}^{} \\ {\sum }_{s = 1}^{3} {}_{}^{1} {f}_{1 s}^{} \cdot {b}_{{sp}^{′}} = \frac{{u}_{p max} - {u}_{p min}}{{u}_{{p}^{′} max} - {u}_{{p}^{′} min}} {}_{}^{1} {h}_{1 p}^{} \\ {\sum }_{s = 1}^{3} {}_{}^{1} {f}_{1 s}^{} \cdot {b}_{sq} = 0\end{matrix} \qquad ( 9 )$$

solving the linear equation set (9) to obtain a first row of the ¹F, and calculating a first row (¹h₁₁, . . . , ¹h₁ₘ) of the matrix ¹H according to the ¹H=¹F·B; and
if ¹h_{1p′}>0 ¹h_{1q′}<0, performing a step 4-4-9); if ¹h_{1p′}<0 and ¹h_{1q′}>0, performing a step 4-4-10); or if ¹h_{1p′}·¹h_{1q′}>0, performing a step 4-4-11);
4-4-9) processing other rows than the rows p, q, P′, q′ of the matrix ¹Π according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-11); where
the rule is as follows:
when ¹h₁ᵢ·¹h₁ᵢ₊₁<0,
if ¹h₁ᵢ>0 and ¹h₁ᵢ₊₁<0, setting an i^{th} row of the matrix ¹Π to the uᵢₘₐₓ and an i+1^{th} row to uᵢ₊₁ₘᵢₙ; or
if ¹h₁ᵢ<0 and ¹h₁ᵢ₊₁>0, setting an i^{th} row of the matrix ¹Π to the uᵢₘᵢₙ and an i+1^{th} row to uᵢ₊₁ₘₐₓ;
when ¹h₁ᵢ<0 and ¹h₁ᵢ₊₁<0,
setting an i^{th} row of the matrix ¹Π to the uᵢₘᵢₙ and an i+1^{th} row to uᵢ₊₁ₘᵢₙ; or
when ¹h₁ᵢ>0 and ¹h₁ᵢ₊₁>0,
calculating ⁵d₀₁=¹h₁ᵢ·uᵢₘₐₓ+¹h₁ᵢ₊₁·uᵢ₊₁ₘᵢₙ and ⁵d₀₂=¹h₁ᵢ·uᵢₘᵢₙ+¹h₁ᵢ₊₁·uᵢ₊₁ₘₐₓ; and if ⁵d₀₁>⁵d₀₂, setting an i^{th} row of the matrix ¹Π to the uᵢₘₐₓ and an i+1^{th} row to uᵢ₊₁ₘᵢₙ; if ⁵d₀₁<⁵d₀₂, setting an i^{th} row of the matrix ¹Π to the uᵢₘᵢₙ and an i+1^{th} row to uᵢ₊₁ₘₐₓ; or if ⁵d₀₁=⁵d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and the i+1^{th} row to uᵢ₊₁ₘₐₓ;
4-4-10) processing other rows than the rows p, q, p′, q′ of the matrix ¹Π according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-11); where
the rule is as follows:
when ¹h₁ᵢ·¹h₁ᵢ₊₁<0,
if ¹h₁ᵢ>0 and ¹h₁ᵢ₊₁<0, setting an i^{th} row of the matrix ¹Π to the uᵢₘᵢₙ and an i+1^{th} row to uᵢ₊₁ₘₐₓ; or
if ¹h₁ᵢ<0 and ¹h₁ᵢ₊₁>0, setting an i^{th} row of the matrix ¹Π to the uᵢₘₐₓ and an i+1^{th} row to uᵢ₊₁ₘᵢₙ;
when ¹h₁ᵢ>0 and ¹h₁ᵢ₊₁>0,
setting an i^{th} row of the matrix ¹Π to the uᵢₘᵢₙ and an i+1^{th} row to uᵢ₊₁ₘᵢₙ; or
when ¹h₁ᵢ<0 and ¹h₁ᵢ₊₁<0,
calculating ⁶d₀₁=¹h₁ᵢ·uᵢₘₐₓ+¹h₁ᵢ₊₁·uᵢ₊₁ₘᵢₙ and ⁶d₀₂=¹h₁ᵢ·uᵢₘᵢₙ+¹h₁ᵢ₊₁·uᵢ₊₁ₘₐₓ; and if ⁶d₀₁>⁶d₀₂, setting an i^{th} row of the matrix ¹Π to the uᵢₘᵢₙ and an i+1^{th} row to uᵢ₊₁ₘₐₓ; if ⁶d₀₁<⁶d₀₂, setting an i^{th} row of the matrix ¹Π to the uᵢₘₐₓ and an i+1^{th} row to uᵢ₊₁ₘᵢₙ; or if ⁶d₀₁=⁶d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and the i+1^{th} row to uᵢ₊₁ₘₐₓ;
4-4-11) constructing a coordinate rotation transformation ²F, such that a transformed coordinate axis v₁ is perpendicular to an image of a boundary surface whose vertex matrix is the ²Π in the group, and images of all points on the boundary surface have equal coordinate values on the v₁ axis, which specifically includes:
setting

$${}^{2} F = [ \begin{matrix}{}_{}^{2} {f}_{11}^{} & {}_{}^{2} {f}_{12}^{} & {}_{}^{2} {f}_{13}^{} \\ {}_{}^{2} {f}_{21}^{} & {}_{}^{2} {f}_{22}^{} & {}_{}^{2} {f}_{23}^{} \\ {}_{}^{2} {f}_{31}^{} & {}_{}^{2} {f}_{32}^{} & {}_{}^{2} {f}_{33}^{}\end{matrix} ] ,$$

$$B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] , and$$

$${}^{2} H = [ \begin{matrix}{}_{}^{2} {h}_{11}^{} & … & {}_{}^{2} {h}_{1 p}^{} & … & {}_{}^{2} {h}_{1 q}^{} & {}_{}^{2} {h}_{1 {q}^{′}}^{} & … & {}_{}^{2} {h}_{1 m}^{} \\ {}_{}^{2} {h}_{21}^{} & … & {}_{}^{2} {h}_{2 p}^{} & … & {}_{}^{2} {h}_{2 q}^{} & {}_{}^{2} {h}_{2 {q}^{′}}^{} & … & {}_{}^{2} {h}_{2 m}^{} \\ {}_{}^{2} {h}_{31}^{} & … & {}_{}^{2} {h}_{3 p}^{} & … & {}_{}^{2} {h}_{3 q}^{} & {}_{}^{2} {h}_{3 {q}^{′}}^{} & … & {}_{}^{2} {h}_{3 m}^{}\end{matrix} ] ,$$

where ²fᵢⱼ represents an element of an i^{th} row and a j^{th} column of the matrix ²F, and ²hᵢⱼ represents an element of an i^{th} row and a j^{th} column of the matrix ²H;
setting ²H=²F·B, such that

$$\{ \begin{matrix}{\sum }_{s = 1}^{3} {}_{}^{2} {f}_{1 s}^{} \cdot {b}_{sp} = 0 \\ {\sum }_{s = 1}^{3} {}_{}^{2} {f}_{1 s}^{} \cdot {b}_{sq} = {}_{}^{2} {h}_{1 q}^{} \\ {\sum }_{s = 1}^{3} {}_{}^{2} {f}_{1 s}^{} \cdot {b}_{{sq}^{′}} = \frac{{u}_{q max} - {u}_{q min}}{{u}_{{q}^{′} max} - {u}_{{q}^{′} min}} {}_{}^{2} {h}_{1 q}^{}\end{matrix} \qquad ( 10 )$$

and ²h₁ₚ=0 and substituting the ²F and the B into the ²H=²F·B to obtain a following equation set:

$$\\ \begin{matrix}\{ \begin{matrix}{\sum }_{s = 1}^{3} {}^{2} {f}_{1 s} \cdot {b}_{sp} = 0 \\ {\sum }_{s = 1}^{3} {}^{2} {f}_{1 s} \cdot {b}_{sq} = {}^{2} {h}_{1 q} \\ {\sum }_{s = 1}^{3} {}^{2} {f}_{1 s} \cdot {b}_{{sq}^{{}_{} ′}} = \frac{{u}_{q max} - {u}_{q min}}{{u}_{{q}^{{}_{} ′} max} - {u}_{{q}^{{}_{} ′} min}} {}^{2} {h}_{1 q}\end{matrix} & ( 10 )\end{matrix}$$

solving the linear equation set (10) to obtain a first row of the ²F, and calculating a first row (²h₁₁, . . . , ²h₁ₘ) of the matrix ²H according to the ²H=²F·B; and if ²h_{1p′}<0 and ²h_{1q′}>0, performing a step 4-4-12); if ²h_{1p′}>0 and ²h_{1q′}<0 and, performing a step 4-4-13); or if ² h_{1p′}·²h_{1q′}>0, performing a step 4-6);
4-4-12) processing other rows than the rows p, q, p′, q′ of the matrix ²Π according to a following rule, where a boundary surface represented by an obtained matrix is the key boundary surface and placed into the set Ω, and i=1, . . . , m, i≠p, p′, q, q′; and then performing the step 4-6), where
the rule is as follows:
when ²h₁ᵢ·²h₁ᵢ₊₁<0,
if ²h₁ᵢ>0 and ²h₁ᵢ₊₁<0, setting an i^{th} row of the matrix ²Π to the uᵢₘₐₓ and an i+1^{th} row to uᵢ₊₁ₘᵢₙ; or
if ²h₁ᵢ<0 and ²h₁ᵢ₊₁>0, setting an i^{th} row of the matrix ²Π to the uᵢₘᵢₙ and an i+1^{th} row to uᵢ₊₁ₘₐₓ;
when ²h₁ᵢ<0 and ²h₁ᵢ₊₁<0,
setting an i^{th} row of the matrix ²Π to the uᵢₘᵢₙ and an i+1^{th} row to uᵢ₊₁ₘᵢₙ; or
when ²h₁ᵢ>0 and ²h₁ᵢ₊₁>0,
calculating ⁷d₀₁=²h₁ᵢ·uᵢₘₐₓ+²h₁ᵢ₊₁·uᵢ₊₁ₘᵢₙ and ⁷d₀₂=²h₁ᵢ·uᵢₘᵢₙ+²h₁ᵢ₊₁·uᵢ₊₁ₘₐₓ; and if ⁷d₀₁>⁷d₀₂, setting an i^{th} row of the matrix ²Π to the uᵢₘₐₓ and an i+1^{th} row to uᵢ₊₁ₘᵢₙ; if ⁷d₀₁<⁷d₀₂, setting an i^{th} row of the matrix ²Π to the uᵢₘᵢₙ and an i+1^{th} row to uᵢ₊₁ₘₐₓ; or if ⁷d₀₁=⁷d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and the i+1^{th} row to uᵢ₊₁ₘₐₓ;
4-4-13) processing other rows than the rows p, q, p′, q′ of the matrix ²Π according to a following rule, where a boundary surface represented by an obtained matrix is the key boundary surface and placed into the set Ω, and i=1, . . . , m, i≠p, p′, q, q′; and then performing the step 4-6), where
the rule is as follows:
when ²h₁ᵢ·²h₁ᵢ₊₁<0,
if ²h₁ᵢ>0 and ²h₁ᵢ₊₁<0, setting an i^{th} row of the matrix ²Π to the uᵢₘᵢₙ and an i+1^{th} row to uᵢ₊₁ₘₐₓ; or
if ²h₁ᵢ<0 and ²h₁ᵢ₊₁>0, setting an i^{th} row of the matrix ²Π to the uᵢₘₐₓ and an i+1^{th} row to uᵢ₊₁ₘᵢₙ;
when ²h₁ᵢ<0 and ²h₁ᵢ₊₁<0,
calculating ⁸d₀₁=²h₁ᵢ·uᵢₘₐₓ+²h₁ᵢ₊₁·uᵢ₊₁ₘᵢₙ and ⁸d₀₂=²h₁ᵢ·uᵢₘᵢₙ+²h₁ᵢ₊₁·uᵢ₊₁ₘₐₓ; and if ⁸d₀₁>⁸d₀₂, setting an i^{th} row of the matrix ²Π to the uᵢₘᵢₙ and an i+1^{th} row to uᵢ₊₁ₘₐₓ; if ⁸d₀₁<⁸d₀₂, setting an i^{th} row of the matrix ²Π to the uᵢₘₐₓ and an i+1^{th} row to uᵢ₊₁ₘᵢₙ; or if ⁸d₀₁=⁸d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and the i+1^{th} row to uᵢ₊₁ₘₐₓ; or
when ²h₁ᵢ>0 and ²h₁ᵢ₊₁>0,
setting an i^{th} row of the matrix ²Π to the uᵢₘᵢₙ and an i+1^{th} row to uᵢ₊₁ₘᵢₙ;
4-5) when the p^{th} control component and the q^{th} control component are not a pair of linear constraint components, and the q^{th} control component has no paired linear constraint component, determining a key boundary surface of the p-q group according to a following specific method:
4-5-1) denoting a component paired with the p^{th} component as a p′^{th} component, where the p-q group contains both the type-I and the type-II rectangular boundary surfaces, and each component of each point on the boundary surfaces of the group has a value that satisfies a following formula (11):

$$\\ \begin{matrix}\{ \begin{matrix}{u}_{pmin} \leq {u}_{p} \leq {u}_{pmax} \\ {u}_{qmin} \leq {u}_{q} \leq {u}_{qmax} \\ {u}_{{p}^{{}_{} ′}} ∈ \{ {u}_{{p}^{{}_{} ′} min} , \frac{{u}_{{p}^{{}_{} ′} max} {u}_{pmax} - {u}_{{p}^{{}_{} ′} min} {u}_{pmin} - ( {u}_{{p}^{{}_{} ′} max} - {u}_{{p}^{{}_{} ′} min} ) {u}_{p}}{( {u}_{pmax} - {u}_{pmin} )} \} \\ {u}_{i} ∈ \{ {u}_{imin} , {u}_{imax} \} , 1 \leq i < m , i \neq p , q , {p}^{{}_{} ′} \\ {u}_{k} + {u}_{k + 1} < {u}_{kmax} + {u}_{k + 1 max} , k = 1 , 3 , … , 2 [ \frac{m}{2} ] - 1 , k \neq p , q , {p}^{{}_{} ′}\end{matrix} & ( 11 )\end{matrix}$$

when u_{p′}=u_{p′min} determining that a boundary surface formed by a point satisfying the formula (11) is the type-I rectangular boundary surface; or when

$$\\ {u}_{{p}^{{}_{} ′}} = \frac{{u}_{{p}^{{}_{} ′} max} {u}_{pmax} - {u}_{{p}^{{}_{} ′} min} {u}_{pmin} - ( {u}_{{p}^{{}_{} ′} max} - {u}_{{p}^{{}_{} ′} min} ) {u}_{p}}{( {u}_{pmax} - {u}_{pmin} )} ,$$

determining that a boundary surface formed by a point satisfying the formula (11) is the type-II rectangular boundary surface;
representing a vertex of each rectangular boundary surface of the group by using an m-row and 4-column matrix, where 4 columns respectively represent vectors corresponding to 4 vertices; a matrix Λ′ is used to represent a vertex of one type-I rectangular boundary surface, and a matrix Π′ represents a vertex of one type-II rectangular boundary surface; values of the p^{th}, p′^{th}, and q^{th} components of four vertices of each boundary surface are shown in a p^{th} row, a p′^{th} row, and a q^{th} row of the matrix, and other components are all uᵢₘₐₓ or uᵢₘᵢₙ; one pair of linear inequality constraint components do not simultaneously take a maximum constraint value corresponding to the one pair of linear inequality constraint components; and for the Λ′, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}) the q^{th} row is (u_{qmin}, u_{qmin}, u_{qmax}, u_{qmax}), and the q′^{th} row is (u_{q′min}, u_{q′min}, u_{q′min}, u_{q′min});

$$\\ {Λ}^{′} = [ \begin{matrix}⋯ & ⋯ & ⋯ & ⋯ \\ {u}_{pmax} & {u}_{pmin} & {u}_{pmin} & {u}_{pmax} \\ {u}_{{p}^{{}_{} ′} min} & {u}_{{p}^{{}_{} ′} min} & {u}_{{p}^{{}_{} ′} min} & {u}_{{p}^{{}_{} ′} min} \\ ⋯ & ⋯ & ⋯ & ⋯ \\ {u}_{qmin} & {u}_{qmin} & {u}_{qmax} & {u}_{qmax}\end{matrix} ] ,$$

$$\\ {Π}^{{}_{} ′} = [ \begin{matrix}⋯ & ⋯ & ⋯ & ⋯ \\ {u}_{pmax} & {u}_{pmin} & {u}_{pmin} & {u}_{pmax} \\ {u}_{{p}^{{}_{} ′} min} & {u}_{{p}^{{}_{} ′} max} & {u}_{{p}^{{}_{} ′} max} & {u}_{{p}^{{}_{} ′} min} \\ ⋯ & ⋯ & ⋯ & ⋯ \\ {u}_{qmin} & {u}_{qmin} & {u}_{qmax} & {u}_{qmax}\end{matrix} ]$$

in the matrices shown in the above formula, if p is an odd number, the p^{th} row comes before the p′^{th} row; or if p is an even number, the p^{th} row comes after the p′^{th} row;
4-5-2) constructing a coordinate rotation transformation T, such that a transformed coordinate axis v₁ is perpendicular to an image of the type-I rectangular boundary surface of the group, which specifically includes:
setting

$$\\ {}^{3} T = [ \begin{matrix}{}^{3} {t}_{11} & {}^{3} {t}_{12} & {}^{3} {t}_{13} \\ {}^{3} {t}_{21} & {}^{3} {t}_{22} & {}^{3} {t}_{23} \\ {}^{3} {t}_{31} & {}^{3} {t}_{32} & {}^{3} {t}_{33}\end{matrix} ] , B = [ \begin{matrix}{b}_{11} & ⋯ & {b}_{1 p} & ⋯ & {b}_{1 q} \\ {b}_{21} & ⋯ & {b}_{2 p} & ⋯ & {b}_{2 q} \\ {b}_{31} & ⋯ & {b}_{3 p} & ⋯ & {b}_{3 q}\end{matrix} ] , and$$

$$\\ {}^{3} C = [ \begin{matrix}{}^{3} {c}_{11} & ⋯ & {}^{3} {c}_{1 p} & ⋯ & {}^{3} {c}_{1 q} \\ {}^{3} {c}_{21} & ⋯ & {}^{3} {c}_{2 p} & ⋯ & {}^{3} {c}_{2 q} \\ {}^{3} {c}_{31} & ⋯ & {}^{3} {c}_{3 p} & ⋯ & {}^{3} {c}_{3 q}\end{matrix} ] ,$$

where ³tᵢⱼ represents an element of an i^{th} row and a j^{th} column of the matrix ³T, and ³cᵢⱼ represents an element of an i^{th} row and a j^{th} column of the matrix ³C;
setting ³C=³T·B, such that ³c₁ₚ=0 and ³c_{1q}=0; and substituting the ³T and the B into the ³C=³T·B to obtain a following equation set:

$$\\ \begin{matrix}\{ \begin{matrix}{\sum }_{s = 1}^{3} {}^{3} {t}_{1 s} \cdot {b}_{sp} = 0 \\ {\sum }_{s = 1}^{3} {}^{3} {t}_{1 s} \cdot {b}_{sq} = 0\end{matrix} & ( 12 )\end{matrix}$$

solving the linear equation set (12) to obtain a first row (³t₁₁, ³t₁₂, ³t₁₃) of the ³T, and calculating a first row (³c₁₁, . . . , ³c₁ₘ) of the matrix ³C according to the ³C=3T·B; and if ³ c_{1p′}<0, performing a step 4-5-3); or if ³c_{1p′}>0, performing a step 4-5-4);
4-5-3) processing other rows than the rows p, q, p′ of the matrix Λ′ according to a following rule, where a boundary surface represented by an obtained matrix is the key boundary surface and placed into the set Ω; and then performing a step 4-5-5), where i=1, . . . , m, i≠p, p′, q; and
the rule is as follows:
when ³c₁ᵢ·³h₁ᵢ₊₁<0,
if ³c₁ᵢ>0 and ³c₁ᵢ₊₁<0, setting an i^{th} row of the matrix Λ′ to the uᵢₘₐₓ and an i+1^{th} row to uᵢ₊₁ₘᵢₙ; or
if ³c₁ᵢ<0 and ³h₁ᵢ₊₁>0, setting an i^{th} row of the matrix Λ′ to the uᵢₘᵢₙ and an i+1^{th} row to uᵢ₊₁ₘₐₓ;
when ³c₁ᵢ<0 and ³c₁ᵢ₊₁<0,
setting an i^{th} row of the matrix Π′ to the uᵢₘᵢₙ and an i+1^{th} row to uᵢ₊₁ₘᵢₙ; or
when ³c₁ᵢ>0 and ³h₁ᵢ₊₁>0,
calculating ⁹d₀₁=³c₁ᵢ·uᵢₘₐₓ+³c₁ᵢ₊₁·uᵢ₊₁ₘᵢₙ, and ⁹d₀₂=³c₁ᵢ·uᵢₘᵢₙ+³c₁ᵢ₊₁·uᵢ₊₁ₘₐₓ; and performing determining as follows:
if ⁹d₀₁>⁹d₀₂, setting an i^{th} row of the matrix Λ′ to the uᵢₘₐₓ and an i+1^{th} row to uᵢ₊₁ₘᵢₙ; if ⁹d₀₁<⁹d₀₂, setting an i^{th} row of the matrix Λ′ to the uᵢₘᵢₙ and an i+1^{th} row to uᵢ₊₁ₘₐₓ; or if ⁹d₀₁=⁹d₀₂, setting an i^{th} row and an i+1^{th} row of the matrix Λ′ as follows: setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘᵢₙ and the i+1^{th} row to uᵢ₊₁ₘₐₓ;
4-5-4) processing other rows than the rows p, q, p′ of the matrix Λ′ according to a following rule, where a boundary surface represented by an obtained matrix is the key boundary surface and placed into the set Ω; and then performing a step 4-5-5), where i=1, . . . , m, i≠p, p′, q; and
the rule is as follows:
when ³c₁ᵢ·³h₁ᵢ₊₁<0,
if ³c₁ᵢ>0 and ³c₁ᵢ₊₁<0, setting an i^{th} row of the matrix Λ′ to the uᵢₘᵢₙ and an i+1^{th} row to uᵢ₊₁ₘₐₓ; or
if ³c₁ᵢ<0 and ³h₁ᵢ₊₁>0, setting an i^{th} row of the matrix Λ′ to the uᵢₘₐₓ and an i+1^{th} row to uᵢ₊₁ₘᵢₙ;
when ³c₁ᵢ>0 and ³c₁ᵢ₊₁>0,
setting an i^{th} row of the matrix Λ′ to the uᵢₘᵢₙ and an i+1^{th} row to uᵢ₊₁ₘᵢₙ; or
when ³c₁ᵢ<0 and ³h₁ᵢ₊₁<0,
calculating ¹⁰d₀₁=³c₁ᵢ·uᵢₘₐₓ+³c₁ᵢ₊₁·uᵢ₊₁ₘᵢₙ, and ¹⁰d₀₂=³c₁ᵢ·uᵢₘᵢₙ+³c₁ᵢ₊₁·uᵢ₊₁ₘₐₓ; and if ¹⁰d₀₁>¹⁰d₀₂, setting an i^{th} row of the matrix Λ′ to the uᵢₘᵢₙ and an i+1^{th} row to uᵢ₊₁ₘₐₓ; if ¹⁰d₀₁<¹⁰d₀₂, setting an i^{th} row of the matrix Λ′ to the uᵢₘₐₓ and an i+1^{th} row to uᵢ₊₁ₘᵢₙ; or if ¹⁰d₀₁=¹⁰d₀₂, setting an i^{th} row and an i+1^{th} row of the matrix Λ′ as follows: setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘᵢₙ and the i+1^{th} row to uᵢ₊₁ₘₐₓ;
4-5-5) constructing a coordinate rotation transformation ³F, such that a transformed coordinate axis v₁ is perpendicular to an image of a boundary surface whose vertex matrix is the Π′ in the group, and images of all points on the boundary surface have equal coordinate values on the v₁ axis, which specifically includes:
setting

$$\\ {}^{3} F = [ \begin{matrix}{}^{3} {f}_{11} & {}^{3} {f}_{12} & {}^{3} {f}_{13} \\ {}^{3} {f}_{21} & {}^{3} {f}_{22} & {}^{3} {f}_{23} \\ {}^{3} {f}_{31} & {}^{3} {f}_{32} & {}^{3} {f}_{33}\end{matrix} ] , B = [ \begin{matrix}{b}_{11} & ⋯ & {b}_{1 p} & {b}_{1 {p}^{{}_{} ′}} & ⋯ & {b}_{1 q} \\ {b}_{21} & ⋯ & {b}_{2 p} & {b}_{2 {p}^{{}_{} ′}} & ⋯ & {b}_{2 q} \\ {b}_{31} & ⋯ & {b}_{3 p} & {b}_{3 {p}^{{}_{} ′}} & ⋯ & {b}_{3 q}\end{matrix} ] , and$$

$$\\ {}^{3} H = [ \begin{matrix}{}^{3} {h}_{11} & ⋯ & {}^{3} {h}_{1 p} & {}^{3} {h}_{1 {p}^{{}_{} ′}} & ⋯ & {}^{3} {h}_{1 q} \\ {}^{3} {h}_{21} & ⋯ & {}^{3} {h}_{2 p} & {}^{3} {h}_{2 {p}^{{}_{} ′}} & ⋯ & {}^{3} {h}_{2 q} \\ {}^{3} {h}_{31} & ⋯ & {}^{3} {h}_{3 p} & {}^{3} {h}_{3 {p}^{{}_{} ′}} & ⋯ & {}^{3} {h}_{3 q}\end{matrix} ] ,$$

where ³hᵢⱼ represents an element of an i^{th} row and a j^{th} column of the matrix ³H, and ³fᵢⱼ represents an element of an i^{th} row and a j^{th} column of the matrix ³F;
setting ³H=³F·B, such that

$$\\ {}^{3} {h}_{1 {p}^{{}_{} ′}} = \frac{{u}_{pmax} - {u}_{pmin}}{{u}_{{p}^{{}_{} ′} max} - {u}_{{p}^{{}_{} ′} min}} {}^{3} {h}_{1 p} ,$$

and ³h_{1q}=0; and substituting the ³F and the B into the ³H=³F·B to obtain a following equation set:

$$\\ \begin{matrix}\{ \begin{matrix}{\sum }_{s = 1}^{3} {}^{3} {f}_{1 s} \cdot {b}_{sp} = {}^{3} {h}_{1 p} \\ {\sum }_{s = 1}^{3} {}^{3} {f}_{1 s} \cdot {b}_{{sp}^{{}_{} ′}} = \frac{{u}_{p max} - {u}_{p min}}{{u}_{{p}^{{}_{} ′} max} - {u}_{{p}^{{}_{} ′} min}} {}^{3} {h}_{1 p} \\ {\sum }_{s = 1}^{3} {}^{3} {f}_{1 s} \cdot {b}_{sq} = 0\end{matrix} & ( 13 )\end{matrix}$$

solving the linear equation set (13) to obtain a first row of the ³F, and calculating a first row (³h₁₁, . . . , ³h₁ₘ) of the matrix ³H according to the ³H=³F·B; and if ³h_{1p′}>0, performing a step 4-5-6); or if ³h_{1p′}<0, performing a step 4-5-7);
4-5-6) processing other rows than the rows p, q, p′ of the matrix Π′ according to a following rule, where a boundary surface represented by an obtained matrix is the key boundary surface and placed into the set Ω; and then performing a step 4-6), where i=1, . . . , m, i≠p, p′, q; and
the rule is as follows:
when ³h₁ᵢ·³h₁ᵢ₊₁<0
if ³h₁ᵢ>0 and ³h₁ᵢ₊₁<0, setting an i^{th} row of the matrix Π′ to the uᵢₘₐₓ and an i+1^{th} row to uᵢ₊₁ₘᵢₙ; or
if ³h₁ᵢ<0 and ³h₁ᵢ₊₁>0, setting an i^{th} row of the matrix Π′ to the uᵢₘᵢₙ and an i+1^{th} row to uᵢ₊₁ₘₐₓ;
when ³h₁ᵢ<0 and ³h₁ᵢ₊₁<0,
setting an i^{th} row of the matrix Π′ to the uᵢₘᵢₙ and an i+1^{th} row to uᵢ₊₁ₘᵢₙ; or
when ³h₁ᵢ; >0 and ³h₁ᵢ₊₁>0,
calculating ¹¹d₀₁=³c₁ᵢ·uᵢₘₐₓ+³c₁ᵢ₊₁·uᵢ₊₁ₘᵢₙ, and ¹¹d₀₂=³c₁ᵢ·uᵢₘᵢₙ+³c₁ᵢ₊₁·uᵢ₊₁ₘₐₓ; and if ¹¹d₀₁>¹¹d₀₂, setting an i^{th} row of the matrix Π′ to the uᵢₘₐₓ and an i+1^{th} row to uᵢ₊₁ₘᵢₙ; if ¹¹d₀₁<¹¹d₀₂, setting an i^{th} row of the matrix Π′ to the uᵢₘᵢₙ and an i+1^{th} row to uᵢ₊₁ₘₐₓ; or if ¹¹d₀₁=¹¹d₀₂, setting an i^{th} row and an i+1^{th} row of the matrix Π′ as follows: setting the i^{th} row of the matrix Π′ to the uᵢₘₐₓ and the i+1^{th} row to uᵢ₊₁ₘᵢₙ; or setting the i^{th} row of the matrix Π′ to the uᵢₘᵢₙ and the i+1^{th} row to uᵢ₊₁ₘₐₓ;
4-5-7) processing other rows than the rows p, q, p′ of the matrix Π′ according to a following rule, where a boundary surface represented by an obtained matrix is the key boundary surface and placed into the set Ω; and then performing a step 4-6), where i=1, . . . , m, i≠p, p′, q; and
the rule is as follows:
when ³h₁ᵢ·³h₁ᵢ₊₁<0
if ³h₁ᵢ>0 and ³h₁ᵢ₊₁<0, setting an i^{th} row of the matrix Π′ to the uᵢₘᵢₙ and an i+1^{th} row to uᵢ₊₁ₘₐₓ; or
if ³h₁ᵢ<0 and ³h₁ᵢ₊₁>0, setting an i^{th} row of the matrix Π′ to the uᵢₘₐₓ and an i+1^{th} row to uᵢ₊₁ₘᵢₙ;
when ³h₁ᵢ<0 and ³h₁ᵢ₊₁<0,
calculating ¹²d₀₁=³c₁ᵢ·uᵢₘₐₓ+³c₁ᵢ₊₁·uᵢ₊₁ₘᵢₙ, and ¹²d₀₂=³c₁ᵢ·uᵢₘᵢₙ+³c₁ᵢ₊₁·uᵢ₊₁ₘₐₓ; and if ¹²d₀₁>¹²d₀₂, setting an i^{th} row of the matrix Π′ to the uᵢₘᵢₙ and an i+1^{th} row to uᵢ₊₁ₘₐₓ; if ¹²d₀₁<¹²d₀₂, setting an i^{th} row of the matrix Π′ to the uᵢₘₐₓ and an i+1^{th} row to uᵢ₊₁ₘᵢₙ; or if ¹²d₀₁=¹²d₀₂, setting an i^{th} row and an i+1^{th} row of the matrix Π′ as follows: setting the i^{th} row of the matrix Π′ to the uᵢₘₐₓ and the i+1^{th} row to uᵢ₊₁ₘᵢₙ; or setting the i^{th} row of the matrix Π′ to the uᵢₘᵢₙ and the i+1^{th} row to uᵢ₊₁ₘₐₓ; or
when ³h₁ᵢ>0 and ³h₁ᵢ₊₁>0,
setting an i^{th} row of the matrix Π′ to the uᵢₘᵢₙ and an i+1^{th} row to uᵢ₊₁ₘᵢₙ; and
4-6) returning to the step 4-1), selecting a next group for which no key boundary surface has been determined, until the key boundary surface has been determined for all groups, and then performing a step 5);
5) checking all key boundary surfaces in the 52, and performing determining as follows: if there are identical key boundary surfaces, retaining only one of the identical key boundary surfaces, and removing other key boundary surfaces that are the same as the retained one key boundary surface; after processing all the key boundary surfaces, forming a new set of key boundary surfaces, which is denoted as Ω′; and
then performing a step 6); and
6) mapping all vertices of each key boundary surface in the Ω′ according to v=B·u_{ELR} to obtain all vertices of a boundary surface corresponding to the control attainable set, so as to determine the boundary surface of the control attainable set, where all key boundary surfaces in the Ω′ are all the key boundary surfaces of the control set; the boundary surface of the control attainable set is a quadrilateral or triangle; and boundary surfaces that are of the control attainable set and determined based on all the key boundary surfaces in the Ω′ constitute the boundary ∂(Φ_{ELR}) of the control attainable set.

The present disclosure has following characteristics and beneficial effects:

The present disclosure breaks through a limitation that all control components need to be independent of each other in existing technologies, and solves a problem of determining a control attainable set of a parallel configuration redundant drive system in which the control attainable set is 3D space, any three columns of a control efficiency matrix are linearly independent, and each pair of control components are linear constraint control components. Instead, the present disclosure can omit a step of determining a quasi-key boundary surface but directly find a key boundary surface for each group. The method is concise and computationally efficient, and has high application value.

The method can be used for evaluating a control capability of a parallel hybrid system with a redundant driving characteristic and each pair of control components being linear constraint control components in an advanced satellite, aircraft, ship, automobile, parallel robot, and the like. The present disclosure can provide a basis for control allocation of the system and be used for fault-tolerant control of the system after some actuators fail.

### BRIEF DESCRIPTION OF THE DRAWINGS

FIG. 1 is an overall flowchart of a method for calculating a control attainable set of a redundant drive system under a linear constraint according to the present disclosure.

### DETAILED DESCRIPTION OF THE EMBODIMENTS

The present disclosure provides a method for calculating a control attainable set of a redundant drive system under a linear constraint. The following provides further detailed description based on the accompanying drawings and specific embodiments.

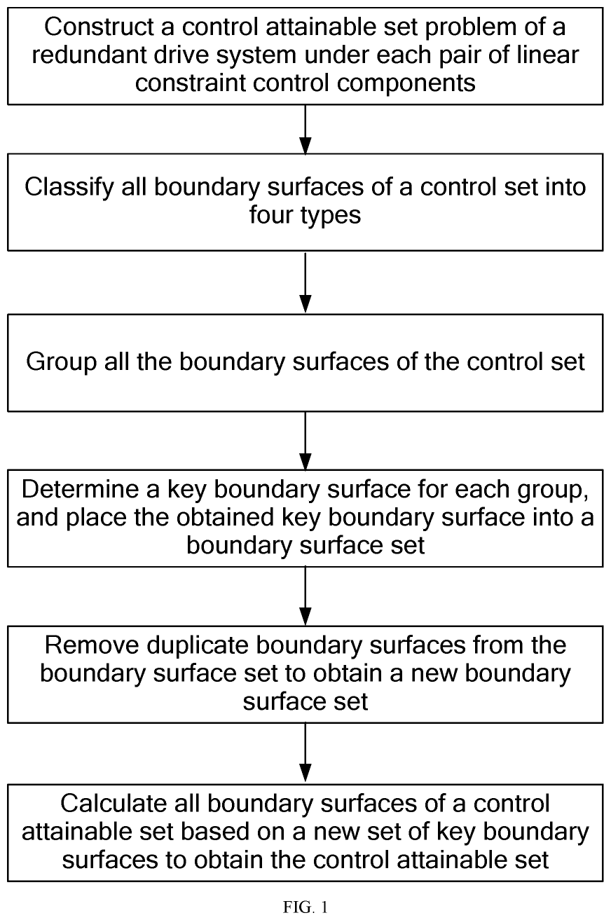

The present disclosure proposes a method for calculating a control attainable set of a redundant drive system under a linear constraint. An overall process is shown in FIG. 1, and the method includes following steps.

1) Establish an expression of a control attainable set of a redundant drive system under each pair of linear constraint control components as follows:

$$\\ \begin{matrix}Φ = \{ v \vert v = B \cdot u , u = {( {u}_{1} , … , {u}_{m} )}^{T} , u ∈ Ω \} s . t . & ( 1 )\end{matrix}$$

$$\\ {u}_{imin} \leq {u}_{i} \leq {u}_{imax} , i = 1 , L , m$$

$$\\ ( {u}_{kmax} - {u}_{kmin} ) {u}_{k + 1} + ( {u}_{k + 1 max} - {u}_{k + 1 min} ) {u}_{k} \leq {u}_{k + 1 max} {u}_{kmax} - {u}_{k + 1 min} {u}_{kmin} ,$$

$$\\ k = 1 , 3 , … , 2 [ \frac{m}{2} ] - 1$$

In the above expression, [m/2] represents an integer part obtained by dividing m by 2, u represents a control vector, the u is denoted as u_{ELR}, u_{ELR}=(u₁, . . . , uₘ)^{T}, uᵢₘᵢₙ≤uᵢ≤uᵢₘₐₓ, i=1,L,m, (uₖₘₐₓ−uₖₘᵢₙ)uₖ₊₁+(uₖ₊₁ₘₐₓ−uₖ₊₁ₘᵢₙ)uₖ≤uₖ₊₁ₘₐₓuₖₘₐₓ−uₖ₊₁ₘᵢₙuₖₘᵢₙ, and k=1,3, . . . , 2[m/2]−1.

An i^{th} control component uᵢ is a control action of a corresponding i^{th} actuator, where 1≤i≤m, and m represents a quantity of actuators; and uᵢₘᵢₙ represents a minimum constraint value of the control action of the i^{th} actuator, and uᵢₘₐₓ represents a maximum constraint value of the control action of the i^{th} actuator. Ω represents a control set, and Ω={u}; v represents a control attainable vector of the redundant drive system, and v=(v₁, v₂, v₃)^{T}, which represents a control output of the redundant drive system; Φ represents the control attainable set; and B represents a 3-row and m-column control efficiency matrix.

For convenience of subsequent description, the expression (1) is rewritten to an expression (2):

$$\\ \begin{matrix}{Φ}_{ELR} = \{ v \vert v = B \cdot {u}_{ELR} , {u}_{ELR} = {( {u}_{1} , … , {u}_{m} )}^{T} , {u}_{ELR} ∈ {Ω}_{ELR} \} s . t . & ( 2 )\end{matrix}$$

$$\\ {u}_{imin} \leq {u}_{i} \leq {u}_{imax} , i = 1 , L , m ;$$

$$\\ ( {u}_{kmax} - {u}_{kmin} ) {u}_{k + 1} + ( {u}_{k + 1 max} - {u}_{k + 1 min} ) {u}_{k} \leq {u}_{k + 1 max} {u}_{kmax} - {u}_{k + 1 min} {u}_{kmin} ,$$

$$\\ k = 1 , 3 , … , 2 [ \frac{m}{2} ] - 1$$

In the above expression, uₖ and uₖ₊₁ represent a pair of control components with a linear constraint, which is referred to as a pair of linear constraint control components, Φ_{ELR} represents a control attainable set of a redundant drive system with each pair of control components being linear constraint control components, Ω_{ELR} represents a control set, u_{ELR} represents a control vector, and Ω_{ELR}={u_{ELR}}. A boundary of the Ω_{ELR} is represented by ∂(Ω_{ELR}), and a boundary of the Φ_{ELR} is represented by ∂(Φ_{ELR}). In this way, determining of the control attainable set of the redundant drive system with each pair of control components being linear constraint control components is to determine ∂(Φ_{ELR}) based on the given Ω_{ELR} and B.
2) Classify all boundary surfaces of the control set Ω_{ELR} obtained in the step 1) into four types.

In this embodiment, for the control set Ω_{ELR}={u_{ELR}}, a point obtained by taking a corresponding maximum or minimum constraint value of each component uᵢ(i=1, . . . , m) of the control vector u_{ELR}=(u₁, . . . , uₘ)^{T} is used as a vertex of the control set Ω_{ELR}. m represents the quantity of actuators, and m>3. One m-dimensional control set has at most 2^{m} vertices. Because paired linear constraint control components cannot take the maximum value simultaneously, the m-dimensional control set Ω_{ELR} represented by the expression (2) has

$$\\ {3}^{[ \frac{m}{2} ]} \cdot {2}^{( \frac{m}{2} )}$$

vertices. [m/2] represents the integer part obtained by dividing m by 2, and (m/2) represents a remainder of dividing m by 2.

Ω_{ELR} represents the control set of the redundant drive system with each pair of control components being linear constraint control components, and the boundary of the Ω_{ELR} is the ∂(Ω_{ELR}) Based on a value of each component of each vertex, there are four types of boundary surfaces constituting the ∂(Ω_{ELR}): a type-rectangular boundary surface, a type-rectangular boundary surface, a type-=2\*ROMAN I rectangular boundary surface, and a triangular boundary surface. The four types of boundary surfaces are defined as follows:

Four vertices of the rectangular boundary surface are denoted as A, B, D, and C in clockwise order, and three vertices of the triangular boundary surface are denoted as A, C, and B in clockwise order.

A rectangle that satisfies following three conditions is referred to as the type-I rectangular boundary surface: (i) for the vertices A and B, one component has a different value, and other components have a same value; (ii) for the vertices A and C, one component of another pair of components has a different value, and other components have a same value; and (iii) for the vertices A and D, the above two components have different values, and other components have a same value.

A rectangle that satisfies following three conditions is referred to as the type-II rectangular boundary surface: (i) for the vertex A and the vertex B, one pair of linear constraint components have different values, and other components have a same value; (ii) for the vertex C and the vertex D, the one pair of linear constraint components have different values, and other components have a same value; and (iii) for the vertex A and the vertex C, the one pair of linear constraint components have a same value, and other components have a same value except that one of the other components has a different value.

A rectangle that satisfies following three conditions is referred to as the type−=2\*ROMAN I rectangular boundary surface: (i) for the vertex A and the vertex B, one pair of linear constraint components have different values, and other components have a same value; (ii) for the vertex A and the vertex C, another pair of linear constraint components have different values, and other components have a same value; and (iii) for the vertex D and the vertex A, each of the above two pairs of linear constraint components has a different value, and other components have a same value.

A right triangle that following three conditions is referred to as the triangular boundary surface: (i) for the vertex A and the vertex B, one pair of linear constraint components have different values, and other components have a same value; (ii) for the vertex A and the vertex C, one component of the one pair of linear constraint components have a different value, and other components have a same value; and (iii) for the vertex B and the vertex C, the other component of the one pair of linear constraint components has a different value, and other components have a same value.

3) Divide all the boundary surfaces of the control set Ω_{ELR} into Cₘ² groups.

If values of two components of the u_{ELR} are between the corresponding minimum and maximum values, and values of other m−2 components are the corresponding minimum or maximum value, the m components form 2^{m-2} boundary surfaces of the control set.

If any two components in the u_{ELR} are denoted as a p^{th} component and a q^{th} component, values of the p^{th} component and the q^{th} component are between the corresponding minimum and maximum values, 1≤p≤m, 1≤q≤m, p<q, values of other m−2 components are the corresponding minimum or maximum value, and a boundary surface formed in such a manner is added to one group that is referred to as a p-q group, all the boundary surfaces in the control set are divided into the Cₘ² groups.

4) Determine a key boundary surface for each of the Cₘ² groups in the step 3).

A boundary surface of an image mapped onto the Φ_{ELR} in the Ω_{ELR} of the boundary ∂(Φ_{ELR}) is denoted as the key boundary surface, the Ω is denoted as a set of key boundary surfaces, and the Ω is initialized as an empty set.

4-1) Select any group for which no key boundary surface has been determined, denote the group as a current p-q group, and perform a step 4-2).

4-2) Determine whether the p^{th} control component and the q^{th} control component are a pair of linear constraint components; and
if they are a pair of linear constraint components, perform a step 4-3);
if they are not a pair of linear constraint components, and m is an even number, perform a step 4-4);

if they are not a pair of linear constraint components, m is an odd number, and the p^{th} and q^{th} control components each have a paired linear constraint component, perform a step 4-4); or

if they are not a pair of linear constraint components, m is an odd number, and the q^{th} control component has no paired linear constraint component, perform a step 4-5).

It should be noted that an m^{th} component does not have a paired linear constraint component only when m is the odd number. Since it has been limited earlier that p<q the p^{th} control component must have a paired linear constraint component.

4-3) When the p^{th} control component and the q^{th} control component are a pair of linear constraint components, determine a key boundary surface of the p-q group according to a following specific method:
4-3-1) When the p^{th} control component and the q^{th} control component are a pair of linear constraint components, determine that all boundary surfaces of the group are triangular boundary surfaces, where a value of each component of each point on the boundary surface satisfies a following formula:

$$\\ \begin{matrix}\{ \begin{matrix}{u}_{pmin} \leq {u}_{p} \leq {u}_{pmax} \\ {u}_{qmin} \leq {u}_{q} \leq \frac{{u}_{qmax} {u}_{pmax} - {u}_{qmin} {u}_{pmin} - ( {u}_{qmax} - {u}_{qmin} ) {u}_{p}}{( {u}_{pmax} - {u}_{pmin} )} \\ {u}_{i} ∈ \{ {u}_{imin} , {u}_{imax} \} , i ∈ {Z}^{{}_{} +} , 1 \leq i \leq m , i \neq p , q\end{matrix} & ( 3 )\end{matrix}$$

A vertex of each boundary surface in the group is represented by an m-row and 3-column matrix 4, and ³ columns are vectors corresponding to 3 vertices. Values of the p^{th} and q^{th} components of three vertices on each boundary surface are shown in p^{th} and q^{th} rows of the matrix Δ. A value of an i(i=1, . . . , m,i≠p,q)^{th} component is the uᵢₘₐₓ or the uᵢₘᵢₙ, and an i(i=1, . . . , m, i≠p, q)^{th} row of the corresponding matrix Δ is the uᵢₘₐₓ Or the uᵢₘᵢₙ. However, one pair of linear constraint components in other components cannot simultaneously take a maximum constraint value corresponding to the one pair of linear constraint components, and values of the other components are uniformly represented by ellipses in the Δ. The p^{th} row of the matrix Δ is (uₚₘₐₓ, uₚₘᵢₙ, uₚₘᵢₙ), and the q^{th} row is (u_{qmin}, u_{qmin}, u_{qmax}).

$$\\ Δ = [ \begin{matrix}⋯ & ⋯ & ⋯ \\ {u}_{pmax} & {u}_{pmin} & {u}_{pmin} \\ {u}_{qmin} & {u}_{qmin} & {u}_{qmax} \\ ⋯ & ⋯ & ⋯\end{matrix} ] .$$

4-3-2) Construct a coordinate rotation transformation ¹T, such that a transformed coordinate axis v₁ is perpendicular to an image of the triangular boundary surface of the group, where only a first row of the ¹T is required because only the V₁ axis is considered.

$$\\ {}^{1} T = [ \begin{matrix}{}^{1} {t}_{11} & {}^{1} {t}_{12} & {}^{1} {t}_{13} \\ {}^{1} {t}_{21} & {}^{1} {t}_{22} & {}^{1} {t}_{23} \\ {}^{1} {t}_{31} & {}^{1} {t}_{32} & {}^{1} {t}_{33}\end{matrix} ] , B = [ \begin{matrix}{b}_{11} & ⋯ & {b}_{1 p} & ⋯ & {b}_{1 q} & ⋯ & {b}_{1 m} \\ {b}_{21} & ⋯ & {b}_{2 p} & ⋯ & {b}_{2 q} & ⋯ & {b}_{2 m} \\ {b}_{31} & ⋯ & {b}_{3 p} & ⋯ & {b}_{3 q} & ⋯ & {b}_{3 m}\end{matrix} ] , and$$

$$\\ {}^{1} C = [ \begin{matrix}{}^{1} {c}_{11} & ⋯ & {}^{1} {c}_{1 p} & ⋯ & {}^{1} {c}_{1 q} & ⋯ & {}^{1} {c}_{1 m} \\ {}^{1} {c}_{21} & ⋯ & {}^{1} {c}_{2 p} & ⋯ & {}^{1} {c}_{2 q} & ⋯ & {}^{1} {c}_{2 m} \\ {}^{1} {c}_{31} & ⋯ & {}^{1} {c}_{3 p} & ⋯ & {}^{1} {c}_{3 q} & ⋯ & {}^{1} {c}_{3 m}\end{matrix} ]$$

are set, where ¹cᵢⱼ represents an element of an i^{th} row and a j^{th} column of the matrix ¹C, ¹tᵢⱼ represents an element of an i^{th} row and a j^{th} column of the matrix ¹T, and bᵢⱼ represents an element of an i^{th} row and a j^{th} column of the matrix B.

¹C=¹T·B is set, such that ¹c₁ₚ=0, and ¹c_{1q}=0. The ¹T and the B are substituted into the ¹C=¹T·B to obtain a following equation set:

$$\{ \begin{matrix}{\sum }_{s = 1}^{3} {}^{1} {t}_{1 s} \cdot {b}_{s p} = 0 \\ {\sum }_{s = 1}^{3} {}^{1} {t}_{1 s} \cdot {b}_{s q} = 0\end{matrix} \qquad ( 4 )$$

The linear equation set (4) is solved to obtain the first row (¹t₁₁, ¹t₁₂, ¹t₁₃) of the ¹T. Then, a first row (¹C₁₁, . . . , ¹C₁ₘ) of the matrix ¹C is calculated according to the ¹C=¹T·B.

4-3-3) Process other rows than the rows P, q of the matrix Δ according to a following rule, where a boundary surface represented by an obtained matrix is the key boundary surface and placed into the set Ω, and 1≤i≤m,i is an integer, i≠p,q.

The rule is as follows:
when ¹c₁ᵢ·¹c₁ᵢ₊₁<0,
if ¹c₁ᵢ>0 and ¹c₁ᵢ₊₁<0, setting the i^{th} row of the matrix Δ to the uᵢₘₐₓ and an i+1^{th} row to uᵢ₊₁ₘᵢₙ; or
if ¹c₁ᵢ<0 and ¹c₁ᵢ₊₁>0, setting the i^{th} row of the matrix Δ to the uᵢₘᵢₙ and an i+1^{th} row to uᵢ₊₁ₘₐₓ; or

when ¹c₁ᵢ<0 and ¹c₁ᵢ₊₁<0,
setting the i^{th} row of the matrix Δ to the uᵢₘᵢₙ and an i+1^{th} row to uᵢ₊₁ₘᵢₙ; or
when ¹c₁ᵢ>0 and ¹c₁ᵢ₊₁>0,
calculating ¹z₀₁=¹c₁ᵢ·uᵢₘₐₓ+¹c₁ᵢ₊₁·uᵢ₊₁ₘᵢₙ and ¹z₀₂=¹c₁ᵢ·uᵢₘᵢₙ+¹c₁ᵢ₊₁·uᵢ₊₁ₘₐₓ and then performing determining as follows:
if ¹z₀₁>¹z₀₂, setting an i^{th} row of the matrix Δ to the uᵢₘₐₓ and an i+1^{th} row to uᵢ₊₁ₘᵢₙ; if ¹z₀₁<¹z₀₂, setting an i^{th} row of the matrix Δ to the uᵢₘᵢₙ and an i+1^{th} row to uᵢ₊₁ₘₐₓ; or if ¹z₀₁=¹z₀₂, setting an i^{th} row and an i+1^{th} row of the matrix Δ as follows: setting the i^{th} row of the matrix Δ to the uᵢₘₐₓ and the i+1^{th} row to uᵢ₊₁ₘᵢₙ; or setting the i^{th} row of the matrix Δ to the uᵢₘᵢₙ and the i+1^{th} row to uᵢ₊₁ₘₐₓ.
4-3-4) Process other rows than the rows p, q of the matrix Δ according to a following rule, where a boundary surface represented by an obtained matrix is the key boundary surface and placed into the set Ω; and then perform a step 4-6), where 1≤i≤m, i is an integer, i≠p, q.

The rule is as follows:
when ¹c₁ᵢ·¹c₁ᵢ₊₁<0,
if ¹c₁ᵢ>0 and ¹c₁ᵢ₊₁<0, setting the i^{th} row of the matrix Δ to the uᵢₘᵢₙ and an i+1^{th} row to uᵢ₊₁ₘₐₓ; or
if ¹c₁ᵢ<0 and ¹c₁ᵢ₊₁>0, setting the i^{th} row of the matrix Δ to the uᵢₘₐₓ and an i+1^{th} row to uᵢ₊₁ₘᵢₙ; or
when ¹c₁ᵢ>0 and ¹c₁ᵢ₊₁>0,
setting the i^{th} row of the matrix Δ to the uᵢₘᵢₙ and an i+1^{th} row to uᵢ₊₁ₘᵢₙ; or
when ¹c₁ᵢ<0 and ¹c₁ᵢ₊₁<0,
calculating ²z₀₁=¹c₁ᵢ·uᵢₘₐₓ+¹c₁ᵢ₊₁·uᵢ₊₁ₘᵢₙ and ²z₀₂=¹c₁ᵢ·uᵢₘᵢₙ+¹c₁ᵢ₊₁·uᵢ₊₁ₘₐₓ and performing determining as follows: if ²z₀₁>²z₀₂, setting an i^{th} row of the matrix Δ to the uᵢₘᵢₙ and the i+1^{th} row to the uᵢ₊₁ₘₐₓ; if ²z₀₁<²z₀₂, setting an i^{th} row of the matrix Δ to the uᵢₘₐₓ and the i+1^{th} row to uᵢ₊₁ₘᵢₙ; or if ¹z₀₁=¹z₀₂, setting an i^{th} row and an i+1^{th} row of the matrix Δ as follows: setting the i^{th} row of the matrix Δ to the uᵢₘₐₓ and the i+1^{th} row to uᵢ₊₁ₘᵢₙ; or setting the i^{th} row of the matrix Δ to the uᵢₘᵢₙ and the i+1^{th} row to uᵢ₊₁ₘₐₓ.
4-4) When the p^{th} control component and the q^{th} control component are not a pair of linear constraint components, and each have the paired linear constraint component, determine a key boundary surface of the p-q group according to a following specific method:
4-4-1) The p-q group has three types of rectangular boundary surfaces. Each component of each point on the boundary surfaces of the group has a value that satisfies a following formula. The component paired with the p^{th} component is denoted as a p′^{th} component, and the component paired with the q^{th} component is denoted as a q′^{th} component.

$$\{ \begin{matrix}{u}_{p min} \leq {u}_{p} \leq {u}_{p max} \\ {u}_{q min} \leq {u}_{q} \leq {u}_{q max} \\ {u}_{{p}^{′}} ∈ \{ {u}_{{p}^{′} min} , \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} \} \\ {u}_{{q}^{′}} ∈ \{ {u}_{{q}^{′} min} , \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} \} \\ {u}_{i} ∈ \{ {u}_{i min} , {u}_{i max} \} , 1 \leq i \leq m , i \neq p , q , {p}^{′} , {q}^{′} \\ {u}_{k} + {u}_{k + 1} < {u}_{k max} + {u}_{k + 1 max} , k = 1 , 3 , … , 2 [ \frac{m}{2} ] - 1 , k \neq p , q , {p}^{′} , {q}^{′}\end{matrix} \qquad ( 5 )$$

When u_{p′}=u_{p′min} and u_{q′}=u_{q′min} it is determined that a boundary surface formed by a point satisfying the formula (5) is the type-I rectangular boundary surface.

When u_{p′}=u_{p′min} and

$${u}_{{q}^{′}} = \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$

it is determined that a boundary surface formed by a point satisfying the formula (5) is the type-II rectangular boundary surface.

When

$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )}$$

and u_{q′}=u_{q′min}, is determined that a boundary surface formed by a point satisfying the formula (5) also is the type-II rectangular boundary surface.

When

$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )}$$

$$and$$

$${u}_{{q}^{′}} = \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$

it is determined that a boundary surface formed by a point satisfying the formula (5) is the type-III rectangular boundary surface.

A vertex of each boundary surface in the group can be represented by an m-row and 4-column matrix, and 4 columns respectively represent vectors corresponding to 4 vertices. A matrix Λ represents a vertex of one type-I rectangular boundary surface, a matrix ¹Π or ²Π represents a vertex of one type-II rectangular boundary surface, and a matrix T represents a vertex of one type-III rectangular boundary surface. Values of the p^{th}, the p′^{th}, the q^{th}, and the q′^{th} components of four vertices on each boundary surface are shown in p^{th}, p′^{th}, q^{th}, and q′^{th} rows of the matrix. A value of an i^{th} component is the uᵢₘₐₓ or the uᵢₘᵢₙ, and an i^{th} row of the corresponding matrix is the uᵢₘₐₓ or the uᵢₘᵢₙ. However, one pair of linear inequality constraint components cannot simultaneously take a maximum constraint value corresponding to the one pair of linear inequality constraint components, and the maximum constraint value is uniformly represented by an ellipsis in the matrix. For the Λ, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min}).

For the ¹Π, the p^{th} row is (uₚₘₐₓ, uₚₘᵢₙ, uₚₘᵢₙ, u_{p max}), the p′ ^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min}).

For the ²Π, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}), the q^{th} row is (u_{qmin}, u_{qmin}, u_{qmax}, u_{qmax}), and the q′^{th} row is (u_{q′max}, u_{q′max}, u_{q′min}, u_{q′min}).

For the T, the p^{th} row is (uₚₘₐₓ, uₚₘᵢₙ, uₚₘᵢₙ, uₚₘₐₓ), the p′^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′max}, u_{q′max}, u_{q′min}, u_{q′min}).

$$Λ = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] , \qquad ( 6 )$$

$${}^{1} Π = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] ,$$

$${}^{2} Π = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ] ,$$

$$T = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ]$$

It should be noted that: In the four matrices shown in the above formula, if p is an odd number, the p^{th} row comes before the p′^{th} row; or if p is an even number, the p^{th} row comes after the p′^{th} row. If q is an odd number, the q^{th} row comes before the q′^{th} row; or if q is an even number, the q^{th} row comes after the q′^{th} row.
4-4-2) Construct a coordinate rotation transformation G, such that a transformed coordinate axis v₁ is perpendicular to an image of the type-III rectangular boundary surface, and images of all points on the boundary surface have equal coordinate values on the v₁ axis.

$$G = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] , B = [ \begin{matrix}{b}_{11} & … & {b}_{1 p} & {b}_{1 {p}^{′}} & … & {b}_{1 q} & {b}_{1 {q}^{′}} & … & {b}_{1 m} \\ {b}_{21} & … & {b}_{2 p} & {b}_{2 {p}^{′}} & … & {b}_{2 q} & {b}_{2 {q}^{′}} & … & {b}_{2 m} \\ {b}_{31} & … & {b}_{3 p} & {b}_{3 {p}^{′}} & … & {b}_{3 q} & {b}_{3 {q}^{′}} & … & {b}_{3 m}\end{matrix} ] ,$$

$$and E = [ \begin{matrix}{e}_{11} & … & {e}_{1 p} & {e}_{1 {p}^{′}} & … & {e}_{1 q} & {e}_{1 {q}^{′}} & … & {e}_{1 m} \\ {e}_{21} & … & {e}_{2 p} & {e}_{2 {p}^{′}} & … & {e}_{2 q} & {e}_{2 {q}^{′}} & … & {e}_{2 m} \\ {e}_{31} & … & {e}_{3 p} & {e}_{3 {p}^{′}} & … & {e}_{3 q} & {e}_{3 {q}^{′}} & … & {e}_{3 m}\end{matrix} ]$$

are set, where gᵢⱼ represents an element of an i^{th} row and a j^{th} column of the matrix G, and eᵢⱼ represents an element of an i^{th} row and a j^{th} column of the matrix E.

E=G·B is set, such that

$$\begin{matrix}{e}_{1 {p}^{′}} = \frac{{u}_{p max} - {u}_{p min}}{{u}_{{p}^{′} max} - {u}_{{p}^{′} min}} {e}_{1 p} , & {e}_{1 {q}^{′}} = \frac{{u}_{q max} - {u}_{q min}}{{u}_{{q}^{′} max} - {u}_{{q}^{′} min}} {e}_{1 q}\end{matrix} .$$

The G and the B are substituted into the E=G·B to obtain a following equation set:

$$\{ \begin{matrix}{\sum }_{s = 1}^{3} {g}_{1 s} \cdot {b}_{sp} = {e}_{1 p} \\ {\sum }_{s = 1}^{3} {g}_{1 s} \cdot {b}_{{sp}^{′}} = \frac{{u}_{p max} - {u}_{p min}}{{u}_{{p}^{′} max} - {u}_{{p}^{′} min}} {e}_{1 p} \\ {\sum }_{s = 1}^{3} {g}_{1 s} \cdot {b}_{sq} = {e}_{1 q} \\ {\sum }_{s = 1}^{3} {g}_{1 s} \cdot {b}_{{sq}^{′}} = \frac{{u}_{q max} - {u}_{q min}}{{u}_{{q}^{′} max} - {u}_{{q}^{′} min}} {e}_{1 q}\end{matrix} \qquad ( 7 )$$

The linear equation set (7) is solved to obtain a first row of the G, and a first row (e₁₁, . . . , e₁ₘ) of the matrix E is calculated according to the E=G·B. If e_{1p′}>0 and e_{1q′}22 0, a step 4-4-3) is performed; if e_{1p′}<0 and e_{1q′}21 0, a step 4-4-4) is performed; or if e_{1p′}·e_{1q′}21 0, a step 4-4-5) is performed.
4-4-3) Process other rows than the rows p, q, p′, q′ of the matrix T according to a following rule, where a boundary surface represented by an obtained matrix is the key boundary surface and placed into the set Ω; and then perform the step 4-4-5), where i=1, . . . , m, i≠p, p′, q, q′.

The rule is as follows:
when e₁ᵢ·e₁ᵢ₊₁<0,
if e₁ᵢ>0 and e₁ᵢ₊₁<0, setting the i^{th} row of the matrix T to the uᵢₘₐₓ and an i+1^{th} row to uᵢ₊₁ₘᵢₙ; or
if e₁ᵢ<0 and e₁ᵢ₊₁>0, setting the i^{th} row of the matrix T to the uᵢₘᵢₙ and an i+1^{th} row to uᵢ₊₁ₘₐₓ;
when e₁ᵢ<0 and e₁ᵢ₊₁<0,
setting the i^{th} row of the matrix T to the uᵢₘᵢₙ and an i+1^{th} row to uᵢ₊₁ₘᵢₙ; or
when e₁ᵢ<0 and e₁ᵢ₊₁>0,
calculating ¹d₀₁=e₁ᵢ·uᵢₘₐₓ+e₁ᵢ₊₁·uᵢ₊₁ₘᵢₙ and ¹d₀₂=e₁ᵢ·uᵢₘᵢₙ+e₁ᵢ₊₁·uᵢ₊₁ₘₐₓ and performing determining as follows: if ¹d₀₁>¹d₀₂, setting an i^{th} row of the matrix T to the uᵢₘₐₓ and an i+1^{th} row to the uᵢ₊₁ₘᵢₙ; if ¹d₀₁<¹z₀₂, setting an i^{th} row of the matrix T to the uᵢₘᵢₙ and an i+1^{th} row to uᵢ₊₁ₘₐₓ; or if ¹d₀₁=¹d₀₂, setting an i^{th} row and an i+1^{th} row of the matrix T as follows: setting the i^{th} row of the matrix T to the uᵢₘₐₓ and the i+1^{th} row to uᵢ₊₁ₘᵢₙ; or setting the i^{th} row of the matrix T to the uᵢₘᵢₙ and the i+1^{th} row to uᵢ₊₁ₘₐₓ.

4-4-4) Process other rows than the rows p, q, p′, q′ of the matrix T according to a following rule, where a boundary surface represented by an obtained matrix is the key boundary surface and placed into the set Ω; and then perform the step 4-4-5), where i=1, . . . , m, i≠p, p′, q, q′.

The rule is as follows:
when e₁ᵢ·e₁ᵢ₊₁<0,
if e₁ᵢ>0 and e₁ᵢ₊₁<0, setting the i^{th} row of the matrix T to the uᵢₘᵢₙ and an i+1^{th} row to uᵢ₊₁ₘₐₓ; or
if e₁ᵢ<0 and e₁ᵢ₊₁>0, setting the i^{th} row of the matrix T to the uᵢₘₐₓ and an i+1^{th} row to uᵢ₊₁ₘᵢₙ;
when e₁ᵢ<0 and e₁ᵢ₊₁<0,
calculating ²d₀₁=²h₁ᵢ·uᵢₘₐₓ+²h₁ᵢ₊₁·uᵢ₊₁ₘᵢₙ, and ²d₀₂=²h₁ᵢ·uᵢₘᵢₙ+²h₁ᵢ₊₁·uᵢ₊₁ₘₐₓ; and if ²d₀₁>²d₀₂, setting an i^{th} row of the matrix T to the uᵢₘᵢₙ and an i+1^{th} row to the uᵢ₊₁ₘₐₓ; if ²d₀₁<²d₀₂, setting an i^{th} row of the matrix T to the uᵢₘₐₓ and an i+1^{th} row to uᵢ₊₁ₘᵢₙ; or if ²d₀₁=²d₀₂, setting an i^{th} row and an i+1^{th} row of the matrix T as follows: setting the i^{th} row of the matrix T to the uᵢₘₐₓ and the i+1^{th} row to uᵢ₊₁ₘᵢₙ; or setting the i^{th} row of the matrix T to the uᵢₘᵢₙ and the i+1^{th} row to uᵢ₊₁ₘₐₓ; or
when e₁ᵢ>0 and e₁ᵢ₊₁>0;
setting the i^{th} row of the matrix T to the uᵢₘᵢₙ and an i+1^{th} row to the uᵢ₊₁ₘᵢₙ.
4-4-5) Construct a coordinate rotation transformation ²T, such that a transformed coordinate axis v₁ is perpendicular to an image of the type-I rectangular boundary surface of the group, where only a first row of the ²T is required because only the v₁ axis is considered.

$${}^{2} T = [ \begin{matrix}{}^{2} {t}_{11} & {}^{2} {t}_{12} & {}^{2} {t}_{13} \\ {}^{2} {t}_{21} & {}^{2} {t}_{22} & {}^{2} {t}_{23} \\ {}^{2} {t}_{31} & {}^{2} {t}_{32} & {}^{2} {t}_{33}\end{matrix} ] , B = [ \begin{matrix}{b}_{11} … {b}_{1 p} … {b}_{1 q} … {b}_{1 m} \\ {b}_{21} … {b}_{2 p} … {b}_{2 q} … {b}_{2 m} \\ {b}_{31} … {b}_{3 p} … {b}_{3 q} … {b}_{3 m}\end{matrix} ] , and$$

$${}^{2} C = [ \begin{matrix}{}^{2} {c}_{11} … {}^{2} {c}_{1 p} … {}^{2} {c}_{1 q} … {}^{2} {c}_{1 m} \\ {}^{2} {c}_{21} … {}^{2} {c}_{2 p} … {}^{2} {c}_{2 q} … {}^{2} {c}_{2 m} \\ {}^{2} {c}_{31} … {}^{2} {c}_{3 p} … {}^{2} {c}_{3 q} … {}^{2} {c}_{3 m}\end{matrix} ]$$

are set, where ²cᵢⱼ represents an element of an i^{th} row and a j^{th} column of the matrix ²C, and ²tᵢⱼ represents an element of an i^{th} row and a j^{th} column of the matrix ²T.

²C=²T·B is set, such that ²c₁ₚ=0, and ²c_{1q}=0. The ²T and the B are substituted into the ²C=²T·B to obtain a following equation set:

$$\{ \begin{matrix}{\sum }_{s = 1}^{3} {}^{2} {t}_{1 s} \cdot {b}_{s p} = 0 \\ {\sum }_{s = 1}^{3} {}^{2} {t}_{1 s} \cdot {b}_{s q} = 0\end{matrix} \qquad ( 8 )$$

The linear equation set (8) is solved to obtain the first row (²t₁₁, ²t₁₂,²t₁₃) of the ²T. Then, a first row(²c₁₁, . . . , ²c₁ₘ) of the matrix ²c can be calculated according to the ²C=²T·B.

If ²c_{1p′}<0 and ²c_{1q′}<0, a step 4-4-6) is performed; if ²c_{1p′}>0 and ²c_{1q′}>0, a step 4-4-7) is performed; or if ²c_{1p′}·²c_{1q′}<0, a step 4-4-8) is performed.

4-4-6) Process other rows than the rows p, q, p′, q′ of the matrix Λ according to a following rule, where a boundary surface represented by an obtained matrix is the key boundary surface and placed into the set Ω, and i=1, . . . , m, i≠p, p′, q, q′; and then perform determining as follows:
if two key boundary surfaces have been found for the group, perform a step 4-6); otherwise, perform the step 4-4-8).

The rule is as follows:
when ²c₁ᵢ·²c₁ᵢ₊₁<0,
if ²c₁ᵢ>0 and ²c₁ᵢ₊₁<0, setting the i^{th} row of the matrix Λ to the uᵢₘₐₓ and an i+1^{th} row to uᵢ₊₁ₘᵢₙ; or
if ²c₁ᵢ<0 and ²c₁ᵢ₊₁>0, setting the i^{th} row of the matrix Λ to the uᵢₘᵢₙ and an i+1^{th} row to uᵢ₊₁ₘₐₓ;
when ²c₁ᵢ<0 and ²c₁ᵢ₊₁<0,
setting the i^{th} row of the matrix Λ to the uᵢₘᵢₙ and an i+1^{th} row to uᵢ₊₁ₘᵢₙ; or
when ²c₁ᵢ>0 and ²c₁ᵢ₊₁>0,
calculating ³d₀₁=²c₁ᵢ·uᵢₘₐₓ+²c₁ᵢ₊₁·uᵢ₊₁ₘᵢₙ, and ³d₀₂=²c₁ᵢ·uᵢₘᵢₙ+²c₁ᵢ₊₁·uᵢ₊₁ₘₐₓ and if ³d₀₁>³d₀₂, setting an i^{th} row of the matrix Λ to the uᵢₘₐₓ and the i+1^{th} row to the uᵢ₊₁ₘᵢₙ; if ³d₀₁<³d₀₂, setting an i^{th} row of the matrix Λ to the uᵢₘᵢₙ and an i+1^{th} row to uᵢ₊₁ₘₐₓ; or if ³d₀₁=³d₀₂, setting an i^{th} row and an i+1^{th} row of the matrix Λ as follows: setting the i^{th} row of the matrix Λ to the uᵢₘᵢₙ and the i+1^{th} row to uᵢ₊₁ₘₐₓ.
4-4-7) Process other rows than the rows p, q, p′, q′ of the matrix Λ according to a following rule, where a boundary surface represented by an obtained matrix is the key boundary surface and placed into the set Ω, and i=1, . . . , m, i≠p, p′, q, q′; and then perform determining as follows:
if two key boundary surfaces have been found for the group, perform a step 4-6); otherwise, perform the step 4-4-8).

The rule is as follows:
when ²c₁ᵢ·²c₁ᵢ₊₁<0,
if ²c₁ᵢ>0 and ²c₁ᵢ₊₁<0, setting the i^{th} row of the matrix Λ to the uᵢₘᵢₙ and an i+1^{th} row to uᵢ₊₁ₘₐₓ; or
if ²c₁ᵢ<0 and ²c₁ᵢ₊₁>0, setting the i^{th} row of the matrix Λ to the uᵢₘₐₓ and an i+1^{th} row to uᵢ₊₁ₘᵢₙ;
when ²c₁ᵢ<0 and ²c₁ᵢ₊₁<0,
calculating ⁴d₀₁=²c₁ᵢ·uᵢₘₐₓ+²c₁ᵢ₊₁·uᵢ₊₁ₘᵢₙ, and ⁴d₀₂=²c₁ᵢ·uᵢₘᵢₙ+²c₁ᵢ₊₁·uᵢ₊₁ₘₐₓ and if ⁴d₀₁>⁴d₀₂, setting an i^{th} row of the matrix Λ to the uᵢₘᵢₙ and the i+1^{th} row to the uᵢ₊₁ₘₐₓ; if ⁴d₀₁<⁴d₀₂, setting an i^{th} row of the matrix Λ to the uᵢₘₐₓ and an i+1^{th} row to uᵢ₊₁ₘᵢₙ; or if ⁴d₀₁=⁴d₀₂, setting an i^{th} row and an i+1^{th} row of the matrix Λ as follows: setting the i^{th} row of the matrix Λ to the uᵢₘᵢₙ and the i+1^{th} row to uᵢ₊₁ₘₐₓ; or
when ²c₁ᵢ>0 and ²c₁ᵢ₊₁>0,
setting the i^{th} row of the matrix Λ to the uᵢₘᵢₙ and an i+1^{th} row to uᵢ₊₁ₘᵢₙ.
4-4-8) Construct a coordinate rotation transformation ¹F, such that a transformed coordinate axis is perpendicular v₁ to an image of a boundary surface whose vertex matrix is the ¹Π in the group, and images of all points on the boundary surface have equal coordinate values on the v₁ axis, where only a first row of the ¹F is required because only the axis is considered.

$${}^{1} F = [ \begin{matrix}{}^{1} {f}_{11} & {}^{1} {f}_{12} & {}^{1} {f}_{13} \\ {}^{1} {f}_{21} & {}^{1} {f}_{22} & {}^{1} {f}_{23} \\ {}^{1} {f}_{31} & {}^{1} {f}_{32} & {}^{1} {f}_{33}\end{matrix} ] , B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] ,$$

$$and {}^{1} H = [ \begin{matrix}{}^{1} {h}_{11} & … & {}^{1} {h}_{1 p} & {}^{1} {h}_{1 {p}^{′}} & … & {}^{1} {h}_{1 q} & … & {}^{1} {h}_{1 m} \\ {}^{1} {h}_{21} & … & {}^{1} {h}_{2 p} & {}^{1} {h}_{2 {p}^{′}} & … & {}^{1} {h}_{2 q} & … & {}^{1} {h}_{2 m} \\ {}^{1} {h}_{31} & … & {}^{1} {h}_{3 p} & {}^{1} {h}_{3 {p}^{′}} & … & {}^{1} {h}_{3 q} & … & {}^{1} {h}_{3 m}\end{matrix} ]$$

are set, where ¹fᵢⱼ represents an element of an i^{th} row and a j^{th} column of the matrix ¹F, and ¹hᵢⱼ represents an element of an i^{th} row and a j^{th} column of the matrix ¹H.

¹H=¹F·B is set, such that

$${}^{1} {h}_{1 {p}^{′}} = \frac{{u}_{p max} - {u}_{p min}}{{u}_{{p}^{′} max} - {u}_{{p}^{′} min}} {}^{1} {h}_{1 p} ,$$

and ¹h_{1q}=0. The ¹F and the B are substituted into the ¹H=¹F·B to obtain a following equation set:

$$\{ \begin{matrix}{\sum }_{s = 1}^{3} {}^{1} {f}_{1 s} \cdot {b}_{s p} = {}^{1} {h}_{1 p} \\ {\sum }_{s = 1}^{3} {}^{1} {f}_{1 s} \cdot {b}_{{sp}^{′}} = \frac{{u}_{p max} - {u}_{p min}}{{u}_{{p}^{′} max} - {u}_{{p}^{′} min}} {}^{1} {h}_{1 p} \\ {\sum }_{s = 1}^{3} {}^{1} {f}_{1 s} \cdot {b}_{s q} = 0\end{matrix} \qquad ( 9 )$$

The linear equation set (9) is solved to obtain the first row of the ¹F, and a first row (¹h₁₁, . . . , ¹h₁ₘ) of the matrix ¹H according to the ¹H=¹F·B.

If ¹h_{1p′}>0, and ¹h_{1p′}<0, a step 4-4-9) is performed; if ¹h_{1p′}<0 and ¹h_{1p′}<0, a step 4-4-10) is performed; or if ¹h_{1p′}·¹h_{1p′}>0, a step 4-4-11) is performed.

4-4-9) Process other rows than the rows p, q, p′, q′ of the matrix ¹Π according to a following rule, where a boundary surface represented by an obtained matrix is the key boundary surface and placed into the set Ω, and i=1, . . . , m, i≠p, p′, q, q′; and then perform determining as follows:
if two key boundary surfaces have been found for the group, perform a step 4-6); otherwise, perform the step 4-4-11).

The rule is as follows:
when ¹h₁ᵢ·¹h₁ᵢ₊₁<0,
if ¹h₁ᵢ>0 and ¹h₁ᵢ₊₁<0, setting the i^{th} row of the matrix ¹Π to the uᵢₘₐₓ and an i+1^{th} row to uᵢ₊₁ₘᵢₙ; or
if ¹h₁ᵢ<0 and ¹h₁ᵢ₊₁>0, setting the i^{th} row of the matrix ¹Π to the uᵢₘᵢₙ and an i+1^{th} row to uᵢ₊₁ₘₐₓ;
when ¹h₁ᵢ<0 and ¹h₁ᵢ₊₁<0,
setting the i^{th} row of the matrix ¹Π to the uᵢₘᵢₙ and an i+1^{th} row to uᵢ₊₁ₘᵢₙ, or
when ¹h₁ᵢ>0 and ¹h₁ᵢ₊₁>0,
calculating ⁵d₀₁=¹h₁ᵢ·uᵢₘₐₓ+¹h₁ᵢ₊₁·uᵢ₊₁ₘᵢₙ, and ⁵d₀₂=¹h₁ᵢ·uᵢₘᵢₙ+¹h₁ᵢ₊₁·uᵢ₊₁ₘₐₓ; and if ⁵d₀₁>⁵d₀₂, setting an i^{th} row of the matrix ¹Π to the uᵢₘₐₓ and the i+1^{th} row to the uᵢ₊₁ₘᵢₙ; if ⁵d₀₁<⁵d₀₂, setting an i^{th} row of the matrix ¹Π to the uᵢₘᵢₙ and an i+1^{th} row to uᵢ₊₁ₘₐₓ; or if ⁵d₀₁=⁵d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and i+1^{th} row to uᵢ₊₁ₘₐₓ.

4-4-10) Process other rows than the rows p, q, p′, q′ of the matrix ¹Π according to a following rule, where a boundary surface represented by an obtained matrix is the key boundary surface and placed into the set Ω, and i=1, . . . , m, i≠p, p′, q, q′; and then perform determining as follows:

if two key boundary surfaces have been found for the group, perform a step 4-6); otherwise, perform the step 4-4-11).

The rule is as follows:
when ¹h₁ᵢ·¹h₁ᵢ₊₁<0,
if ¹h₁ᵢ>0 and ¹h₁ᵢ₊₁<0, setting the i^{th} row of the matrix ¹Π to the uᵢₘᵢₙ and an i+1^{th} row to uᵢ₊₁ₘₐₓ; or
if ¹h₁ᵢ<0 and ¹h₁ᵢ₊₁>0, setting the i^{th} row of the matrix ¹Π to the uᵢₘₐₓ and an i+1^{th} row to uᵢ₊₁ₘᵢₙ;
when ¹h₁ᵢ>0 and ¹h₁ᵢ₊₁>0,
setting the i^{th} row of the matrix ¹Π to the uᵢₘᵢₙ and an i+1^{th} row to uᵢ₊₁ₘᵢₙ, or
when ¹h₁ᵢ<0 and ¹h₁ᵢ₊₁<0,
calculating ⁶d₀₁=¹h₁ᵢ·uᵢₘₐₓ+¹h₁ᵢ₊₁·uᵢ₊₁ₘᵢₙ, and ⁶d₀₂=¹h₁ᵢ·uᵢₘᵢₙ+¹h₁ᵢ₊₁·uᵢ₊₁ₘₐₓ; and if ⁶d₀₁>⁶d₀₂, setting an i^{th} row of the matrix ¹Π to the uᵢₘᵢₙ and the i+1^{th} row to the uᵢ₊₁ₘₐₓ; if ⁶d₀₁<⁶d₀₂, setting an i^{th} row of the matrix ¹Π to the uᵢₘₐₓ and an i+1^{th} row to uᵢ₊₁ₘᵢₙ; or if ⁶d₀₁=⁶d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and i+1^{th} row to uᵢ₊₁ₘₐₓ.

4-4-11) Construct a coordinate rotation transformation ²F, such that a transformed coordinate axis v₁ is perpendicular to an image of a boundary surface whose vertex matrix is the ²Λ in the group, and images of all points on the boundary surface have equal coordinate values on the v₁ axis, where only a first row of the ²F is required because only the v₁ axis is considered.

$${}^{2} F = [ \begin{matrix}{}^{2} {f}_{11} & {}^{2} {f}_{12} & {}^{2} {f}_{13} \\ {}^{2} {f}_{21} & {}^{2} {f}_{22} & {}^{2} {f}_{23} \\ {}^{2} {f}_{31} & {}^{2} {f}_{32} & {}^{2} {f}_{33}\end{matrix} ] , B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] ,$$

$$and {}^{2} H = [ \begin{matrix}{}^{2} {h}_{11} & … & {}^{2} {h}_{1 p} & {}^{2} {h}_{1 {p}^{′}} & … & {}^{2} {h}_{1 q} & … & {}^{2} {h}_{1 m} \\ {}^{2} {h}_{21} & … & {}^{2} {h}_{2 p} & {}^{2} {h}_{2 {p}^{′}} & … & {}^{2} {h}_{2 q} & … & {}^{2} {h}_{2 m} \\ {}^{2} {h}_{31} & … & {}^{2} {h}_{3 p} & {}^{2} {h}_{3 {p}^{′}} & … & {}^{2} {h}_{3 q} & … & {}^{2} {h}_{3 m}\end{matrix} ]$$

are set, where ²fᵢⱼ represents an element of an i^{th} row and a j^{th} column of the matrix ²F, and ²hᵢⱼ represents an element of an i^{th} row and a j^{th} column of the matrix ²H.

²H=²F·B is set, such that

$${}^{2} {h}_{1 {q}^{′}} = \frac{{u}_{q max} - {u}_{q min}}{{u}_{q max} - {u}_{q min}} {}^{2} {h}_{1 q} ,$$

and ²h₁ₚ=0. The ²F and the B are substituted into the ²H=²F·B to obtain a following equation set:

$$\{ \begin{matrix}{\sum }_{s = 1}^{3} {}^{2} {f}_{1 s} \cdot {b}_{sq} & = 0 \\ {\sum }_{s = 1}^{3} {}^{2} {f}_{1 s} \cdot {b}_{sq} & = {}^{2} {h}_{1 q} \\ {\sum }_{s = 1}^{3} {}^{2} {f}_{1 s} \cdot {b}_{{sq}^{′}} & = \frac{{u}_{q max} - {u}_{q min}}{{u}_{{q}^{′} max} - {u}_{{q}^{′} min}} {}^{2} {h}_{1 q}\end{matrix} \qquad ( 10 )$$

The linear equation set (10) is solved to obtain the first row of the ²F, and a first row (²h₁₁, . . . , ²h₁ₘ) of the matrix ²H according to the ²H=²F·B. If and ²h_{1p′}<0 and ²h_{1q′}>0, a step 4-4-12) is performed; if ²h_{1p′}>0 and ²h_{1q′}<0, a step 4-4-13) is performed; or if ²h_{1p′}·²h_{1q′}>0, a step 4-6) is performed.

4-4-12) Process other rows than the rows p, q, p′, q′ of the matrix ¹Π according to a following rule, where a boundary surface represented by an obtained matrix is the key boundary surface and placed into the set Ω, and i=1, . . . , m, i≠p, p′, q, q′; and then perform the step 4-6).

The rule is as follows:
when ²h₁ᵢ·²h₁ᵢ₊₁<0,
if ²h₁ᵢ>0 and ²h₁ᵢ₊₁<0, setting the i^{th} row of the matrix ²Π to the uᵢₘₐₓ and an i+1^{th} row to uᵢ₊₁ₘᵢₙ; or
if ²h₁ᵢ<0 and ²h₁ᵢ₊₁>0, setting the i^{th} row of the matrix ²Π to the uᵢₘᵢₙ and an i+1^{th} row to uᵢ₊₁ₘₐₓ;
when ²h₁ᵢ<0 and ²h₁ᵢ₊₁<0,
setting the i^{th} row of the matrix ²Π to the uᵢₘᵢₙ and an i+1^{th} row to uᵢ₊₁ₘᵢₙ, or
when ²h₁ᵢ<0 and ²h₁ᵢ₊₁<0,
calculating ⁷d₀₁=²h₁ᵢ·uᵢₘₐₓ+²h₁ᵢ₊₁·uᵢ₊₁ₘᵢₙ, and ⁷d₀₂=²h₁ᵢ·uᵢₘᵢₙ+²h₁ᵢ₊₁·uᵢ₊₁ₘₐₓ; and if ⁷d₀₁>⁷d₀₂, setting an i^{th} row of the matrix ²Π to the uᵢₘₐₓ and the i+1^{th} row to the uᵢ₊₁ₘᵢₙ; if ⁷d₀₁<⁷d₀₂, setting an i^{th} row of the matrix ²Π to the uᵢₘᵢₙ and an i+1^{th} row to uᵢ₊₁ₘₐₓ; or if ⁷d₀₁=⁷d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and i+1^{th} row to uᵢ₊₁ₘₐₓ.

4-4-13) Process other rows than the rows p, q, p′, q′ of the matrix ²Π according to a following rule, where a boundary surface represented by an obtained matrix is the key boundary surface and placed into the set Ω, and i=1, . . . , m, i≠p, p′, q, q′; and then perform the step 4-6).

The rule is as follows:
when ²h₁ᵢ·²h₁ᵢ₊₁<0,
if ²h₁ᵢ>0 and ²h₁ᵢ₊₁<0, setting the i^{th} row of the matrix ²Π to the uᵢₘᵢₙ and an i+1^{th} row to uᵢ₊₁ₘₐₓ; or
if ²h₁ᵢ<0 and ²h₁ᵢ₊₁>0, setting the i^{th} row of the matrix ¹Π to the uᵢₘₐₓ and an i+1^{th} row to uᵢ₊₁ₘᵢₙ;
when ²h₁ᵢ>0 and ²h₁ᵢ₊₁>0,
calculating ⁸d₀₁=²h₁ᵢ·uᵢₘₐₓ+²h₁ᵢ₊₁·uᵢ₊₁ₘᵢₙ, and ⁸d₀₂=²h₁ᵢ·uᵢₘᵢₙ+²h₁ᵢ₊₁·uᵢ₊₁ₘₐₓ; and if ⁸d₀₁>⁸d₀₂, setting an i^{th} row of the matrix ²Π to the uᵢₘᵢₙ and the i+1^{th} row to the uᵢ₊₁ₘₐₓ; if ⁸d₀₁<⁸d₀₂, setting an i^{th} row of the matrix ²Π to the uᵢₘₐₓ and an i+1^{th} row to uᵢ₊₁ₘᵢₙ; or if ⁸d₀₁=⁸d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and i+1^{th} row to uᵢ₊₁ₘₐₓ; or
when ²h₁ᵢ>0 and ²h₁ᵢ₊₁>0,
setting the i^{th} row of the matrix ²Π to the uᵢₘᵢₙ and an i+1^{th} row to uᵢ₊₁ₘᵢₙ.

4-5) When the p^{th} control component and the q^{th} control component are not a pair of linear constraint components, and the q^{th} control component has no paired linear constraint component, determine a key boundary surface of the p-q group according to a following specific method:

4-5-1) This situation occurs only when m is an odd number and q=m. The p-q group contains both the type-I and the type-II rectangular boundary surfaces. Each component of each point on the boundary surfaces of the group has a value that satisfies a following formula (11). A component paired with the p^{th} component is denoted as a p′^{th} component.

$$\{ \begin{matrix}{u}_{pmin} \leq {u}_{p} \leq {u}_{p max} \\ {u}_{q min} \leq {u}_{q} \leq {u}_{qmax} \\ {u}_{{p}^{′}} ∈ \{ {u}_{{p}^{′} min} , \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} \} \\ {u}_{i} ∈ \{ {u}_{i min} , {u}_{i max} \} , 1 \leq i < m , i \neq p , q , {p}^{′} \\ {u}_{k} + {u}_{k + 1} < {u}_{k max} + {u}_{k + 1 max} , k = 1 , 3 , … , 2 [ \frac{m}{2} ] - 1 , k \neq p , q , {p}^{′}\end{matrix} \qquad ( 11 )$$

When u_{p′}=u_{p′min}, it is determined that a boundary surface formed by a point satisfying the formula (11) is the type-I rectangular boundary surface; or when

$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} ,$$

it is determined that a boundary surface formed by a point satisfying the formula (11) is the type-II rectangular boundary surface.

A vertex of each boundary surface in the group can be represented by an m row and 4-column matrix, and 4 columns respectively represent vectors corresponding to 4 vertices. A matrix Λ′ is used to represent a vertex of one type-I rectangular boundary surface, and a matrix Π′ is used to represent a vertex of one type-I rectangular boundary surface. Values of the p^{th} p′^{th}, and q^{th} components of four vertices on each boundary surface are shown in p^{th}, p′^{th} and q^{th} rows of the matrix. A value of an i(i=1, . . . , m, i≠p, p′, q)^{th} component is the uᵢₘₐₓ or the uₘᵢₙ, and an i(i=1, . . . , m, i≠p, p′, q)^{th} row of the corresponding matrix is the uᵢₘₐₓ or the uᵢₘᵢₙ. However, one pair of linear constraint components cannot simultaneously take a maximum constraint value corresponding to the one pair of linear constraint components, and the maximum constraint value is uniformly represented by an ellipsis in the matrix. For the Λ′, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}), the q^{th} row is) (u_{qmin}, u_{qmin}, u_{qmax}, u_{qmax}), and the q^{th} row is (u_{q′min}, u_{q′min}, u_{q′min}, u_{q′min}).

$${Λ}^{′} = [ \begin{matrix}⋯ & ⋯ & ⋯ & ⋯ \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ ⋯ & ⋯ & ⋯ & ⋯ \\ {u}_{q min} & {u}_{q min} & {u}_{q max} & {u}_{q max}\end{matrix} ] , {\prod }^{′} = [ \begin{matrix}⋯ & ⋯ & ⋯ & ⋯ \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ ⋯ & ⋯ & ⋯ & ⋯ \\ {u}_{q min} & {u}_{q min} & {u}_{q max} & {u}_{q max}\end{matrix} ]$$

In the matrices shown in the above formula, if P is an odd number, the p^{th} row comes before the p′^{th} row; or if P is an even number, the p^{th} row comes after the p′^{th} row.

4-5-2) Construct a coordinate rotation transformation ³T, such that a transformed coordinate axis v₁ is perpendicular to an image of the type-I rectangular boundary surface of the group, where only a first row of the ³T is required because only the v₁ axis is considered.

$${}^{3} T = [ \begin{matrix}{}^{3} {t}_{11} & {}^{3} {t}_{12} & {}^{3} {t}_{13} \\ {}^{3} {t}_{21} & {}^{3} {t}_{22} & {}^{3} {t}_{23} \\ {}^{3} {t}_{31} & {}^{3} {t}_{32} & {}^{3} {t}_{33}\end{matrix} ] , B = [ \begin{matrix}{b}_{11} & … & {b}_{1 p} & … & {b}_{1 q} \\ {b}_{21} & … & {b}_{2 p} & … & {b}_{2 q} \\ {b}_{31} & … & {b}_{3 p} & … & {b}_{3 q}\end{matrix} ] , and {}^{3} C = [ \begin{matrix}{}^{3} {c}_{11} & … & {}^{3} {c}_{1 p} & … & {}^{3} {c}_{1 q} \\ {}^{3} {c}_{21} & … & {}^{3} {c}_{2 p} & … & {}^{3} {c}_{2 q} \\ {}^{3} {c}_{31} & … & {}^{3} {c}_{3 p} & … & {}^{3} {c}_{3 q}\end{matrix} ]$$

are set, where ³tᵢⱼ represents an element of an i^{th} row and a j^{th} column of the matrix ³T, and ³cᵢⱼ represents an element of an i^{th} row and a j^{th} column of the matrix ³C.

³C=³T·B is set, such that ³c₁ₚ=0, and ³c_{1q}=0. The ³T and the B are substituted into the ³C=³T·B to obtain a following equation set:

$$\{ \begin{matrix}{\sum }_{s = 1}^{3} {}^{3} {t}_{1 s} \cdot {b}_{sp} & = 0 \\ {\sum }_{s = 1}^{3} {}^{3} {t}_{1 s} \cdot {b}_{sq} & = 0\end{matrix} \qquad ( 12 )$$

The linear equation set (12) is solved to obtain the first row (³t₁₁, ³t₁₂, ³t₁₃) of the ³T. Then, a first row (³c₁₁, . . . , ³c₁ₘ) of the matrix ³C can be calculated according to the ³C=³T·B. If ³c_{1p′}<0, a step 4-5-3) is performed; or if ³c_{1p′}>0, a step 4-5-4) is performed.

4-5-3) Process other rows than the rows p, q, p′ according to a following rule, where a boundary surface represented by an obtained matrix is the key boundary surface and placed into the set Ω; and then perform a step 4-5-5), where i=1, . . . , m, i≠p, p′, q.

The rule is as follows:
when ³c₁ᵢ·³c₁ᵢ₊₁<0,
if ³c₁ᵢ>0 and ³c₁ᵢ₊₁<0, setting the i^{th} row of the matrix Λ′ to the uᵢₘₐₓ and an i+1^{th} row to uᵢ₊₁ₘᵢₙ; or
if ³c₁ᵢ<0 and ³c₁ᵢ₊₁>0, setting the i^{th} row of the matrix Λ′ to the uᵢₘᵢₙ and an i+1^{th} row to uᵢ₊₁ₘₐₓ;
when ³c₁ᵢ<0 and ³c₁ᵢ₊₁<0,
setting the i^{th} row of the matrix Λ′ to the uᵢₘᵢₙ and an i+1^{th} row to uᵢ₊₁ₘᵢₙ; or
when ³c₁ᵢ>0 and ³c₁ᵢ₊₁>0,
calculating ⁹d₀₁=³c₁ᵢ·uᵢₘₐₓ+³c₁ᵢ₊₁·uᵢ₊₁ₘᵢₙ, and ⁹d₀₂=³c₁ᵢ·uᵢₘᵢₙ+³c₁ᵢ₊₁·uᵢ₊₁ₘₐₓ; and
if ⁹d₀₁>⁹d₀₂, setting an i^{th} row of the matrix Λ′ to the uᵢₘₐₓ and the i+1^{th} row to uᵢ₊₁ₘᵢₙ; if ⁹d₀₁<⁹d₀₂, setting an i^{th} row of the matrix Λ to the uᵢₘᵢₙ and an i+1^{th} row to uᵢ₊₁ₘₐₓ; or if ⁹d₀₁=⁹d₀₂, setting an i^{th} row and an i+1^{th} row of the matrix Λ′ as follows: setting the i^{th} row of the matrix Λ′ to the uᵢₘᵢₙ and the i+1^{th} row to uᵢ₊₁ₘₐₓ.

4-5-4) Process other rows than the rows p, q, p′ of the matrix Λ′ according to a following rule, where a boundary surface represented by an obtained matrix is the key boundary surface and placed into the set Ω; and then perform a step 4-5-5), where i=1, . . . , m, i≠p, p′, q.

The rule is as follows:
when ³c₁ᵢ·³c₁ᵢ₊₁<0,
if ³c₁ᵢ>0 and ³c₁ᵢ₊₁<0, setting the i^{th} row of the matrix Λ′ to the uᵢₘᵢₙ and an i+1^{th} row to uᵢ₊₁ₘₐₓ; or
if ³c₁ᵢ<0 and ³c₁ᵢ₊₁>0, setting the i^{th} row of the matrix Λ′ to the uᵢₘₐₓ and an i+1^{th} row to uᵢ₊₁ₘᵢₙ;
when ³c₁ᵢ>0 and ³c₁ᵢ₊₁>0,
setting the i^{th} row of the matrix Λ′ to the uᵢₘᵢₙ and an i+1^{th} row to uᵢ₊₁ₘᵢₙ; or
when ³c₁ᵢ<0 and ³c₁ᵢ₊₁<0,
calculating ¹⁰d₀₁=³c₁ᵢ·uᵢₘₐₓ+³c₁ᵢ₊₁·uᵢ₊₁ₘᵢₙ, and ¹⁰d₀₂=³c₁ᵢ·uᵢₘᵢₙ+³c₁ᵢ₊₁·uᵢ₊₁ₘₐₓ; and if ¹⁰d₀₁>¹⁰d₀₂, setting an i^{th} row of the matrix Λ′ to the uᵢₘᵢₙ and the i+1^{th} row to uᵢ₊₁ₘₐₓ; if ¹⁰d₀₁<¹⁰d₀₂, setting an i^{th} row of the matrix Λ to the uᵢₘₐₓ and an i+1^{th} row to uᵢ₊₁ₘᵢₙ; or if ¹⁰d₀₁=¹⁰d₀₂, setting an i^{th} row and an i+1^{th} row of the matrix Λ′ as follows: setting the i^{th} row of the matrix Λ′ to the uᵢₘᵢₙ and the i+1^{th} row to uᵢ₊₁ₘₐₓ.

4-5-5) Construct a coordinate rotation transformation ³F, such that a transformed coordinate axis v₁ is perpendicular to an image of a boundary surface whose vertex matrix is the Π′ in the group, and images of all points on the boundary surface have equal coordinate values on the v₁ axis, where only a first row of the ³F is required because only the v₁ axis is considered.

$${}^{3} F = [ \begin{matrix}{}^{3} {f}_{11} & {}^{3} {f}_{12} & {}^{3} {f}_{13} \\ {}^{3} {f}_{21} & {}^{3} {f}_{22} & {}^{3} {f}_{23} \\ {}^{3} {f}_{31} & {}^{3} {f}_{32} & {}^{3} {f}_{33}\end{matrix} ] , B = [ \begin{matrix}{b}_{11} & … & {b}_{1 p} & {b}_{1 {p}^{′}} & … & {b}_{1 q} \\ {b}_{21} & … & {b}_{2 p} & {b}_{2 {p}^{′}} & … & {b}_{2 q} \\ {b}_{31} & … & {b}_{3 p} & {b}_{3 {p}^{′}} & … & {b}_{3 q}\end{matrix} ] , and {}^{3} H = [ \begin{matrix}{}^{3} {h}_{11} & … & {}^{3} {h}_{1 p} & {}^{3} {h}_{1 {p}^{′}} & … & {}^{3} {h}_{1 q} \\ {}^{3} {h}_{21} & … & {}^{3} {h}_{2 p} & {}^{3} {h}_{2 {p}^{′}} & … & {}^{3} {h}_{2 q} \\ {}^{3} {h}_{31} & … & {}^{3} {h}_{3 p} & {}^{3} {h}_{3 {p}^{′}} & … & {}^{3} {h}_{3 q}\end{matrix} ]$$

are set, where ³hᵢⱼ represents an element of an i^{th} row and a j^{th} column of the matrix ³H, and ³fᵢⱼ represents an element of an i^{th} row and a j^{th} column of the matrix ³F.

³H=³F·B is set, such that

$${}^{3} {h}_{1 {p}^{′}} = \frac{{u}_{p max} - {u}_{p min}}{{u}_{{p}^{′} max} - {u}_{{p}^{′} min}} {}^{3} {h}_{1 p} ,$$

and ³h_{1q}=0. The ³F and the B are substituted into the ³H=³F·B to obtain a following equation set:

$$\{ \begin{matrix}{\sum }_{s = 1}^{3} {}^{3} {f}_{1 s} \cdot {b}_{sp} & {=}^{3} {h}_{1 p} \\ {\sum }_{s = 1}^{3} {}^{3} {f}_{1 s} \cdot {b}_{s p} & = \frac{{u}_{pmax} - {u}_{pmin}}{{u}_{pmax} - {u}_{pmin}} {}^{3} {h}_{1 p} \\ {\sum }_{s = 1}^{3} {}^{3} {f}_{1 s} \cdot {b}_{sq} & = 0\end{matrix} \qquad ( 13 )$$

The linear equation set (13) is solved to obtain the first row of the ³F, and a first row (³h₁₁, . . . , ³h₁ₘ) of the matrix ³H according to the ³H=³F·B. If ³h_{1p′}>0, a step 4-5-6) is performed; or if ³h_{1p′}<0, a step 4-5-7) is performed.

4-5-6) Process other rows than the rows p, q, p′ of the matrix Π′ according to a following rule, where a boundary surface represented by an obtained matrix is the key boundary surface and placed into the set Ω; and then perform a step 4-6), where i=1, . . . , m, i≠p, p′, q.

The rule is as follows:
when ³h₁ᵢ·³h₁ᵢ₊₁<0,
if ³h₁ᵢ>0 and ³h₁ᵢ₊₁<0, setting the i^{th} row of the matrix Π to the uᵢₘₐₓ and an i+1^{th} row to uᵢ₊₁ₘᵢₙ; or
if ³h₁ᵢ<0 and ³h₁ᵢ₊₁>0, setting the i^{th} row of the matrix Π to the uᵢₘᵢₙ and an i+1^{th} row to uᵢ₊₁ₘₐₓ;
when ³h₁ᵢ<0 and ³h₁ᵢ₊₁<0,
setting the i^{th} row of the matrix Π to the uᵢₘᵢₙ and an i+1^{th} row to uᵢ₊₁ₘᵢₙ, or
when ³h₁ᵢ>0 and ³h₁ᵢ₊₁>0,
calculating ¹¹d₀₁=³h₁ᵢ·uᵢₘₐₓ+³h₁ᵢ₊₁·uᵢ₊₁ₘᵢₙ, and ¹¹d₀₂=³h₁ᵢ·uᵢₘᵢₙ+³h₁ᵢ₊₁·uᵢ₊₁ₘₐₓ; and if ¹¹d₀₁>¹¹d₀₂, setting an i^{th} row of the matrix Π to the uᵢₘₐₓ and the i+1^{th} row to the uᵢ₊₁ₘᵢₙ; if ¹¹d₀₁<¹¹d₀₂, setting an i^{th} row of the matrix Π to the uᵢₘᵢₙ and an i+1^{th} row to uᵢ₊₁ₘₐₓ; or if ¹¹d₀₁=¹¹d₀₂, setting an i^{th} row and an i+1^{th} row of the matrix Π as follows: setting the i^{th} row of the matrix Π to the uᵢₘₐₓ and the i+1^{th} row to uᵢ₊₁ₘᵢₙ; or setting the i^{th} row of the matrix Π to the uᵢₘᵢₙ and i+1^{th} row to uᵢ₊₁ₘₐₓ.

4-5-7) Process other rows than the rows p, q, p′ of the matrix Π′ according to a following rule, where a boundary surface represented by an obtained matrix is the key boundary surface and placed into the set Ω; and then perform a step 4-6), where i=1, . . . , m, i≠p, p′, q.

The rule is as follows:
when ³h₁ᵢ·³h₁ᵢ₊₁<0,
if ³h₁ᵢ>0 and ³h₁ᵢ₊₁<0, setting the i^{th} row of the matrix Π to the uᵢₘᵢₙ and an i+1^{th} row to uᵢ₊₁ₘₐₓ; or
if ³h₁ᵢ<0 and ³h₁ᵢ₊₁>0, setting the i^{th} row of the matrix Π to the uᵢₘₐₓ and an i+1^{th} row to uᵢ₊₁ₘᵢₙ;
when ³h₁ᵢ<0 and ³h₁ᵢ₊₁<0,
calculating ¹²d₀₁=³h₁ᵢ·uᵢₘₐₓ+³h₁ᵢ₊₁·uᵢ₊₁ₘᵢₙ, and ¹²d₀₂=³h₁ᵢ·uᵢₘᵢₙ+³h₁ᵢ₊₁·uᵢ₊₁ₘₐₓ; and if ¹²d₀₁>¹²d₀₂, setting an i^{th} row of the matrix Π to the uᵢₘᵢₙ and the i+1^{th} row to the uᵢ₊₁ₘₐₓ; if ¹²d₀₁<¹²d₀₂, setting an i^{th} row of the matrix Π to the uᵢₘₐₓ and an i+1^{th} row to uᵢ₊₁ₘᵢₙ; or if ¹²d₀₁=¹²d₀₂, setting an i^{th} row and an i+1^{th} row of the matrix Π as follows: setting the i^{th} row of the matrix Π to the uᵢₘₐₓ and the i+1^{th} row to uᵢ₊₁ₘᵢₙ; or setting the i^{th} row of the matrix Π′ to the uᵢₘᵢₙ and i+1^{th} row to uᵢ₊₁ₘₐₓ; or
when ³h₁ᵢ>0 and ³h₁ᵢ₊₁>0,
setting the i^{th} row of the matrix Π′ to the uᵢₘᵢₙ and an i+1^{th} row to uᵢ₊₁ₘᵢₙ.

4-6) Return to the step 4-1), select a next group for which no key boundary surface has been determined, until the key boundary surface has been determined for all groups, and then perform a step 5).

5) Check all key boundary surfaces in the Ω, and perform determining as follows: if there are identical key boundary surfaces, retain only one of the identical key boundary surfaces, and remove other key boundary surfaces that are the same as the retained one key boundary surface; after processing all the key boundary surfaces, form a new set of key boundary surfaces, which is denoted as Ω′; and then perform a step 6).

6) All key boundary surfaces in the Ω′ are all key boundary surfaces in the control set. All vertices of each key boundary surface in the Ω′ are mapped according to v=B·u_{ELR} to obtain all vertices of a boundary surface corresponding to the control attainable set, so as to determine the boundary surface of the control attainable set, where the boundary surface of the control attainable set is a quadrilateral or triangle. Boundary surfaces that are of the control attainable set and determined based on all the key boundary surfaces in the Ω′ constitute the boundary ∂(Φ_{ELR}) of the control attainable set.

The method in the present disclosure is further described in detail below with reference to a specific embodiment.

### EMBODIMENT

In this embodiment, a control attainable set of a four-wheel independently driven and independently steered vehicle is calculated.

Given that four longitudinal forces of four wheels are F_{L1}, F_{L2}, F_{L3}, and F_{L4}, respectively, and four lateral forces are F_{T1}, F_{T2}, F_{T3}, and F_{T4} respectively. It is set that uᵥ=(F_{L1}, F_{T1}, F_{L2}, F_{T2}, F_{L3},F_{T3}, F_{L4}, F_{T4})^{T}, F_{Limin}≤F_{Li}≤F_{Limax}, F_{Timin}≤F_{Ti}≤F_{Timax}, i=1, . . . , 4, F_{Limin}, F_{Timin} respectively represent minimum values of the longitudinal and lateral forces of each wheel, F_{Limax}, F_{Timax} respectively represent maximum values of the longitudinal and lateral forces of each wheel, [F_{L1min}, . . . , F_{L4min}]=[−16, −16, −19.3, −19.3], [F_{T1min}, . . . , F_{T4min}]=[−5, −5, −9.21, −9.21], [F_{L1max}, . . . , F_{L4max}]=[16, 16, 9.3, 9.3], and [F_{T1max}, . . . , F_{T4max}]=[5,5,9.21,9.21]. There is a following linear relationship between an i^{th} longitudinal force and an i^{th} lateral force: (F_{Limax}-F_{Limin})F_{Ti}+(F_{Timax}-F_{Timax})F_{Li}≤F_{Timax}F_{Limax}−F_{Timin}F_{Limin}. All values of the uᵥ constitute a control set Ωᵥ={uᵥ} of the four-wheel independently driven and independently steered vehicle. In addition, a wheel force control efficiency matrix Bᵥ is known:

$${B}_{v} = ( \begin{matrix}0.9397 & - 0.342 & 0.9563 & - 0.2924 & 0.9659 & 0.2588 & 0.9744 & 0.2249 \\ - 0.342 & 0.9397 & - 0.2924 & 0.9563 & 0.2588 & 0.9659 & 0.2249 & 0.9744 \\ 1.0762 & 0.1790 & 1.5435 & - 1.0787 & - 1.3403 & - 0.9867 & - 1.0118 & 0.4121\end{matrix} ) ,$$

The control attainable set Φᵥ of the four-wheel independently driven and independently steered vehicle is calculated according to a following formula: Φᵥ={v_{VS}|v_{VS}=Bᵥ·u_{VS}=(F_{LS}, F_{TS}, M_{S})^{T}, uᵥₛ∈Ωᵥ}, where F_{LS} represents a specific overall longitudinal force of the vehicle, F_{TS} represents a specific overall lateral force of the vehicle, and Mₛ represents a specific overall yawing moment of the vehicle.

This embodiment proposes a method for calculating a control attainable set of a redundant drive system under a linear constraint, including following steps:

1) Construct a control attainable set of a redundant drive system under each pair of linear constraint control components.

In this embodiment, a correspondence between each physical quantity and the terms used in the foregoing description is as follows: Ωᵥ corresponds to Ω_{ELR}, Bᵥ corresponds to B, Φᵥ corresponds to Φ_{ELR}, and uᵥ=(F_{L1}, F_{T1}, F_{L2}, F_{T2}, F_{L3}, F_{T3}, F_{L4}, F_{T4})^{T} corresponds to u_{ELR}=(u₁, . . . , u₈)^{T} The physical problem is to:
determine a control containable set of an 8-dimensional control vector u_{ELR}=(u₁, . . . , u₈)^{T}, where u₁ and u₂ are a pair of control components, u₃ and u₄ are a pair of control components, u₅ and u₆ are a pair of control components, and u₇ and u₈ are a pair of control components; and each control component uᵢ has a value range, namely uᵢₘᵢₙ≤uᵢ≤uᵢₘₐₓ, where i=1, . . . , 8,

$$[ {u}_{1 min} , … , {u}_{8 min} ] = [ - 16 , - 5 , - 16 , - 5 , - 193 , - 921 , - 193 , - 9 \; 21 ] , and$$

$$[ {u}_{1 max} , … , {u}_{8 max} ] = [ 16 , 5 , 16 , 5 , 19.3 , 9.21 , 19.3 , 9.21 ] .$$

There is a following linear relationship between each pair of control components:

$$( {u}_{k max} - {u}_{k min} ) {u}_{k + 1} + ( {u}_{k + 1 max} - {u}_{k + 1 min} ) {u}_{k} \leq {u}_{k + 1 max} {u}_{k max} - {u}_{k + 1 min} {u}_{k min} , k = 1 , 3 , 5 , 7.$$

Ω_{ELR}={u_{ELR}} is set, where

$${u}_{ELR} = {( {u}_{1} , … , {u}_{8} )}^{T}$$

$$s . t .$$

$${u}_{imin} \leq {u}_{i} \leq {u}_{imax} , i = 1 , L , 8 ;$$

$$( {u}_{k max} - {u}_{k min} ) {u}_{k + 1} + ( {u}_{k + 1 max} - {u}_{k + 1 min} ) {u}_{k} \leq {u}_{k + 1 max} {u}_{k max} - {u}_{k + 1 min} {u}_{k min} , k = 1 , 3 , 5 , 7 ;$$

Each control vector u_{ELR} of the Ω_{ELR} generates a control attainable vector v through following mapping: v=B·u_{ELR}, where B:R⁸→R³,

$$B = ( \begin{matrix}0.9397 & - 0.342 & 0.9563 & - 0.2924 & 0.9659 & 0.2588 & 0.9744 & 0.2249 \\ - 0.342 & 0.9397 & - 0.2924 & 0.9563 & 0.2588 & 0.9659 & 0.2249 & 0.9744 \\ 1.0762 & 0.179 & 1.5435 & - 1.0787 & - 1.3403 & - 0.9867 & - 1.0118 & 0.4121\end{matrix} ) .$$

Requirement: Determine ∂(Φ_{ELR}) of the control attainable set.

2) Classify all boundary surfaces of the control set Ω_{ELR} into four types.

A point obtained by taking a corresponding maximum or minimum constraint value of each component uᵢ(i=1, . . . , 8) of the control vector u_{ELR}=(u₁, . . . , u₈)^{T} is a vertex of the control set Ω_{ELR}. The 8-dimensional control set Ω_{ELR} in this embodiment has 3⁴ vertices. Boundary surfaces constituting ∂(Ω_{ELR}) are a type-rectangular boundary surface, a type-rectangular boundary surface, a type−=2\*ROMAN I rectangular boundary surface, and a triangular boundary surface.

3) Divide all the boundary surfaces of the control set into C₈² groups.

Values of a p^{th} control component uₚ, u_{q} and a q^{th} control component (1≤p≤8, 1≤q≤8, p<q) are between the corresponding minimum and maximum values, and values of other 6 components uᵢ(1≤i≤8, i≠p, i≠q) are the corresponding minimum or maximum value, namely, uᵢ=uᵢₘₐₓ or uᵢₘᵢₙ Through such combination, a total of 2⁶ boundary surfaces are obtained and added to a group referred to as a p-q group. All the boundary surfaces of the control set are divided into a total of 28 groups, namely, a 1-2 group, a 1-3 group, . . . , and a 7-8 group.

4) Determine a key boundary surface for each of the C₈² groups in the step 3).

There are a total of 28 groups. Due to limited space, only the 1-2 group and the 3-5 group are used as examples to illustrate a process of determining the key boundary surface. A set of key boundary surfaces is denoted as Ω, and the Ω is initialized as an empty set.

4-1) Denote the 1-2 group as a current p-q group.

4-2) Perform a step 4-3) because a first control component and a second control component are a pair of linear constraint components.

4-3)

4-3-1) Boundary surfaces of the group are all triangular boundary surfaces.

4-3-2) Construct a coordinate rotation transformation ¹T, such that a transformed coordinate axis v₁ is perpendicular to an image of the triangular boundary surface of the group, where only a first row of the ¹T is required because only the v₁ axis is considered.

Given that

$$B = ( \begin{matrix}0.9397 & - 0.342 & 0.9563 & - 0.2924 & 0.9659 & 0.2588 & 0.9744 & 0.2249 \\ - 0.342 & 0.9397 & - 0.2924 & 0.9563 & 0.2588 & 0.9659 & 0.2249 & 0.9744 \\ 1.0762 & 0.179 & 1.5435 & - 1.0787 & - 1.3403 & - 0.9867 & - 1.0118 & 0.4121\end{matrix} ) , \\ {1}^{} T = [ \begin{matrix}{1}^{} {t}_{11} & {1}^{} {t}_{12} & {1}^{} {t}_{13} \\ {1}^{} {t}_{21} & {1}^{} {t}_{22} & {1}^{} {t}_{23} \\ {1}^{} {t}_{31} & {1}^{} {t}_{32} & {1}^{} {t}_{33}\end{matrix} ] , {and }^{1} C = [ \begin{matrix}{1}^{} {c}_{11} & {1}^{} {c}_{12} & … & {1}^{} {c}_{18} \\ {1}^{} {c}_{21} & {1}^{} {c}_{22} & … & {1}^{} {c}_{28} \\ {1}^{} {c}_{31} & {1}^{} {c}_{32} & … & {1}^{} {c}_{38}\end{matrix} ]$$

are set. ¹C=¹T·B is set, such that ¹C₁₁=0, and ¹C₁₂=0.

The ¹T and the B are substituted into the ¹C=¹T·B to obtain a following equation set:

$$\{ \begin{matrix}{\sum }_{s = 1}^{3} {1}^{} {t}_{1 s} \cdot {b}_{s 1} = 0 \\ {\sum }_{s = 1}^{3} {1}^{} {t}_{1 s} \cdot {b}_{s 2} = 0\end{matrix} \qquad ( 14 )$$

The linear equation set (14) is solved. Set ¹t₁₃=1, such that ¹t₁₁=−1.4, ¹t₁₂=−0.7 can be calculated.

Then, the first row of the matrix ¹C can be calculated according to the ¹C=¹T·B, which is (¹c₁₁, . . . , ¹C₁₈)=(0, 0, 0.4093, −1.3388, −2.8738, −2.0252, −2.5334, −0.5849) Then, a step 4-3-3) is performed.

4-3-3) Due to ¹c₁₃·¹c₁₄<0, and ¹c₁₃>0, and ¹c₁₄<0, set a third row of a matrix Δ to u₃ₘₐₓ and a fourth row to u₄ₘᵢₙ; due to¹c₁₅<0,¹c₁₆<0, set a fifth row of the matrix Δ to u₅ₘᵢₙ and a sixth row to u₆ₘᵢₙ; due to ¹c₁₇<0,¹c₁₈<0, set a seventh row of the matrix Δ to u₇ₘᵢₙ and an eighth row to u₈ₘᵢₙ; and represent an obtained matrix by Δ₁, where a boundary surface represented by the matrix Δ₁, is the key boundary surface and placed into the set Ω, and then a step 4-3-4) is performed.

$${Δ}_{1} = [ \begin{matrix}16 & - 16 & - 16 \\ - 5 & - 5 & 5 \\ 16 & 16 & 16 \\ - 5 & - 5 & - 5 \\ - 19.3 & - 19.3 & - 19.3 \\ - 9.21 & - 9.21 & - 9.21 \\ - 19.3 & - 19.3 & - 19.3 \\ - 9.21 & - 9.21 & - 9.21\end{matrix} ]$$

4-3-4) Due to, and ¹c₁₃·¹c₁₄<0, and ¹c₁₃>0 and ¹c₁₄<0, set the third row of the matrix Δ to theu₃ₘᵢₙ and the fourth row to the u₄ₘₐₓ; due to ¹c₁₅<0, ¹c₁₆<0 and ¹c₁₅·u₅ₘₐₓ+¹c₁₆·u₆ₘᵢₙ<¹c₁₅·u₅ₘᵢₙ+¹c₁₆·u₆ₘₐₓ, set the fifth row of the matrix Δ to the u₅ₘₐₓ and the sixth row to the u₆ₘᵢₙ; due to ¹c₁₇<0,¹c₁₈<0 and ¹c₁₇·u₇ₘₐₓ+¹c₁₈·u₈ₘᵢₙ<¹c₁₇·u₇ₘᵢₙ+¹c₁₈·u₈ₘₐₓ, set the seventh row of the matrix Δ to the u₇ₘₐₓ and the eighth row to the u₈ₘᵢₙ; and represent an obtained matrix by Δ₂, where a boundary surface represented by the matrix Δ₂ is the key boundary surface and placed into the set Ω, and then a step 4-6) is performed.

$${Δ}_{2} = [ \begin{matrix}16 & - 16 & - 16 \\ - 5 & - 5 & 5 \\ - 16 & - 16 & - 16 \\ 5 & 5 & 5 \\ 19.3 & 19.3 & 19.3 \\ - 9.21 & - 9.21 & - 9.21 \\ 19.3 & 19.3 & 19.3 \\ - 9.21 & - 9.21 & - 9.21\end{matrix} ]$$

4-1) Denote the 3-5 group as a current p-q group.

4-2) Perform a step 4-4) because a third control component and a fifth control component are not a pair of linear constraint components, and m=8, which is an even number.

4-4)

4-4-1) The p-q group has three types of rectangular boundary surfaces. A step 4-4-2) is performed.

4-4-2) Construct a coordinate rotation transformation G, such that a transformed coordinate axis v₁ is perpendicular to an image of the type-III rectangular boundary surface of the group, where only a first row of the G is required because only the v₁ axis is considered.

Given that

$$B = ( \begin{matrix}0.9397 & - 0.342 & 0.9563 & - 0.2924 & 0.9659 & 0.2588 & 0.9744 & 0.2249 \\ - 0.342 & 0.9397 & - 0.2924 & 0.9563 & 0.2588 & 0.9659 & 0.2249 & 0.9744 \\ 1.0762 & 0.179 & 1.5435 & - 1.0787 & - 1.3403 & - 0.9867 & - 1.0118 & 0.4121\end{matrix} ) , G = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] and E = [ \begin{matrix}{e}_{11} & … & {e}_{13} & {e}_{14} & {e}_{15} & {e}_{16} & … & {e}_{18} \\ {e}_{21} & … & {e}_{23} & {e}_{24} & {e}_{25} & {e}_{26} & … & {e}_{28} \\ {e}_{31} & … & {e}_{33} & {e}_{34} & {e}_{35} & {e}_{36} & … & {e}_{38}\end{matrix} ]$$

are set. E=G·B is set, such that

$$\begin{matrix}{e}_{14} = \frac{{u}_{3 max} - {u}_{3 min}}{{u}_{4 max} - {u}_{4 min}} {e}_{13} , \\ {e}_{16} = \frac{{u}_{5 max} - {u}_{5 min}}{{u}_{6 max} - {u}_{6 min}} {e}_{15} .\end{matrix}$$

The G and the B are substituted into the E=G·B to obtain a following equation set:

$$\{ \begin{matrix}{\sum }_{s = 1}^{3} {g}_{1 s} \cdot {b}_{s 3} = {e}_{13} \\ {\sum }_{s = 1}^{3} {g}_{1 s} \cdot {b}_{s 4} = \frac{{u}_{3 max} - {u}_{3 min}}{{u}_{4 max} - {u}_{4 min}} {e}_{13} \\ {\sum }_{s = 1}^{3} {g}_{1 s} \cdot {b}_{s 5} = {e}_{15} \\ {\sum }_{s = 1}^{3} {g}_{1 s} \cdot {b}_{s 6} = \frac{{u}_{5 max} - {u}_{5 min}}{{u}_{6 max} - {u}_{6 min}} {e}_{15}\end{matrix} \qquad ( 15 )$$

The linear equation set (15) is solved to obtain the first row of the G, and a first row (e₁₁, . . . , e₁₈)=(0.2621 1.8566 0.5041 1.6130 1.0 2.0955 1.0152 2.4431) of the matrix E according to the E=G·B. Due to e₁₄>0 and e₁₆>0, a step 4-4-3) is performed.

4-4-3) Process other rows than third, fourth, fifth, and sixth rows of a matrix T according to a following rule, where a boundary surface represented by an obtained matrix is the key boundary surface and placed into the set Ω; and then perform a step 4-4-5).

Due to e₁₁>0 and e₁₂>0, and e₁₁·u₁ₘₐₓ+e₁₂·u₂ₘᵢₙ<e₁₁·u₁ₘᵢₙ+e₁₂·u₂ₘₐₓ, a first row of the matrix T is set to u₁ₘᵢₙ, and a second row is set to u₂ₘₐₓ; due to e₁₇>0 and e₁₈>0, and e₁₇·u₇ₘₐₓ+e₁₈·u₁₈ₘᵢₙ<e₁₇·u₇ₘᵢₙ+e₁₈·u₈ₘₐₓ, a seventh row of the matrix T is set to u₇ₘᵢₙ, and an eighth row is set to u₈ₘₐₓ; and an obtained matrix is represented by T₁, and a boundary surface represented by the matrix T₁ is the key boundary surface and placed in the set Ω

$${T}_{1} = [ \begin{matrix}- 16 & - 16 & - 16 & - 16 \\ 5 & 5 & 5 & 5 \\ 16 & - 16 & - 16 & 16 \\ - 5 & 5 & 5 & - 5 \\ - 19.3 & - 19.3 & 19.3 & 19.3 \\ 9.21 & 9.21 & - 9.21 & - 9.21 \\ - 19.3 & - 19.3 & - 19.3 & - 19.3 \\ 9.21 & 9.21 & 9.21 & 9.21\end{matrix} ]$$

4-4-5) Construct a coordinate rotation transformation ²T, such that a transformed coordinate axis v₁ is perpendicular to an image of the type-I rectangular boundary surface of the group, where only a first row of the ²T is required because only the v₁ axis is considered.

Given that

$$B = ( \begin{matrix}0.9397 & - 0.342 & 0.9563 & - 0.2924 & 0.9659 & 0.2588 & 0.9744 & 0.2249 \\ - 0.342 & 0.9397 & - 0.2924 & 0.9563 & 0.2588 & 0.9659 & 0.2249 & 0.9744 \\ 1.0762 & 0.179 & 1.5435 & - 1.0787 & - 1.3403 & - 0.9867 & - 1.0118 & 0.4121\end{matrix} ) , {2}^{} T = [ \begin{matrix}{2}^{} {t}_{11} & {2}^{} {t}_{12} & {2}^{} {t}_{13} \\ {2}^{} {t}_{21} & {2}^{} {t}_{22} & {2}^{} {t}_{23} \\ {2}^{} {t}_{31} & {2}^{} {t}_{32} & {2}^{} {t}_{33}\end{matrix} ] , {and }^{2} C = [ \begin{matrix}{2}^{} {c}_{11} & … & {2}^{} {c}_{13} & … & {2}^{} {c}_{15} & … & {2}^{} {c}_{18} \\ {2}^{} {c}_{21} & … & {2}^{} {c}_{23} & … & {2}^{} {c}_{25} & … & {2}^{} {c}_{28} \\ {2}^{} {c}_{31} & … & {2}^{} {c}_{33} & … & {2}^{} {c}_{35} & … & {2}^{} {c}_{38}\end{matrix} ]$$

are set. ²C=²T·B is set, such that ²c₁₃=0, and ²c₁₈=0. The ²T and the B are substituted into the ²C=²T·B to obtain a following equation set:

$$\{ \begin{matrix}{\sum }_{s = 1}^{3} {2}^{} {t}_{1 s} \cdot {b}_{s 3} = 0 \\ {\sum }_{s = 1}^{3} {2}^{} {t}_{1 s} \cdot {b}_{s 5} = 0\end{matrix} \qquad ( 16 )$$

The linear equation set (16) is solved. Set ²t₁₃=1, such that ²t₁₃=−0.0143, ²t₁₂=5.2321 can be calculated.

Then, a first row of the matrix ²C can be calculated according to the ²C=²T·B, which is (²c₁₁, . . . , ²c₁₈)=(−0.7266,5.1005,0,3.9289,0, 4.0633,0.151,5.507). Due to ²c₁₄>0 and ²c₁₆>0, a step 4-4-7) is performed.

4-4-7) Process other rows than third, fourth, fifth, and sixth rows of a matrix Λ according to a following rule, where a boundary surface represented by an obtained matrix is the key boundary surface and placed into the set Ω; and because two key boundary surfaces have been found for the group, a step 4-6) is performed.

Due to ²c₁₁·²c₁₂<0, and ²c₁₁<0 and ²c₁₂>0, a first row of the matrix Λ is set to u₁ₘₐₓ, and a second row is set to u₂ₘᵢₙ; due to ²c₁₇>0, ²c₁₈>0, a seventh row of the matrix Λ is set to u₇ₘᵢₙ, and an eighth row is set to u₈ₘᵢₙ; and an obtained matrix is represented by Λ₁, and a boundary surface represented by the matrix Λ₁ is the key boundary surface and placed into the set Ω.

$${Λ}_{1} = [ \begin{matrix}16 & 16 & 16 & 16 \\ - 5 & - 5 & - 5 & - 5 \\ 16 & - 16 & - 16 & 16 \\ - 5 & - 5 & - 5 & - 5 \\ - 19.3 & - 19.3 & 19.3 & 19.3 \\ - 9.21 & - 9.21 & - 9.21 & - 9.21 \\ - 19.3 & - 19.3 & - 19.3 & - 19.3 \\ - 9.21 & - 9.21 & - 9.21 & - 9.21\end{matrix} ]$$

4-6) Determine the key boundary surface for each group according to the steps 4-1 to 4-5-7 in this embodiment of the present disclosure.

Due to limited space, the key boundary surface is not determined for each group. Therefore, the above steps do not provide all elements of the set Ω. As a result, a step 6) is performed, while a step 5) is omitted.

Step 6) Constitute the boundary ∂(Φ_{ELR}) of the control attainable set by using boundary surfaces that are of the control attainable set and determined based on all key boundary surfaces in the Ω′. According to the implementation steps of the present disclosure, a total of 36 boundary surfaces of the control attainable set in this embodiment can be calculated. Because the step 5) is omitted, all the boundary surfaces of the control attainable set are not calculated any longer. Only boundary surfaces that are of the control attainable set and for the groups 1-2 and 3-5 are calculated below.

Three vertices of a key boundary surface Δ₁ in the 1-2 group are mapped according to v=B·u_{ELR} to obtain three vertices of a corresponding boundary surface of the control attainable set. In this way, it is determined that one boundary surface of the control attainable set is a triangle represented by a matrix ∂(Δ₁), with each column representing one vertex.

$$\partial ( {Δ}_{1} ) = [ \begin{matrix}- 8.3947 & - 38. 4651 & - 41. 8851 \\ - 46. 8360 & - 35. 8920 & - 26. 4950 \\ 97.1013 & 62.6629 & 64.4529\end{matrix} ]$$

Three vertices of another key boundary surface Δ₂ in the 1-2 group are mapped according to the v=B·u_{ELR} to obtain three vertices of a corresponding boundary surface of the control attainable set. In this way, it is determined that one boundary surface of the control attainable set is a triangle represented by a matrix ∂(Δ₂), with each column representing one vertex.

$$\partial ( {Δ}_{2} ) = [ \begin{matrix}32.9753 & 2.9049 & - 0.5151 \\ - 9.2454 & 1.6986 & 11.0956 \\ - 53. 8688 & - 88. 3072 & - 86. 5172\end{matrix} ]$$

Four vertices of a key boundary surface T₁ in the 3-5 group are mapped according to the v=B·u_{ELR} to obtain four vertices of a corresponding boundary surface of the control attainable set. In this way, it is determined that one boundary surface of the control attainable set is a quadrilateral represented by a matrix ∂(T₁), with each column representing one vertex.

$$\partial ( {T}_{1} ) = [ \begin{matrix}- 32. 9753 & - 66. 5009 & - 33. 9843 & - 0.4587 \\ 9.2454 & 28.1652 & 20.3630 & 1.4432 \\ 53.8688 & - 6.3102 & - 39. 8708 & 20.3082\end{matrix} ]$$

Four vertices of another key boundary surface Λ₁ in the 3-5 group are mapped according to the v=B·u_{ELR} to obtain four vertices of a corresponding boundary surface of the control attainable set. In this way, it is determined that one boundary surface of the control attainable set is a quadrilateral represented by a matrix ∂(Λ₁), with each column representing one vertex.

$$\partial ( {Λ}_{1} ) = [ \begin{matrix}- 8.3947 & - 38. 9963 & - 1.7125 & 28.8891 \\ - 46. 8360 & - 37. 4792 & - 27. 4895 & - 36. 8463 \\ 97.1013 & 47.7093 & - 4.0263 & 45.3657\end{matrix} ]$$

The foregoing are merely descriptions of preferred embodiments of the present disclosure, and are not intended to limit the protection scope of the present disclosure. Any modification, equivalent substitution, improvement, etc. within the spirit and principles of the present disclosure shall fall within the scope of protection of the present disclosure.

What is claimed is:

1. A method for calculating a control attainable set of a redundant drive system under a linear constraint, comprising following steps:
1) establishing an expression of a control attainable set of a redundant drive system under each pair of linear constraint control components as follows:
$$Φ = \{ v \vert v = B \cdot u , u = {( {u}_{1} , … , {u}_{m} )}^{T} , u ∈ Ω \} s . t {u}_{i min} \leq {u}_{i} \leq {u}_{i max} , i = 1 , L , m ( {u}_{k max} - {u}_{k min} ) {u}_{k + 1} + ( {u}_{k + 1 max} - {u}_{k + 1 min} ) {u}_{k} \leq {u}_{k + 1 max} {u}_{k max} - {u}_{k + 1 min} {u}_{k min} , k = 1 , 3 , … , 2 [ \frac{m}{2} ] - 1 \qquad ( 1 )$$
wherein [m/2] represents an integer part obtained by dividing m by 2, u represents a control vector, the u is denoted as u_{ELR}, u_{ELR}=(u₁ . . . , uₘ)^{T}, uᵢₘᵢₙ≤uᵢ≤uᵢₘₐₓ, i=1,L,m, (uₖₘₐₓ−uₖₘᵢₙ)uₖ₊₁+(uₖ₊₁ₘₐₓ−uₖ₊₁ₘᵢₙ)uₖ≤uₖ₊₁ₘₐₓuₖₘₐₓ−uₖ₊₁ₘᵢₙuₖₘᵢₙ, and k=1,3, . . . , 2[m/2]−1;
wherein an i^{th} control component uᵢ is a control action of a corresponding i^{th} actuator, wherein 1≤≤m, and m represents a quantity of actuators; uᵢₘᵢₙ represents a minimum constraint value of the control action of the i^{th} actuator, and uᵢₘₐₓ represents a maximum constraint value of the control action of the i^{th} actuator; Ω represents a control set, and Ω={u}; v represents a control attainable vector of the redundant drive system, and v=(v₁, v₂, v₃)^{T}, which represents a control output of the redundant drive system; Φ represents the control attainable set; and B represents a 3-row and m-column control efficiency matrix; and
the expression (1) is rewritten to a following expression (2):
$${Φ}_{ELR} = \{ v \vert v = B \cdot {u}_{ELR} , {u}_{ELR} = {( {u}_{1} , … , {u}_{m} )}^{T} , {u}_{ELR} ∈ {Ω}_{ELR} \} s . t . {u}_{i min} \leq {u}_{i} \leq {u}_{i max} , i = 1 , L , m ; ( {u}_{k max} - {u}_{k min} ) {u}_{k + 1} + ( {u}_{k + 1 max} - {u}_{k + 1 min} ) {u}_{k} \leq {u}_{k + 1 max} {u}_{k max} - {u}_{k + 1 min} {u}_{k min} , k = 1 , 3 , … , 2 [ \frac{m}{2} ] - 1 \qquad ( 2 )$$
wherein uₖ and uₖ₊₁ represent a pair of control components with a linear constraint, Φ_{ELR} represents a control attainable set of a redundant drive system with each pair of control components being linear constraint control components, Ω_{ELR} represents a control set, u_{ELR} represents a control vector, and Ω_{ELR}={u_{ELR}};
2) classifying all boundary surfaces of the control set Ω_{ELR} obtained in the step 1) into four types, which comprises:
using, as a vertex of the control set Ω_{ELR}, a point obtained by taking a corresponding maximum or minimum constraint value of each component uᵢ of the control vector u_{ELR}=(u₁, . . . , uₘ)^{T}, wherein the m-dimensional control set Ω_{ELR} represented in the expression (2) has
$${3}^{[ \frac{m}{2} ]} \cdot {2}^{( \frac{m}{2} )}$$
vertices, and (m/2) represents a remainder of dividing m by 2; and
setting ∂(Ω_{ELR}) to represent a boundary of the Ω_{ELR}, and classifying boundary surfaces of the ∂(Ω_{ELR}) into a type-rectangular boundary surface, a type-rectangular boundary surface, a type−=2\*ROMAN I rectangular boundary surface, and a triangular boundary surface based on a value of each component of each vertex, which specifically comprises:
assuming that four vertices of the rectangular boundary surface are denoted as A, B, D, and C in clockwise order, and three vertices of the triangular boundary surface are denoted as A, C, and B in clockwise order,
if any rectangular boundary surface satisfies following conditions: for the vertices A and B, one component has a different value, and other components have a same value; for the vertices A and C, one component of another pair of components has a different value, and other components have a same value; and for the vertices A and D, the above two components have different values, and other components have a same value, determining that the rectangular boundary surface is the type-rectangular boundary surface;
if any rectangular boundary surface satisfies following conditions: for the vertex A and the vertex B, one pair of linear constraint components have different values, and other components have a same value; for the vertex C and the vertex D, the one pair of linear constraint components have different values, and other components have a same value; and for the vertex A and the vertex C, the one pair of linear constraint components have a same value, and other components have a same value except that one of the other components has a different value, determining that the rectangular boundary surface is the type-rectangular boundary surface;
if any rectangular boundary surface satisfies following conditions: for the vertex A and the vertex B, one pair of linear constraint components have different values, and other components have a same value; for the vertex A and the vertex C, another pair of linear constraint components have different values, and other components have a same value; and for the vertex D and the vertex A, each of the above two pairs of linear constraint components has a different value, and other components have a same value, determining that the rectangular boundary surface is the type−=2\*ROMAN I rectangular boundary surface; and
if any right angle satisfies following conditions: for the vertex A and the vertex B, one pair of linear constraint components have different values, and other components have a same value; for the vertex A and the vertex C, one component of the one pair of linear constraint components has a different value, and other components have a same value; and for the vertex B and the vertex C, the other component of the one pair of linear constraint components has a different value, and other components have a same value, determining that the right angle is the triangular boundary surface;
3) dividing all the boundary surfaces of the control set Ω_{ELR} into Cₘ² groups, wherein
if values of two components in the u_{ELR} are between the corresponding minimum and maximum values, and values of other m−2 components are the corresponding minimum or maximum value, the m components form 2^{m-2} boundary surfaces of the control set; and
if any two components in the u_{ELR} are denoted as a p^{th} component and a q^{th} component, values of the p^{th} component and the q^{th} component are between the corresponding minimum and maximum values, 1≤p≤m, 1≤q≤m, p<q, values of other m−2 components are the corresponding minimum or maximum value, and a formed boundary surface is denoted as a p-q group, all the boundary surfaces of the control set are divided into the Cₘ² groups;
4) determining a key boundary surface for each of the Cₘ² groups in the step 3), wherein
a boundary surface of an image mapped onto the Φ_{ELR} in the Ω_{ELR} of a boundary ∂(Φ_{ELR}) is denoted as the key boundary surface, the Ω is denoted as a set of key boundary surfaces, the Ω is initialized as an empty set, and the step comprises following substeps:
4-1) selecting any group for which no key boundary surface has been determined, denoting the group as a current p-q group, and performing a step 4-2);
4-2) determining whether the p^{th} control component and the q^{th} control component are a pair of linear constraint components; and
if they are a pair of linear constraint components, performing a step 4-3);
if they are not a pair of linear constraint components, and m is an even number, performing a step 4-4);
if they are not a pair of linear constraint components, m is an odd number, and the p^{th} and q^{th} control components each have a paired linear constraint component, performing a step 4-4); or
if they are not a pair of linear constraint components, m is an odd number, and the q^{th} control component has no paired linear constraint component, performing a step 4-5);
4-3) when the p^{th} control component and the q^{th} control component are a pair of linear constraint components, determining a key boundary surface of the P-q group according to a following specific method:
4-3-1) when the p^{th} control component and the q^{th} control component are a pair of linear constraint components, determining that all boundary surfaces of the group are triangular boundary surfaces, wherein a value of each component of each point on the boundary surface satisfies a following formula:
$$\{ \begin{matrix}{u}_{p min} \leq {u}_{p} \leq {u}_{p max} \\ {u}_{q min} \leq {u}_{q} \leq \frac{{u}_{q max} {u}_{p max} - {u}_{q min} {u}_{p min} - ( {u}_{q max} - {u}_{q min} ) {u}_{p}}{( {u}_{p max} - {u}_{p min} )} \\ {u}_{i} ∈ \{ {u}_{i min} , {u}_{i max} \} , i ∈ {Z}^{+} , 1 \leq i \leq m , i \neq p , q\end{matrix} \qquad ( 3 )$$
wherein a vertex of each boundary surface in the group is represented by an m-row and 3-column matrix Δ, and 3 columns are vectors corresponding to 3 vertices; values of the p^{th} and q^{th} components of three vertices on each boundary surface are shown in p^{th} and q^{th} rows of the matrix Δ, while values of other components are all the uᵢₘₐₓ or the uᵢₘᵢₙ; one pair of linear constraint components in the other components do not simultaneously take a maximum constraint value corresponding to the one pair of linear constraint components; and the p^{th} row of the matrix Δ is (uₚₘₐₓ, uₚₘᵢₙ, uₚₘᵢₙ), and the q^{th} row is (u_{qmin}, u_{qmin}, u_{qmax});
$$Δ = [ \begin{matrix}… & … & … \\ {u}_{p max} & {u}_{p mi𝔫} & {u}_{p mi𝔫} \\ {u}_{q mi𝔫} & {u}_{q mi𝔫} & {u}_{q max} \\ … & … & …\end{matrix} ] ;$$
4-3-2) constructing a coordinate rotation transformation ¹T, such that a transformed coordinate axis v₁ is perpendicular to an image of the triangular boundary surface of the group, which specifically comprises:
setting
$${}^{1} T = [ \begin{matrix}{}^{1} {t}_{11} & {}^{1} {t}_{12} & {}^{1} {t}_{13} \\ {}^{1} {t}_{21} & {}^{1} {t}_{22} & {}^{1} {t}_{23} \\ {}^{1} {t}_{31} & {}^{1} {t}_{32} & {}^{1} {t}_{33}\end{matrix} ] , \\ B = [ \begin{matrix}{b}_{11} … {b}_{1 p} … {b}_{1 q} … {b}_{1 m} \\ {b}_{21} … {b}_{2 p} … {b}_{2 q} … {b}_{2 m} \\ {b}_{31} … {b}_{3 p} … {b}_{3 q} … {b}_{3 m}\end{matrix} ] , and \\ {}^{1} C = [ \begin{matrix}{}^{1} {c}_{11} … {}^{1} {c}_{1 p} … {}^{1} {c}_{1 q} … {}^{1} {c}_{1 m} \\ {}^{1} {c}_{21} … {}^{1} {c}_{2 p} … {}^{1} {c}_{2 q} … {}^{1} {c}_{2 m} \\ {}^{1} {c}_{31} … {}^{1} {c}_{3 p} … {}^{1} {c}_{3 q} … {}^{1} {c}_{3 m}\end{matrix} ] ,$$
wherein ¹cᵢⱼ represents an element of an i^{th} row and a j^{th} column of the matrix ¹C, ¹tᵢⱼ represents an element of an i^{th} row and a j^{th} column of the matrix ¹T, and bᵢⱼ represents an element of an i^{th} row and a j^{th} column of the matrix B;
setting ¹C=¹T·B, such that ¹c₁ₚ=0 and ¹c_{1q}=0;
substituting the ¹T and the B into the ¹C=¹T·B to obtain a following equation set:
$$\{ \begin{matrix}{\sum }_{s = 1}^{3} {}^{1} {t}_{1 s} \cdot {b}_{sp} = 0 \\ {\sum }_{s = 1}^{3} {}^{1} {t}_{1 s} \cdot {b}_{sq} = 0\end{matrix} \qquad ( 4 )$$
solving the linear equation set (4) to obtain a first row (¹t₁₁, ¹t₁₂, ¹t₁₃) of the ¹T; and
calculating a first row (¹c₁₁, . . . , ¹c₁ₘ) of the matrix ¹C according to the ¹C=¹T·B;
4-3-3) processing other rows than the rows p, q of the matrix according to a following rule, wherein a boundary surface represented by an obtained matrix is the key boundary surface and placed into the set Ω, and 1≤i≤m, i is an integer, i≠p, q; and
the rule is as follows:
when ¹c₁ᵢ·¹c₁ᵢ₊₁<0,
if ¹c₁ᵢ>0 and ¹c₁ᵢ₊₁<0, setting an i^{th} row of the matrix Δ to the uᵢₘₐₓ and an i+1^{th} row to u_{i+1 min}; or
if ¹c₁ᵢ<0 and ¹c₁ᵢ₊₁<0, setting an i^{th} row of the matrix Δ to the uᵢₘᵢₙ and an i+1^{th} row to uᵢ₊₁ₘₐₓ;
when ¹c₁ᵢ<0and ¹c₁ᵢ₊₁<0,
setting an i^{th} row of the matrix Δ to the uᵢₘᵢₙ and an i+1^{th} row to uᵢ₊₁ₘᵢₙ; or
when ¹c₁ᵢ>0 and ¹c₁ᵢ₊₁>0,
calculating ¹z₀₁=¹c₁ᵢ·uᵢₘₐₓ+¹c₁ᵢ₊₁·uᵢ₊₁ₘᵢₙ and ¹z₀₂=¹c₁ᵢ·uᵢₘᵢₙ+¹c₁ᵢ₊₁·uᵢ₊₁ₘₐₓ, and then performing determining as follows:
if ¹z₀₁>¹z₀₂, setting an i^{th} row of the matrix Δ to the uᵢₘₐₓ and an i+1^{th} row to uᵢ₊₁ₘᵢₙ; if ¹z₀₁<¹z₀₂ setting an i^{th} row of the matrix Δ to the uᵢₘᵢₙ and an i+1^{th} row to uᵢ₊₁ₘₐₓ; or if ¹z₀₁=¹z₀₂, setting an i^{th} row and an i+1^{th} row of the matrix Δ as follows: setting the i^{th} row of the matrix Δ to the uᵢₘₐₓ and the i+1^{th} row to uᵢ₊₁ₘᵢₙ; or setting the i^{th} row of the matrix Δ to the uᵢₘᵢₙ and the i+1^{th} row to uᵢ₊₁ₘₐₓ;
4-3-4) processing other rows than the rows p, q of the matrix Δ according to a following rule, where a boundary surface represented by an obtained matrix is the key boundary surface and placed into the set Ω; and then performing a step 4-6), wherein 1≤i≤m,i is an integer, i≠p, q; and
the rule is as follows:
when ¹c₁ᵢ·¹c₁ᵢ₊₁<0,
if ¹c₁ᵢ>0 and ¹c₁ᵢ₊₁<0, setting the i^{th} row of the matrix Δ to the uᵢₘᵢₙ and the i+1^{th} row to the uᵢ₊₁ₘₐₓ; or
if ¹c₁ᵢ<0 and ¹c₁ᵢ₊₁>0, setting the i^{th} row of the matrix Δ to the uᵢₘₐₓ and the i+1^{th} row to u_{i+1 min};
when ¹c₁ᵢ>0 and ¹c₁ᵢ₊₁>0,
setting the i^{th} row of the matrix Δ to the uᵢₘᵢₙ and the i+1^{th} row to the uᵢ₊₁ₘᵢₙ; or
when ¹c₁ᵢ<0 and ¹c₁ᵢ₊₁<0,
calculating ²z₀₁=¹c₁ᵢ·uᵢₘₐₓ+¹c₁ᵢ₊₁·uᵢ₊₁ₘᵢₙ and ²z₀₂=¹c₁ᵢ·uᵢₘᵢₙ+¹c₁ᵢ₊₁·uᵢ₊₁ₘₐₓ and performing determining as follows: if ²z₀₁>²z₀₂, setting the i^{th} row of the matrix Δ to the uᵢₘᵢₙ and the i+1^{th} row to the uᵢₘₐₓ; if ²z₀₁<²z₀₂, setting the i^{th} row of the matrix Δ to the uᵢₘₐₓ and the i+1^{th} row to the uᵢ₊₁ₘᵢₙ; or if ¹z₀₁=¹z₀₂, setting the i^{th} row and the i+1^{th} row of the matrix Δ as follows: setting the i^{th} row of the matrix Δ to the uᵢₘₐₓ and the i+1^{th} row to the uᵢ₊₁ₘᵢₙ; or setting the i^{th} row of the matrix Δ to the uᵢₘᵢₙ and the i+1^{th} row to the uᵢ₊₁ₘₐₓ;
4-4) when the p^{th} control component and the q^{th} control component are not a pair of linear constraint components, and each have the paired linear constraint component, determining a key boundary surface of the p-q group according to a following specific method:
4-4-1) denoting the component paired with the p^{th} component as a p component, and the component paired with the q^{th} component as a q′^{th} component, where the p-q group has three types of rectangular boundary surfaces, and each component of each point on the boundary surfaces of the group has a value that satisfies a following formula:
$$\{ \begin{matrix}{u}_{pmin} \leq {u}_{p} \leq {u}_{p max} \\ {u}_{qmin} \leq {u}_{q} \leq {u}_{q max} \\ {u}_{{p}^{′}} ∈ \{ {u}_{{p}^{′} min} , \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} \} \\ {u}_{q} ∈ \{ {u}_{{q}^{′} min} , \frac{{u}_{{q}^{′} max} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} \} \\ {u}_{i} ∈ \{ {u}_{i min} , {u}_{i max} \} , 1 \leq i \leq m , i \neq p , q , {p}^{′} , {q}^{′} \\ {u}_{k} + {u}_{k + 1} < {u}_{k max} + {u}_{k + 1 max} , k = 1 , 3 , … , 2 [ \frac{m}{2} ] - 1 , k \neq p , q , {p}^{′} , {q}^{′}\end{matrix} \qquad ( 5 )$$
when u_{p′}=u_{p′min} and u_{q′}=u_{q′min}, determining that a boundary surface formed by a point satisfying the formula (5) is the type-I rectangular boundary surface;
when u_{p′}=u_{p′min} and
$${u}_{{q}^{′}} = \frac{{u}_{{q}^{′} mαx} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$
determining that a boundary surface formed by a point satisfying the formula (5) is the type-II rectangular boundary surface;
when
$${u}_{{p}^{′}} = \frac{{u}_{{p}^{′} mαx} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )}$$
and u_{q′}=u_{q′min}, determining that a boundary surface formed by a point satisfying the formula (5) also is the type-II rectangular boundary surface;
when
$${u}_{{p}^{′}} = \frac{{u}_{{p}^{′} mαx} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} and \\ {u}_{{q}^{′}} = \frac{{u}_{{q}^{′} mαx} {u}_{q max} - {u}_{{q}^{′} min} {u}_{q min} - ( {u}_{{q}^{′} max} - {u}_{{q}^{′} min} ) {u}_{q}}{( {u}_{q max} - {u}_{q min} )} ,$$
determining that a boundary surface formed by a point satisfying the formula (5) is the type-III rectangular boundary surface; and
representing a vertex of each rectangular boundary surface of the group by using an m-row and 4-column matrix, wherein 4 columns respectively represent vectors corresponding to 4 vertices; a matrix Λ represents a vertex of one type-I rectangular boundary surface, a matrix ¹Π or ²Π represents a vertex of one type-II rectangular boundary surface, and a matrix T represents a vertex of one type-III rectangular boundary surface; values of the p^{th}, p′^{th}, q^{th}, and q′^{th} components of four vertices of each boundary surface are shown in a p^{th} row, a p′^{th} row, a q^{th} row, and a q′^{th} row of the matrix, and other components are all the uᵢₘₐₓ or the uᵢₘᵢₙ; one pair of linear inequality constraint components do not simultaneously take a maximum constraint value corresponding to the one pair of linear inequality constraint components; for the Λ, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min});
for the ¹Π, the p^{th} row is (uₚₘₐₓ, uₚₘᵢₙ, uₚₘᵢₙ, uₚₘₐₓ), the p′^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′min}, u_{q′min}, u_{q′min}, u_{q′min});
for the ²Π, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}, the q^{th} row is (u_{qmin}, u_{qmin}, u_{qmax}, u_{qmax}), and the q′^{th} row is (u_{q′max}, u_{q′max}, u_{q′min}, u_{q′min}); and
for the T, the p^{th} row is (uₚₘₐₓ, uₚₘᵢₙ, uₚₘᵢₙ, uₚₘₐₓ), the p′^{th} row is (u_{p′min}, u_{p′max}, u_{p′max}, u_{p′min}), the q^{th} row is (u_{qmin}, u_{qmin}, u_{qmax}, u_{qmax}), and the q′^{th} row is (u_{q′max}, u_{q′max}, u_{q′min}, u_{q′min});
$$Λ = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] , \\ {}^{1} Π = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} min} & {u}_{{q}^{′} min} & {u}_{{q}^{′} min} & {u}_{{q}^{′} min} \\ … & … & … & …\end{matrix} ] , \\ {}^{2} Π = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ] , \\ T = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max} \\ {u}_{{q}^{′} max} & {u}_{{q}^{′} max} & {u}_{{q}^{′} min} & {u}_{{q}^{′} min} \\ … & … & … & …\end{matrix} ] \qquad ( 6 )$$
wherein if P is an odd number, the p^{th} row comes before the p′^{th} row; if p is an even number, the p^{th} row comes after the p′^{th} row; if q is an odd number, the q^{th} row comes before the q′^{th} row; and if q is an even number, the q^{th} row comes after the q′^{th} row;
4-4-2) constructing a coordinate rotation transformation G, such that a transformed coordinate axis v₁ is perpendicular to an image of the type-III rectangular boundary surface, and images of all points on the boundary surface have equal coordinate values on the v₁ axis, which specifically comprises:
setting
$$G = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] , \\ B = [ \begin{matrix}{b}_{11} & … & {b}_{1 p} & {b}_{1 {p}^{′}} & … & {b}_{1 q} & {b}_{1 {q}^{′}} & … & {b}_{1 m} \\ {b}_{21} & … & {b}_{2 p} & {b}_{2 {p}^{′}} & … & {b}_{2 q} & {b}_{2 {q}^{′}} & … & {b}_{2 m} \\ {b}_{31} & … & {b}_{3 p} & {b}_{3 {p}^{′}} & … & {b}_{3 q} & {b}_{3 {q}^{′}} & … & {b}_{3 m}\end{matrix} ] , and \\ E = [ \begin{matrix}{e}_{11} & … & {e}_{1 p} & {e}_{1 {p}^{′}} & … & {e}_{1 q} & {e}_{1 {q}^{′}} & … & {e}_{1 m} \\ {e}_{21} & … & {e}_{2 p} & {e}_{2 {p}^{′}} & … & {e}_{2 q} & {e}_{2 {q}^{′}} & … & {e}_{2 m} \\ {e}_{31} & … & {e}_{3 p} & {e}_{3 {p}^{′}} & … & {e}_{3 q} & {e}_{3 {q}^{′}} & … & {e}_{3 m}\end{matrix} ] ,$$
wherein gᵢⱼ represents an element of an i^{th} row and a j^{th} column of the matrix G, and eᵢⱼ represents an element of an i^{th} row and a j^{th} column of the matrix E;
setting E=G·B, such that
$${e}_{1 {p}^{′}} = \frac{{u}_{p max} - {u}_{p min}}{{u}_{{p}^{′} max} - {u}_{{p}^{′} min}} {e}_{1 p} , \\ {e}_{1 {q}^{′}} = \frac{{u}_{q max} - {u}_{q min}}{{u}_{{q}^{′} max} - {u}_{{q}^{′} min}} {e}_{1 q} ;$$
and substituting the G and the B into the E=G·B to obtain a following equation set:
$$\{ \begin{matrix}{\sum }_{s = 1}^{3} {g}_{1 s} \cdot {b}_{sp} = {e}_{1 p} \\ {\sum }_{s = 1}^{3} {g}_{1 s} \cdot {b}_{{sp}^{′}} = \frac{{u}_{p max} - {u}_{p min}}{{u}_{{p}^{′} max} - {u}_{{p}^{′} min}} {e}_{1 p} \\ {\sum }_{s = 1}^{3} {g}_{1 s} \cdot {b}_{sq} = {e}_{1 q} \\ {\sum }_{s = 1}^{3} {g}_{1 s} \cdot {b}_{{sq}^{′}} = \frac{{u}_{q max} - {u}_{q min}}{{u}_{{q}^{′} max} - {u}_{{q}^{′} min}} {e}_{1 q}\end{matrix} \qquad ( 7 )$$
solving the linear equation set (7) to obtain a first row of the G, and calculating a first row (e₁₁, . . . , e₁ₘ) of the matrix E according to the E=G·B; and if e_{1p′}>0 and e_{1q′}>0, performing a step 4-4-3); if e_{1p′}<0 and e_{1q′}<0, performing a step 4-4-4); or if e_{1p′}·e_{1q′}<0, performing a step 4-4-5);
4-4-3) processing other rows than the rows p, q, p′, q′ of the matrix T according to a following rule, wherein a boundary surface represented by an obtained matrix is the key boundary surface and placed into the set Ω; and then performing the step 4-4-5), wherein i=1, . . . , m, i≠p, p′, q, q′; and
the rule is as follows:
when e₁ᵢ·e₁ᵢ₊₁<0,
if e₁ᵢ>0 and e₁ᵢ₋₁<0, setting an i^{th} row of the matrix T to the uᵢₘₐₓ and an i+1^{th} row to uᵢ₊₁ₘᵢₙ; or
if e₁ᵢ<0 and e₁ᵢ₊₁>0, setting an i^{th} row of the matrix T to the uᵢₘᵢₙ and an i+1^{th} row to uᵢ₊₁ₘₐₓ;
when e₁ᵢ<0 and e₁ᵢ₊₁<0 ^{(i=1, . . . , m,i≠p, p′,q,q′)},
setting an i^{th} row of the matrix T to the uᵢₘᵢₙ and an i+1^{th} row to uᵢ₊₁ₘᵢₙ; or
when e₁ᵢ>0 and e₁ᵢ₊₁>0,
calculating ¹d₀₁=e₁ᵢ·uᵢₘₐₓ+e₁ᵢ₊₁ₘᵢₙ and ¹d₀₂=e₁ᵢ·uᵢₘᵢₙ+e₁ᵢ₊₁ₘₐₓ, and performing determining as follows: if ¹d₀₁>¹d₀₂, setting an i^{th} row of the matrix T to the uᵢₘₐₓ and an i+1^{th} row to uᵢ₊₁ₘᵢₙ; if ¹d₀₁<¹d₀₂, setting an i^{th} row of the matrix T to the uᵢₘᵢₙ and an i+1^{th} row to uᵢ₊₁ₘₐₓ; or if ¹d₀₁=¹d₀₂, setting an i^{th} row and an i+1^{th} row of the matrix T as follows: setting the i^{th} row of the matrix T to the uᵢₘₐₓ and the i+1^{th} row to the uᵢ₊₁ₘᵢₙ; or setting the i^{th} row of the matrix T to the uᵢₘᵢₙ and the i+1^{th} row to the uᵢ₊₁ₘₐₓ;
4-4-4) processing other rows than the rows p, q, p′, q′ of the matrix T according to a following rule, where a boundary surface represented by an obtained matrix is the key boundary surface and placed into the set Ω; and then performing the step 4-4-5), where i=1, . . . , m, i≠p, p′, q, q′; and
the rule is as follows:
when e₁ᵢ·e₁ᵢ₊₁<0,
if e₁ᵢ>0 and e₁ᵢ₊₁<0, setting an i^{th} row of the matrix T to the uᵢₘᵢₙ and an i+1^{th} row to uᵢ₊₁ₘₐₓ; or
if e₁ᵢ<0 and e₁ᵢ₊₁>0, setting an i^{th} row of the matrix T to the uᵢₘₐₓ and an i+1^{th} row to uᵢ₊₁ₘᵢₙ;
when e₁ᵢ<0 and e₁ᵢ₊₁<0,
calculating ²d₀₁=²h₁ᵢ·uᵢₘₐₓ+²h₁ᵢ₊₁·+uᵢ₊₁ₘᵢₙ and ²d₀₂=²h₁ᵢ·uᵢₘᵢₙ+²h₁ᵢ₊₁·uᵢ₊₁ₘₐₓ and if ²d₀₁>²d₀₂, setting an i^{th} row of the matrix T to the uᵢₘᵢₙ and an i+1^{th} row to uᵢ₊₁ₘₐₓ; if ²d₀₁<²d₀₂, setting an i^{th} row of the matrix T to the uᵢₘₐₓ and an i+1^{th} row to uᵢ₊₁ₘᵢₙ; or if ²d₀₁=²d₀₂, setting an i^{th} row and an i+1^{th} row of the matrix T as follows: setting the i^{th} row of the matrix T to the uᵢₘₐₓ and the i+1^{th} row to uᵢ₊₁ₘᵢₙ; or setting the i^{th} row of the matrix T to the uᵢₘᵢₙ and the i+1^{th} row to uᵢ₊₁ₘₐₓ; or
when e₁ᵢ>0 and e₁ᵢ₊₁>0,
setting an i^{th} row of the matrix T to the uᵢₘᵢₙ and an i+1^{th} row to uᵢ₊₁ₘᵢₙ;
4-4-5) constructing a coordinate rotation transformation ²T, such that a transformed coordinate axis v₁ is perpendicular to an image of the type-I rectangular boundary surface of the group, which specifically includes:
setting
$${}^{2} T = [ \begin{matrix}{}_{}^{2} {t}_{11} & {}_{}^{2} {t}_{12} & {}_{}^{2} {t}_{13} \\ {}_{}^{2} {t}_{21} & {}_{}^{2} {t}_{22} & {}_{}^{2} {t}_{23} \\ {}_{}^{2} {t}_{31} & {}_{}^{2} {t}_{32} & {}_{}^{2} {t}_{33}\end{matrix} ] , B = [ \begin{matrix}{b}_{11} … {b}_{1 p} … {b}_{1 q} … {b}_{1 m} \\ {b}_{21} … {b}_{2 p} … {b}_{2 q} … {b}_{2 m} \\ {b}_{31} … {b}_{3 p} … {b}_{3 q} … {b}_{3 m}\end{matrix} ] , and$$
$${}^{2} C = [ \begin{matrix}{}_{}^{2} {c}_{11} … {}_{}^{2} {c}_{1 p} … {}_{}^{2} {c}_{1 q} … {}_{}^{2} {c}_{1 m} \\ {}_{}^{2} {c}_{21} … {}_{}^{2} {c}_{2 p} … {}_{}^{2} {c}_{2 q} … {}_{}^{2} {c}_{2 m} \\ {}_{}^{2} {c}_{31} … {}_{}^{2} {c}_{3 p} … {}_{}^{2} {c}_{3 q} … {}_{}^{2} {c}_{3 m}\end{matrix} ] ,$$
wherein ²Cᵢⱼ represents an element of an i^{th} row and a j^{th} column of the matrix ²C, and ²tᵢⱼ represents an element of an i^{th} row and a j^{th} column of the matrix ²T;
setting ²C=²T·B, such that ²c₁ₚ=0 and ²C_{1q}=0; and substituting the ²T and the B into the ²C=²T·B to obtain a following equation set:
$$\{ \begin{matrix}{\sum }_{s = 1}^{3} {}_{}^{2} {t}_{{1}_{2}} \cdot {b}_{sp} = 0 \\ {\sum }_{s = 1}^{3} {}_{}^{2} {t}_{{1}_{2}} \cdot {b}_{sq} = 0\end{matrix} \qquad ( 8 )$$
solving the linear equation set (8) to obtain a first row (²t₁₁, ²t₁₂, ²t₁₃) of the ²T, and calculating a first row (²C₁₁, . . . , ²C₁ₘ) of the matrix ²C according to the ²C=²T·B; and
if ²c_{1p′}<0 and ²C_{1q′}<0 performing a step 4-4-6); if ²c_{1p′}>0 and ²C_{1q′}>0, performing a step 4-4-7); or if ²c_{1p′}·²C_{1q′}<0, performing a step 4-4-8);
4-4-6) processing other rows than the rows p, q, p′, q′ of the matrix Λ according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-8); where
the rule is as follows:
when ²c₁ᵢ·²c₁ᵢ₊₁<0,
if ²c₁ᵢ>0 and ²c₁ᵢ₊₁<0 setting an i^{th} row of the matrix Λ to the uᵢₘₐₓ and an i+1^{th} row to uᵢ₊₁ₘᵢₙ; or
if ²c₁ᵢ<0 and ²c₁ᵢ₊₁>0, setting an i^{th} row of the matrix Λ to the uᵢₘᵢₙ and an i+1^{th} row to uᵢ₊₁ₘₐₓ;
when ²c₁ᵢ<0 and ²c₁ᵢ₊₁<0,
setting an i^{th} row of the matrix Λ to the uᵢₘᵢₙ and an i+1^{th} row to uᵢ₊₁ₘᵢₙ; or
when ²c₁ᵢ>0 and ²c₁ᵢ₊₁>0,
calculating ³d₀₁=²c₁ᵢ·uᵢₘₐₓ+²c₁ᵢ₊₁·uᵢ₊₁ₘᵢₙ, and ³d₀₂=²c₁ᵢ·uᵢₘᵢₙ+²c₁ᵢ₊₁·uᵢ₊₁ₘₐₓ; and if ³d₀₁>³d₀₂, setting an i^{th} row of the matrix Λ to the uᵢₘₐₓ and an i+1^{th} row to uᵢ₊₁ₘᵢₙ; if ³d₀₁<³d₀₂, setting an i^{th} row of the matrix Λ to the uᵢₘᵢₙ and an i+1^{th} row to uᵢ₊₁ₘₐₓ; or if ³d₀₁=³d₀₂, setting an i^{th} row and an i+1^{th} row of the matrix Λ as follows: setting the i^{th} row of the matrix Λ to the uᵢₘₐₓ and the i+1^{th} row to uᵢ₊₁ₘᵢₙ; or setting the i^{th} row of the matrix Λ to the uᵢₘᵢₙ and the i+1^{th} row to uᵢ₊₁ₘₐₓ;
4-4-7) processing other rows than the rows p, q, p′, q′ of the matrix according Λ to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-8); where
the rule is as follows:
when ²c₁ᵢ·²c₁ᵢ₊₁<0,
if ²c₁ᵢ>0 and ²c₁ᵢ₊₁<0, setting an i^{th} row of the matrix Λ to the uᵢₘᵢₙ and an i+1^{th} row to uᵢ₊₁ₘₐₓ; or
if ²c₁ᵢ<0 and ²c₁ᵢ₊₁>0 setting an i^{th} row of the matrix Λ to the uᵢₘₐₓ and an i+1^{th} row to uᵢ₊₁ₘᵢₙ;
when ²c₁ᵢ<0 and ²c₁ᵢ₊₁<0,
calculating ⁴d₀₁=²c₁ᵢ·uᵢₘₐₓ+²c₁ᵢ₊₁·uᵢ₊₁ₘᵢₙ and ⁴d₀₂=²c₁ᵢ·uᵢₘᵢₙ+²c₁ᵢ₊₁·uᵢ₊₁ₘₐₓ; and if ⁴d₀₁>⁴d₀₂, setting an i^{th} row of the matrix Λ to the uᵢₘᵢₙ and an i+1^{th} row to uᵢ₊₁ₘₐₓ; if ⁴d₀₁<⁴d₀₂, setting an i^{th} row of the matrix Λ to the uᵢₘₐₓ and an i+1^{th} row to uᵢ₊₁ₘᵢₙ; or if ⁴d₀₁=⁴d₀₂, setting an i^{th} row and an i+1^{th} row of the matrix Λ as follows: setting the i^{th} row of the matrix Λ to the uᵢₘₐₓ and the i+1^{th} row to uᵢ₊₁ₘᵢₙ; or setting the i^{th} row of the matrix Λ to the uᵢₘᵢₙ and the i+1^{th} row to uᵢ₊₁ₘₐₓ; or
when ²c₁ᵢ>0 and ²c₁ᵢ₊₁>0,
setting an i^{th} row of the matrix Λ to the uᵢₘᵢₙ and an i+1^{th} row to u_{i+1 min};
4-4-8) constructing a coordinate rotation transformation ¹F, such that a transformed coordinate axis v₁ is Perpendicular to an Image of a Boundary Surface Whose Vertex Matrix is the ¹Π in the group, and images of all points on the boundary surface have equal coordinate values on the v₁ axis, which specifically includes:
setting
$${}^{1} F = [ \begin{matrix}{}_{}^{1} {f}_{11} & {}_{}^{1} {f}_{12} & {}_{}^{1} {f}_{13} \\ {}_{}^{1} {f}_{21} & {}_{}^{1} {f}_{22} & {}_{}^{1} {f}_{23} \\ {}_{}^{1} {f}_{31} & {}_{}^{1} {f}_{32} & {}_{}^{1} {f}_{33}\end{matrix} ] , B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] , and$$
$${}^{1} H = [ \begin{matrix}{}^{1} {h}_{11} & … & {}^{1} {h}_{1 p} & {}^{1} {h}_{1 {p}^{′}} & … & {}^{1} {h}_{1 q} & … & {}^{1} {h}_{1 m} \\ {}^{1} {h}_{21} & … & {}^{1} {h}_{2 p} & {}^{1} {h}_{2 {p}^{′}} & … & {}^{1} {h}_{2 q} & … & {}^{1} {h}_{2 m} \\ {}^{1} {h}_{31} & … & {}^{1} {h}_{3 p} & {}^{1} {h}_{3 {p}^{′}} & … & {}^{1} {h}_{3 q} & … & {}^{1} {h}_{3 m}\end{matrix} ] ,$$
wherein ¹fᵢⱼ represents an element of an i^{th} row and a j^{th} column of the matrix ¹F, and ¹hᵢⱼ represents an element of an i^{th} row and a j^{th} column of the matrix ¹H;
setting ¹H=¹F·B, such that
$${}^{1} {h}_{1 {p}^{′}} = \frac{{u}_{p max} - {u}_{p min}}{{u}_{{p}^{′} max} - {u}_{{p}^{′} min}} {}^{1} {h}_{1 p}$$
and ¹_{1q}=0; and substituting the ¹F and the B into the ¹H= ¹F·B to obtain a following equation set:
$$\{ \begin{matrix}{\sum }_{s = 1}^{3} {}_{}^{1} {f}_{1 s} \cdot {b}_{sp} = {}^{1} {h}_{1 p} \\ {\sum }_{s = 1}^{3} {}_{}^{1} {f}_{1 s} \cdot {b}_{{sp}^{′}} = \frac{{u}_{p max} - {u}_{p min}}{{u}_{{p}^{′} max} - {u}_{{p}^{′} min}} {}^{1} {h}_{1 p}^{} \\ {\sum }_{s = 1}^{3} {}_{}^{1} {f}_{1 s} \cdot {b}_{sq} = 0\end{matrix} \qquad ( 9 )$$
solving the linear equation set (9) to obtain a first row of the ¹F, and calculating a first row (¹h₁₁, . . . , ¹h₁ₘ) of the matrix ¹H according to the ¹H=¹F·B; and
if ¹h_{1p′}>0 ¹h_{1q′}<0, performing a step 4-4-9); if ¹h_{1p′}<0 and ¹h_{1q′}>0, performing a step 4-4-10); or if ¹h_{1p′}·¹h_{1q′}>0, performing a step 4-4-11);
4-4-9) processing other rows than the rows p, q, P′, q′ of the matrix ¹Π according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-11); wherein
the rule is as follows:
when ¹h₁ᵢ·¹h₁ᵢ₊₁<0,
if ¹h₁ᵢ>0 and ¹h₁ᵢ₊₁<0, setting an i^{th} row of the matrix ¹Π to the uᵢₘₐₓ and an i+1^{th} row to uᵢ₊₁ₘᵢₙ; or
if ¹h₁ᵢ<0 and ¹h₁ᵢ₊₁>0, setting an i^{th} row of the matrix ¹Π to the uᵢₘᵢₙ and an i+1^{th} row to uᵢ₊₁ₘₐₓ;
when ¹h₁ᵢ<0 and ¹h₁ᵢ₊₁<0,
setting an i^{th} row of the matrix ¹Π to the uᵢₘᵢₙ and an i+1^{th} row to uᵢ₊₁ₘᵢₙ; or
when ¹h₁ᵢ>0 and ¹h₁ᵢ₊₁>0,
calculating ⁵d₀₁=¹h₁ᵢ·uᵢₘₐₓ+¹h₁ᵢ₊₁·uᵢ₊₁ₘᵢₙ and ⁵d₀₂=¹h₁ᵢ·uᵢₘᵢₙ+¹h₁ᵢ₊₁·uᵢ₊₁ₘₐₓ; and if ⁵d₀₁>⁵d₀₂, setting an i^{th} row of the matrix ¹Π to the uᵢₘₐₓ and an i+1^{th} row to uᵢ₊₁ₘᵢₙ; if ⁵d₀₁<⁵d₀₂, setting an i^{th} row of the matrix ¹Π to the uᵢₘᵢₙ and an i+1^{th} row to uᵢ₊₁ₘₐₓ; or if ⁵d₀₁=⁵d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and the i+1^{th} row to uᵢ₊₁ₘₐₓ;
4-4-10) processing other rows than the rows p, q, p′, q′ of the matrix ¹Π according to a following rule, where a boundary surface represented by an obtained matrix is the key boundary surface and placed into the set Ω, and i=1, . . . , m, i≠p, p′, q, q′; and then performing determining as follows:
if two key boundary surfaces have been found for the group, performing a step 4-6); otherwise, performing the step 4-4-11); where
the rule is as follows:
when ¹h₁ᵢ·¹h₁ᵢ₊₁<0,
if ¹h₁ᵢ>0 and ¹h₁ᵢ₊₁<0, setting an i^{th} row of the matrix ¹Π to the uᵢₘᵢₙ and an i+1^{th} row to uᵢ₊₁ₘₐₓ; or
if ¹h₁ᵢ<0 and ¹h₁ᵢ₊₁>0, setting an i^{th} row of the matrix ¹Π to the uᵢₘₐₓ and an i+1^{th} row to uᵢ₊₁ₘᵢₙ;
when ¹h₁ᵢ>0 and ¹h₁ᵢ₊₁>0,
setting an i^{th} row of the matrix ¹Π to the uᵢₘᵢₙ and an i+1^{th} row to uᵢ₊₁ₘᵢₙ; or
when ¹h₁ᵢ<0 and ¹h₁ᵢ₊₁<0,
calculating ⁶d₀₁=¹h₁ᵢ·uᵢₘₐₓ+¹h₁ᵢ₊₁·uᵢ₊₁ₘᵢₙ and ⁶d₀₂=¹h₁ᵢ·uᵢₘᵢₙ+¹h₁ᵢ₊₁·uᵢ₊₁ₘₐₓ; and if ⁶d₀₁>⁶d₀₂, setting an i^{th} row of the matrix ¹Π to the uᵢₘᵢₙ and an i+1^{th} row to uᵢ₊₁ₘₐₓ; if ⁶d₀₁<⁶d₀₂, setting an i^{th} row of the matrix ¹Π to the uᵢₘₐₓ and an i+1^{th} row to uᵢ₊₁ₘᵢₙ; or if ⁶d₀₁=⁶d₀₂, setting an i^{th} row and an i+1^{th} row of the matrix ¹Π as follows: setting the i^{th} row of the matrix ¹Π to the uᵢₘₐₓ and the i+1^{th} row to uᵢ₊₁ₘᵢₙ; or setting the i^{th} row of the matrix ¹Π to the uᵢₘᵢₙ and the i+1^{th} row to uᵢ₊₁ₘₐₓ;
4-4-11) constructing a coordinate rotation transformation ²F, such that a transformed coordinate axis v₁ is perpendicular to an image of a boundary surface whose vertex matrix is the ²Π in the group, and images of all points on the boundary surface have equal coordinate values on the v₁ axis, which specifically includes:
setting
$${}^{2} F = [ \begin{matrix}{}_{}^{2} {f}_{11} & {}_{}^{2} {f}_{12} & {}_{}^{2} {f}_{13} \\ {}_{}^{2} {f}_{21} & {}_{}^{2} {f}_{22} & {}_{}^{2} {f}_{23} \\ {}_{}^{2} {f}_{31} & {}_{}^{2} {f}_{32} & {}_{}^{2} {f}_{33}\end{matrix} ] , B = [ \begin{matrix}{b}_{11} & … & {b}_{1 p} & {b}_{1 {p}^{′}} & … & {b}_{1 q} & … & {b}_{1 m} \\ {b}_{21} & … & {b}_{2 p} & {b}_{2 {p}^{′}} & … & {b}_{2 q} & … & {b}_{2 m} \\ {b}_{31} & … & {b}_{3 p} & {b}_{3 {p}^{′}} & … & {b}_{3 q} & … & {b}_{3 m}\end{matrix} ] , and$$
$${}^{2} H = [ \begin{matrix}{}^{2} {h}_{11} & … & {}^{2} {h}_{1 p} & {}^{2} {h}_{1 q} & … & {}^{2} {h}_{1 {q}^{′}} & … & {}^{2} {h}_{1 m} \\ {}^{2} {h}_{21} & … & {}^{2} {h}_{2 p} & {}^{2} {h}_{2 q} & … & {}^{2} {h}_{2 {q}^{′}} & … & {}^{2} {h}_{2 m} \\ {}^{2} {h}_{31} & … & {}^{2} {h}_{3 p} & {}^{2} {h}_{3 q} & … & {}^{2} {h}_{3 {q}^{′}} & … & {}^{2} {h}_{3 m}\end{matrix} ] ,$$
where ²fᵢⱼ represents an element of an i^{th} row and a j^{th} column of the matrix ²F, and ²hᵢⱼ represents an element of an i^{th} row and a j^{th} column of the matrix ²H;
setting ²H=²F·B, such that
$${}^{2} {h}_{1 {q}^{′}}^{} = \frac{{u}_{q max} - {u}_{q min}}{{u}_{{q}^{′} max} - {u}_{{q}^{′} min}} {}^{2} {h}_{1 q}^{}$$
and ²h₁ₚ=0 and substituting the ²F and the B into the ²H=²F·B to obtain a following equation set:
$$\{ \begin{matrix}{\sum }_{s = 1}^{3} {}_{}^{2} {f}_{1 s} \cdot {b}_{sp} = 0 \\ {\sum }_{s = 1}^{3} {}_{}^{2} {f}_{1 s} \cdot {b}_{sq} = {}^{2} {h}_{1 q}^{} \\ {\sum }_{s = 1}^{3} {}_{}^{2} {f}_{1 s} \cdot {b}_{{sq}^{′}} = \frac{{u}_{q max} - {u}_{q min}}{{u}_{{q}^{′} max} - {u}_{{q}^{′} min}} {}^{2} {h}_{1 q}^{}\end{matrix} \qquad ( 10 )$$
solving the linear equation set (10) to obtain a first row of the ²F, and calculating a first row (²h₁₁, . . . , ²h₁ₘ) of the matrix ²H according to the ²H=²F·B; and if ²h_{1p′}<0 and ²h_{1q′}>0, performing a step 4-4-12); if ²h_{1p′}>0 and ²h_{1q′}<0 and, performing a step 4-4-13); or if ² h_{1p′}·²h_{1q′}>0, performing a step 4-6);
4-4-12) processing other rows than the rows p, q, p′, q′ of the matrix ²Π according to a following rule, where a boundary surface represented by an obtained matrix is the key boundary surface and placed into the set Ω, and i=1, . . . , m, i≠p, p′, q, q′; and then performing the step 4-6), where
the rule is as follows:
when ²h₁ᵢ·²h₁ᵢ₊₁<0,
if ²h₁ᵢ>0 and ²h₁ᵢ₊₁<0, setting an i^{th} row of the matrix ²Π to the uᵢₘₐₓ and an i+1^{th} row to uᵢ₊₁ₘᵢₙ; or
if ²h₁ᵢ<0 and ²h₁ᵢ₊₁>0, setting an i^{th} row of the matrix ²Π to the uᵢₘᵢₙ and an i+1^{th} row to uᵢ₊₁ₘₐₓ;
when ²h₁ᵢ<0 and ²h₁ᵢ₊₁<0,
setting an i^{th} row of the matrix ²Π to the uᵢₘᵢₙ and an i+1^{th} row to uᵢ₊₁ₘᵢₙ; or
when ²h₁ᵢ>0 and ²h₁ᵢ₊₁>0,
calculating ⁷d₀₁=²h₁ᵢ·uᵢₘₐₓ+²h₁ᵢ₊₁·uᵢ₊₁ₘᵢₙ and ⁷d₀₂=²h₁ᵢ·uᵢₘᵢₙ+²h₁ᵢ₊₁·uᵢ₊₁ₘₐₓ; and if ⁷d₀₁>⁷d₀₂, setting an i^{th} row of the matrix ²Π to the uᵢₘₐₓ and an i+1^{th} row to uᵢ₊₁ₘᵢₙ; if ⁷d₀₁<⁷d₀₂, setting an i^{th} row of the matrix ²Π to the uᵢₘᵢₙ and an i+1^{th} row to uᵢ₊₁ₘₐₓ; or if ⁷d₀₁=⁷d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and the i+1^{th} row to uᵢ₊₁ₘₐₓ;
4-4-13) processing other rows than the rows p, q, p′, q′ of the matrix ²Π according to a following rule, where a boundary surface represented by an obtained matrix is the key boundary surface and placed into the set Ω, and i=1, . . . , m, i≠p, p′, q, q′; and then performing the step 4-6), where
the rule is as follows:
when ²h₁ᵢ·²h₁ᵢ₊₁<0,
if ²h₁ᵢ>0 and ²h₁ᵢ₊₁<0, setting an i^{th} row of the matrix ²Π to the uᵢₘᵢₙ and an i+1^{th} row to uᵢ₊₁ₘₐₓ; or
if ²h₁ᵢ<0 and ²h₁ᵢ₊₁>0, setting an i^{th} row of the matrix ²Π to the uᵢₘₐₓ and an i+1^{th} row to uᵢ₊₁ₘᵢₙ;
when ²h₁ᵢ<0 and ²h₁ᵢ₊₁<0,
calculating ⁸d₀₁=²h₁ᵢ·uᵢₘₐₓ+²h₁ᵢ₊₁·uᵢ₊₁ₘᵢₙ and ⁸d₀₂=²h₁ᵢ·uᵢₘᵢₙ+²h₁ᵢ₊₁·uᵢ₊₁ₘₐₓ; and if ⁸d₀₁>⁸d₀₂, setting an i^{th} row of the matrix ²Π to the uᵢₘᵢₙ and an i+1^{th} row to uᵢ₊₁ₘₐₓ; if ⁸d₀₁<⁸d₀₂, setting an i^{th} row of the matrix ²Π to the uᵢₘₐₓ and an i+1^{th} row to uᵢ₊₁ₘᵢₙ; or if ⁸d₀₁=⁸d₀₂, setting an i^{th} row and an i+1^{th} row of the matrix ²Π as follows: setting the i^{th} row of the matrix ²Π to the uᵢₘₐₓ and the i+1^{th} row to uᵢ₊₁ₘᵢₙ; or setting the i^{th} row of the matrix ²Π to the uᵢₘᵢₙ and the i+1^{th} row to uᵢ₊₁ₘₐₓ; or
when ²h₁ᵢ>0 and ²h₁ᵢ₊₁>0,
setting an i^{th} row of the matrix ²Π to the uᵢₘᵢₙ and an i+1^{th} row to uᵢ₊₁ₘᵢₙ;
4-5) when the p^{th} control component and the q^{th} control component are not a pair of linear constraint components, and the q^{th} control component has no paired linear constraint component, determining a key boundary surface of the p-q group according to a following specific method:
4-5-1) denoting a component paired with the p^{th} component as a p′^{th} component, wherein the p-q group contains both the type-I and the type-II rectangular boundary surfaces, and each component of each point on the boundary surfaces of the group has a value that satisfies a following formula (11):
$$\{ \begin{matrix}{u}_{p min} \leq {u}_{p} \leq {u}_{p max} \\ {u}_{q min} \leq {u}_{q} \leq {u}_{q max} \\ {u}_{{p}^{′}} ∈ \{ {u}_{{p}^{′} min} , \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} \} \\ {u}_{i} ∈ \{ {u}_{i min} , {u}_{i max} \} , 1 \leq i < m , i \neq p , q , {p}^{′} \\ {u}_{k} + {u}_{k + 1} < {u}_{k max} + {u}_{k + 1 max} , k = 1 , 3 , … , 2 [ \frac{m}{2} ] - 1 , k \neq p , 1 , {p}^{′}\end{matrix} \qquad ( 11 )$$
when u_{p′}=u_{p′min} determining that a boundary surface formed by a point satisfying the formula (11) is the type-I rectangular boundary surface; or when
$${u}_{{p}^{′}} = \frac{{u}_{{p}^{′} max} {u}_{p max} - {u}_{{p}^{′} min} {u}_{p min} - ( {u}_{{p}^{′} max} - {u}_{{p}^{′} min} ) {u}_{p}}{( {u}_{p max} - {u}_{p min} )} ,$$
determining that a boundary surface formed by a point satisfying the formula (11) is the type-II rectangular boundary surface;
representing a vertex of each rectangular boundary surface of the group by using an m-row and 4-column matrix, where 4 columns respectively represent vectors corresponding to 4 vertices; a matrix Λ′ is used to represent a vertex of one type-I rectangular boundary surface, and a matrix Π′ represents a vertex of one type-II rectangular boundary surface; values of the p^{th}, p′^{th}, and q^{th} components of four vertices of each boundary surface are shown in a p^{th} row, a p′^{th} row, and a q^{th} row of the matrix, and other components are all uᵢₘₐₓ or uᵢₘᵢₙ; one pair of linear inequality constraint components do not simultaneously take a maximum constraint value corresponding to the one pair of linear inequality constraint components; and for the Λ′, the p^{th} row is (uₚₘₐₓ, uₚₘᵢₙ, uₚₘᵢₙ, uₚₘₐₓ), the p′^{th} row is (u_{p′min}, u_{p′min}, u_{p′min}, u_{p′min}) the q^{th} row is (u_{qmin}, u_{qmin}, u_{qmax}, u_{qmax}), and the q′^{th} row is (u_{q′min}, u_{q′min}, u_{q′min}, u_{q′min});
$${Λ}^{′} = [ \begin{matrix}… & … & … & … \\ {u}_{p max} & {u}_{p min} & {u}_{p min} & {u}_{p max} \\ {u}_{{p}^{′} min} & {u}_{{p}^{′} min} & {u}_{{p}^{′} min} & {u}_{{p}^{′} min} \\ … & … & … & … \\ {u}_{q min} & {u}_{q min} & {u}_{q max} & {u}_{q max}\end{matrix} ] ,$$
$${Π}^{′} = [ \begin{matrix}… & … & … & … \\ {u}_{p max} & {u}_{p min} & {u}_{p min} & {u}_{p max} \\ {u}_{{p}^{′} min} & {u}_{{p}^{′} max} & {u}_{{p}^{′} max} & {u}_{{p}^{′} min} \\ … & … & … & … \\ {u}_{q min} & {u}_{q min} & {u}_{q max} & {u}_{q max}\end{matrix} ]$$
in the matrices shown in the above formula, if p is an odd number, the p^{th} row comes before the p′^{th} row; or if p is an even number, the p^{th} row comes after the p′^{th} row;
4-5-2) constructing a coordinate rotation transformation T, such that a transformed coordinate axis v₁ is perpendicular to an image of the type-I rectangular boundary surface of the group, which specifically includes:
setting
$${}^{3} T = [ \begin{matrix}{}_{}^{3} {t}_{11} & {}_{}^{3} {t}_{12} & {}_{}^{3} {t}_{13} \\ {}_{}^{3} {t}_{21} & {}_{}^{3} {t}_{22} & {}_{}^{3} {t}_{23} \\ {}_{}^{3} {t}_{31} & {}_{}^{3} {t}_{32} & {}_{}^{3} {t}_{33}\end{matrix} ] , B = [ \begin{matrix}{b}_{11} … {b}_{1 p} … {b}_{1 q} \\ {b}_{21} … {b}_{2 p} … {b}_{2 q} \\ {b}_{31} … {b}_{3 p} … {b}_{3 q}\end{matrix} ] , and$$
$${}^{3} C = [ \begin{matrix}{}_{}^{3} {c}_{11} … {}_{}^{3} {c}_{1 p} … {}_{}^{3} {c}_{1 q} \\ {}_{}^{3} {c}_{21} … {}_{}^{3} {c}_{2 p} … {}_{}^{3} {c}_{2 q} \\ {}_{}^{3} {c}_{31} … {}_{}^{3} {c}_{3 p} … {}_{}^{3} {c}_{3 q}\end{matrix} ] ,$$
wherein ³tᵢⱼ represents an element of an i^{th} row and a j^{th} column of the matrix ³T, and ³cᵢⱼ represents an element of an i^{th} row and a j^{th} column of the matrix ³C;
setting ³C=³T·B, such that ³c₁ₚ=0 and ³c_{1q}=0; and substituting the ³T and the B into the ³C=³T·B to obtain a following equation set:
$$\{ \begin{matrix}{\sum }_{s = 1}^{3} {}_{}^{3} {t}_{1 s} \cdot {b}_{sp} = 0 \\ {\sum }_{s = 1}^{3} {}_{}^{3} {t}_{1 s} \cdot {b}_{sq} = 0\end{matrix} \qquad ( 12 )$$
solving the linear equation set (12) to obtain a first row (³t₁₁, ³t₁₂, ³t₁₃) of the ³T, and calculating a first row (³c₁₁, . . . , ³c₁ₘ) of the matrix ³C according to the ³C=3T·B; and if ³ c_{1p′}<0, performing a step 4-5-3); or if ³c_{1p′}>0, performing a step 4-5-4);
4-5-3) processing other rows than the rows p, q, p′ of the matrix Λ′ according to a following rule, where a boundary surface represented by an obtained matrix is the key boundary surface and placed into the set Ω; and then performing a step 4-5-5), where i=1, . . . , m, i≠p, p′, q; and
the rule is as follows:
when ³c₁ᵢ·³h₁ᵢ₊₁<0,
if ³c₁ᵢ>0 and ³c₁ᵢ₊₁<0, setting an i^{th} row of the matrix Π′ to the uᵢₘₐₓ and an i+1^{th} row to uᵢ₊₁ₘᵢₙ; or
if ³c₁ᵢ<0 and ³h₁ᵢ₊₁>0, setting an i^{th} row of the matrix Π′ to the uᵢₘᵢₙ and an i+1^{th} row to uᵢ₊₁ₘₐₓ;
when ³c₁ᵢ<0 and ³c₁ᵢ₊₁<0,
setting an i^{th} row of the matrix Π′ to the uᵢₘᵢₙ and an i+1^{th} row to uᵢ₊₁ₘᵢₙ; or
when ³c₁ᵢ>0 and ³h₁ᵢ₊₁>0,
calculating ⁹d₀₁=³c₁ᵢ·uᵢₘₐₓ+³c₁ᵢ₊₁·uᵢ₊₁ₘᵢₙ, and ⁹d₀₂=³c₁ᵢ·uᵢₘᵢₙ+³c₁ᵢ₊₁·uᵢ₊₁ₘₐₓ; and performing determining as follows:
if ⁹d₀₁>⁹d₀₂, setting an i^{th} row of the matrix Λ′ to the uᵢₘₐₓ and an i+1^{th} row to uᵢ₊₁ₘᵢₙ; if ⁹d₀₁<⁹d₀₂, setting an i^{th} row of the matrix Λ′ to the uᵢₘᵢₙ and an i+1^{th} row to uᵢ₊₁ₘₐₓ; or if ⁹d₀₁=⁹d₀₂, setting an i^{th} row and an i+1^{th} row of the matrix Λ′ as follows: setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘᵢₙ and the i+1^{th} row to uᵢ₊₁ₘₐₓ;
4-5-4) processing other rows than the rows p, q, p′ of the matrix Λ′ according to a following rule, where a boundary surface represented by an obtained matrix is the key boundary surface and placed into the set Ω; and then performing a step 4-5-5), where i=1, . . . , m, i≠p, p′, q; and
the rule is as follows:
when ³c₁ᵢ·³h₁ᵢ₊₁<0,
if ³c₁ᵢ>0 and ³c₁ᵢ₊₁<0, setting an i^{th} row of the matrix Λ′ to the uᵢₘᵢₙ and an i+1^{th} row to uᵢ₊₁ₘₐₓ; or
if ³c₁ᵢ<0 and ³h₁ᵢ₊₁>0, setting an i^{th} row of the matrix Λ′ to the uᵢₘₐₓ and an i+1^{th} row to uᵢ₊₁ₘᵢₙ;
when ³c₁ᵢ>0 and ³c₁ᵢ₊₁>0,
setting an i^{th} row of the matrix Λ′ to the uᵢₘᵢₙ and an i+1^{th} row to uᵢ₊₁ₘᵢₙ; or
when ³c₁ᵢ<0 and ³h₁ᵢ₊₁<0,
calculating ¹⁰d₀₁=³c₁ᵢ·uᵢₘₐₓ+³c₁ᵢ₊₁·uᵢ₊₁ₘᵢₙ, and ¹⁰d₀₂=³c₁ᵢ·uᵢₘᵢₙ+³c₁ᵢ₊₁·uᵢ₊₁ₘₐₓ; and if ¹⁰d₀₁>¹⁰d₀₂, setting an i^{th} row of the matrix Λ′ to the uᵢₘᵢₙ and an i+1^{th} row to uᵢ₊₁ₘₐₓ; if ¹⁰d₀₁<¹⁰d₀₂, setting an i^{th} row of the matrix Λ′ to the uᵢₘₐₓ and an i+1^{th} row to uᵢ₊₁ₘᵢₙ; or if ¹⁰d₀₁=¹⁰d₀₂, setting an i^{th} row and an i+1^{th} row of the matrix Λ′ as follows: setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘₐₓ and the i+1^{th} row to uᵢ₊₁ₘᵢₙ; or setting the i^{th} row of the matrix Λ′ to the uᵢₘᵢₙ and the i+1^{th} row to uᵢ₊₁ₘₐₓ;
4-5-5) constructing a coordinate rotation transformation ³F, such that a transformed coordinate axis v₁ is perpendicular to an image of a boundary surface whose vertex matrix is the Π′ in the group, and images of all points on the boundary surface have equal coordinate values on the v₁ axis, which specifically includes:
setting
$${}^{3} F = [ \begin{matrix}{}_{}^{3} {f}_{11} & {}_{}^{3} {f}_{12} & {}_{}^{3} {f}_{13} \\ {}_{}^{3} {f}_{21} & {}_{}^{3} {f}_{22} & {}_{}^{3} {f}_{23} \\ {}_{}^{3} {f}_{31} & {}_{}^{3} {f}_{32} & {}_{}^{3} {f}_{33}\end{matrix} ] , B = [ \begin{matrix}{b}_{11} & … & {b}_{1 p} & {b}_{1 {p}^{′}} & … & {b}_{1 q} \\ {b}_{21} & … & {b}_{2 p} & {b}_{2 {p}^{′}} & … & {b}_{2 q} \\ {b}_{31} & … & {b}_{3 p} & {b}_{3 {p}^{′}} & … & {b}_{3 q}\end{matrix} ] , and$$
$${}^{3} H = [ \begin{matrix}{}^{3} {h}_{11} & … & {3}^{} {h}_{1 p} & {}^{3} {h}_{1 {p}^{′}} & … & {}^{3} {h}_{1 q} \\ {}^{3} {h}_{21} & … & {}^{3} {h}_{2 p} & {}^{3} {h}_{2 {p}^{′}} & … & {}^{3} {h}_{2 q} \\ {}^{3} {h}_{31} & … & {}^{3} {h}_{3 p} & {}^{3} {h}_{3 {p}^{′}} & … & {}^{3} {h}_{3 q}\end{matrix} ] ,$$
wherein ³hᵢⱼ represents an element of an i^{th} row and a j^{th} column of the matrix ³H, and ³fᵢⱼ represents an element of an i^{th} row and a j^{th} column of the matrix ³F;
setting ³H=³F·B, such that ³h_{1p′}=uₚₘₐₓ−uₚₘᵢₙ/u_{p′max}−u_{p′min} ³h₁ₚ, and ³h_{1q}=0; and substituting the ³F and the B into the ³H=³F·B to obtain a following equation set:
$$\{ \begin{matrix}{\sum }_{s = 1}^{3} {}_{}^{3} {f}_{1 s} \cdot {b}_{sp} = {}^{3} {h}_{1 p} \\ {\sum }_{s = 1}^{3} {}_{}^{3} {f}_{1 s} \cdot {b}_{{sp}^{′}} = \frac{{u}_{p max} - {u}_{p min}}{{u}_{{p}^{′} max} - {u}_{{p}^{′} min}} {}^{3} {h}_{1 p}^{} \\ {\sum }_{s = 1}^{3} {}_{}^{3} {f}_{1 s} \cdot {b}_{sq} = 0\end{matrix} \qquad ( 13 )$$
solving the linear equation set (13) to obtain a first row of the ³F, and calculating a first row (³h₁₁, . . . , ³h₁ₘ) of the matrix ³H according to the ³H=³F·B; and if ³h_{1p′}>0, performing a step 4-5-6); or if ³h_{1p′}<0, performing a step 4-5-7);
4-5-6) processing other rows than the rows p, q, p′ of the matrix Π′ according to a following rule, where a boundary surface represented by an obtained matrix is the key boundary surface and placed into the set Ω; and then performing a step 4-6), where i=1, . . . , m, i≠p, p′, q; and
the rule is as follows:
when ³h₁ᵢ·³h₁ᵢ₊₁<0,
if ³h₁ᵢ>0 and ³h₁ᵢ₊₁<0, setting an i^{th} row of the matrix Λ′ to the uᵢₘₐₓ and an i+1^{th} row to uᵢ₊₁ₘᵢₙ; or
if ³h₁ᵢ<0 and ³h₁ᵢ₊₁>0, setting an i^{th} row of the matrix Λ′ to the uᵢₘᵢₙ and an i+1^{th} row to uᵢ₊₁ₘₐₓ;
when ³h₁ᵢ<0 and ³h₁ᵢ₊₁<0,
setting an i^{th} row of the matrix Λ′ to the uᵢₘᵢₙ and an i+1^{th} row to uᵢ₊₁ₘᵢₙ; or
when ³h₁ᵢ; >0 and ³h₁ᵢ₊₁>0,
calculating ¹¹d₀₁=³c₁ᵢ·uᵢₘₐₓ+³c₁ᵢ₊₁·uᵢ₊₁ₘᵢₙ, and ¹¹d₀₂=³c₁ᵢ·uᵢₘᵢₙ+³c₁ᵢ₊₁·uᵢ₊₁ₘₐₓ; and if ¹¹d₀₁>¹¹d₀₂, setting an i^{th} row of the matrix Π′ to the uᵢₘₐₓ and an i+1^{th} row to uᵢ₊₁ₘᵢₙ; if ¹¹d₀₁<¹¹d₀₂, setting an i^{th} row of the matrix Π′ to the uᵢₘᵢₙ and an i+1^{th} row to uᵢ₊₁ₘₐₓ; or if ¹¹d₀₁=¹¹d₀₂, setting an i^{th} row and an i+1^{th} row of the matrix Π′ as follows: setting the i^{th} row of the matrix Π′ to the uᵢₘₐₓ and the i+1^{th} row to uᵢ₊₁ₘᵢₙ; or setting the i^{th} row of the matrix Π′ to the uᵢₘᵢₙ and the i+1^{th} row to uᵢ₊₁ₘₐₓ;
4-5-7) processing other rows than the rows p, q, p′ of the matrix Π′ according to a following rule, where a boundary surface represented by an obtained matrix is the key boundary surface and placed into the set Ω; and then performing a step 4-6), where i=1, . . . , m, i≠p, p′, q; and
the rule is as follows:
when ³h₁ᵢ·³h₁ᵢ₊₁<0,
if ³h₁ᵢ>0 and ³h₁ᵢ₊₁<0, setting an i^{th} row of the matrix Π′ to the uᵢₘᵢₙ and an i+1^{th} row to uᵢ₊₁ₘₐₓ; or
if ³h₁ᵢ<0 and ³h₁ᵢ₊₁>0, setting an i^{th} row of the matrix Π′ to the uᵢₘₐₓ and an i+1^{th} row to uᵢ₊₁ₘᵢₙ;
when ³h₁ᵢ<0 and ³h₁ᵢ₊₁<0,
calculating ¹²d₀₁=³c₁ᵢ·uᵢₘₐₓ+³c₁ᵢ₊₁·uᵢ₊₁ₘᵢₙ, and ¹²d₀₂=³c₁ᵢ·uᵢₘᵢₙ+³c₁ᵢ₊₁·uᵢ₊₁ₘₐₓ; and if ¹²d₀₁>¹²d₀₂, setting an i^{th} row of the matrix Π′ to the uᵢₘᵢₙ and an i+1^{th} row to uᵢ₊₁ₘₐₓ; if ¹²d₀₁<¹²d₀₂, setting an i^{th} row of the matrix Π′ to the uᵢₘₐₓ and an i+1^{th} row to uᵢ₊₁ₘᵢₙ; or if ¹²d₀₁=¹²d₀₂, setting an i^{th} row and an i+1^{th} row of the matrix Π′ as follows: setting the i^{th} row of the matrix Π′ to the uᵢₘₐₓ and the i+1^{th} row to uᵢ₊₁ₘᵢₙ; or setting the i^{th} row of the matrix Π′ to the uᵢₘᵢₙ and the i+1^{th} row to uᵢ₊₁ₘₐₓ; or
when ³h₁ᵢ>0 and ³h₁ᵢ₊₁>0,
setting an i^{th} row of the matrix Π′ to the uᵢₘᵢₙ and an i+1^{th} row to uᵢ₊₁ₘᵢₙ; and
4-6) returning to the step 4-1), selecting a next group for which no key boundary surface has been determined, until the key boundary surface has been determined for all groups, and then performing a step 5);
5) checking all key boundary surfaces in the 52, and performing determining as follows: if there are identical key boundary surfaces, retaining only one of the identical key boundary surfaces, and removing other key boundary surfaces that are the same as the retained one key boundary surface; after processing all the key boundary surfaces, forming a new set of key boundary surfaces, which is denoted as Ω′; and
then performing a step 6); and
6) mapping all vertices of each key boundary surface in the Ω′ according to v=B·u_{ELR} to obtain all vertices of a boundary surface corresponding to the control attainable set, so as to determine the boundary surface of the control attainable set, where all key boundary surfaces in the Ω′ are all the key boundary surfaces of the control set; the boundary surface of the control attainable set is a quadrilateral or triangle; and boundary surfaces that are of the control attainable set and determined based on all the key boundary surfaces in the Ω′ constitute the boundary ∂(Φ_{ELR}) of the control attainable set.
